(19) United States
(12) Patent Application Publication
(10) Pub. No.: US 2025/0134141 A1
(43) Pub. Date: May 1, 2025

(54) PROCESS FOR TREATING PLANT-BASED SUBSTRATES FOR FOOD PRODUCTS

(71) Applicant: Voyage Foods, Inc., Oakland, CA (US)

(72) Inventors: Lucas Baker, San Francisco, CA (US); Kelsey Tenney, Oakland, CA (US); Jackson Sizemore, San Francisco, CA (US); Shalmali Gadgil, Tokyo (JP)

(21) Appl. No.: 18/902,457

(22) Filed: Sep. 30, 2024

Related U.S. Application Data
(60) Provisional application No. 63/541,641, filed on Sep. 29, 2023.

(51) Int. Cl. A23L 11/00; A23L 11/30; A23L 11/60; A23L 25/00

(52) U.S. Cl. CPC A23L 11/05; A23L 11/33; A23L 11/60; A23L 25/30

(57) ABSTRACT

Methods and materials for processing plant substrates are provided herein, as are compositions containing the processed plant substrates and particularly, methods and materials for processing legumes to produce coffee-like products (e.g., solid soluble instant granules, beverage powders, and liquid extracts and concentrates) that are made without coffee beans, and compositions containing the processed legumes.

### CROSS-REFERENCE TO RELATED APPLICATIONS

This application claims priority to U.S. Application No. 63/541,641, filed on Sep. 29, 2023, the disclosure of which is incorporated herein by reference in its entirety.

### TECHNICAL FIELD

This document relates to methods and materials for processing and using plant substrates (e.g., legumes or plant seeds), and to compositions (e.g., food products) containing the processed plant substrates.

### BACKGROUND

Roasting can enhance the sensory qualities (e.g., aromas, flavors, and/or appearance) of certain food products and their ingredients. A classic example is green coffee beans, which develop the characteristic aroma and flavor of coffee during roasting by undergoing numerous chemical processes including the Maillard reaction, where amino groups in proteins react with reducing sugars to form aroma and flavor compounds, Strecker degradations where carbonyls react with amino acids to create valuable flavor and aroma producing aldehydes or ketones, and caramelization, which uses up remaining sugars in the coffee beans to create dark brown flavor producing compounds.

It would appear that many seeds, beans, or other plant materials could also benefit from roasting applications to create foods and beverages suitable as coffee alternatives or other plant-based food products. Legumes, for example, are rich in nutrients and readily available. A diet rich in legumes, such as chickpeas, provides various health benefits. Legumes are considered a healthy dietary option due to their abundant carbohydrates, protein, energy, vitamins, minerals, and fibers. Food products from chickpeas have been found to constitute a major dietary source of high-quality protein. See, Langyan et al., Front Nutr., 8:772573, 2022. The proteins in these plant-based materials have been found to not only contribute to nutrition, but also to food quality, texture, aroma, and flavor. See, Rasheed et al., Molecules, 25 (4):873, 2020.

Chickpeas and other legumes like lentils, split peas, pinto beans, as well as fruit seeds such as grape seeds and date seeds are not only rich in protein. They also contain complex starches, insoluble dietary fiber such as lignins (and/or lignocellulose), and/or soluble fiber such as raffinose in chickpeas. Chickpea hulls, for example, contain high amounts of insoluble fiber and are typically removed for most chickpea food product processing. Like many legumes, grape seeds contain lignins, a complex network of polymers that are cross-linked to each other. The strong bonds that hold lignin's polymers together make it difficult to break down. See, Sanderson, Nature, 474: S12-S14, 2011.

Despite their desirable nutritional content, many legumes and fruit seeds (e.g., grape seeds, cranberry seeds, blueberry seeds, raspberry seeds, strawberry seeds, blackberry seeds, pomegranate seeds, date seeds, fenugreek seeds, and others) are not readily seen as candidates in roasting applications like that of coffee beans. For instance, legumes such as chickpeas and fruit seeds such as grape seeds have traditionally been overlooked candidates as beverage substitutes for coffee, unlike, for example, carob, chicory, malted barley, or rye, which have been used extensively in applications as coffee alternatives. Legumes and fruit seeds have also not been widely used in either alcoholic or non-alcoholic beverages. In addition, legumes, on top of their distinctive bean-like flavor which some consumers find unappealing, tend to thicken, or cloud soups or other liquid foods due to their starchy nature and tendency to gel over time.

Ingredients such as chickpeas, lentils, split peas, grape seeds, pinto beans, and date seeds, have rarely been used in roasted applications, such as in coffee beverage replicas, due to their inefficient roastability, extractability, and grindability. This is largely due to their underlying composition, which, as noted above, is high in protein and in both insoluble and soluble fiber. For example, chickpeas contain about 24% protein on average. In contrast, green coffee beans contain about 8.5% to 12% weight by weight of protein, which makes them more readily roasted, ground, and extracted.

The relatively high protein content of many legumes and seeds, such as chickpeas, date, and grape seeds, as well as an abundance of starches, result in dense, pebble-like particles when they are dried or roasted, and such legumes and seeds therefore are challenging to breakdown and process. Roasting these materials does not make them more friable, or prone to breakage. Rather, in some instances, roasting or other processes can render them even more resistant to breakdown through grinding or other mechanical processes. Sugars, starches, and proteins in the bean or seed form a complex with bonds that makes access to roasting precursor molecules such as sugars and amino acids difficult. A roasted chickpea or grape seed, for example, are both resistant to grinding or pulverization into a paste for downstream food applications.

Thus, there remains a long-felt need presented by many commodity ingredients such as legumes and fruit and vegetable seeds that are not able to be used as roasted and extractable products despite their availability and nutritionally desirable characteristics. There also remains a long-felt need to improve the processability and also the sensory qualities of products that otherwise would have fewer desirable characteristics, such that the improved products can be applied to new categories of foods and beverages.

### SUMMARY

This document provides solutions to the technical challenges peculiar to food products generated from plant-based substrates, particularly legumes and seeds and other substrates that are fibrous, lignocellulosic and/or proteinaceous. For example, by using particular treatments (e.g., pH adjustment and acid hydrolysis, enzymatic breakdown, roasting, or a combination thereof), valuable new food products can be created from often overlooked food stocks. For example, this document provides coffee-like products (e.g., coffee-like solids and coffee-like liquids) that are made without coffee beans, as well as methods for making coffee-like products from legumes such as chickpeas.

As described herein, this document provides methods, and products made according to the methods, for processing fibrous, lignocellulosic and/or proteinaceous plant substrates such as legumes and plant seeds. The methods described herein generally include treatments (e.g., pre-roasting or post-roasting treatments) of legumes, plant seeds or other fibrous, lignocellulosic, and/or proteinaceous plant substrates to improve roastability, extractability, and/or filterability. The methods provided herein can, for example, reduce undesirable fiber-protein agglomeration, which can be present as a viscous gel-like mass or sediment that precipitates out of solution, and can increase the availability of saccharides, peptides, and free amino acids to facilitate downstream reactions (e.g., Maillard reactions) that can impact the taste, aroma, and color of products based on the plant substrate.

The methods provided herein for processing plant materials (e.g., legumes and other plant seeds) successfully overcome technical challenges and increase the “roastability” and “extractability” of such plant materials. Thus, the methods provided herein solve the problem presented by many commodity ingredients that are not able to be used as roasted and extractable products. The methods provided herein also address a long-standing need for process improvements to increase the breakability and thus, the grindability of lignocellulosic, proteinaceous plant-based substrates without causing liquefaction, where the integrity and structure of the roasted particle is lost during the process of breaking down fibrous proteinaceous plant materials. Liquefaction renders the ingredients unroastable and unsuitable for applications like coffee or chocolate, where it is important to retain structure of the individual bean, pea, and/or seed, for example, for further processing, such as roasting and grinding (milling).

Materials that are relatively easy to grind (high grindability) also tend to be more prone to breakage (high breakability), while materials that are tough and resistant to grinding (low grindability) also may tend to have low breakability, such that they are less likely to fracture or break under mechanical stress. This is often the case with plant-based substrates such as legumes and fruit and vegetable seeds, but the methods provided herein can alleviate these issues.

In a first aspect, this document features a method for preparing a ground plant substrate from a fibrous, lignocellulosic and/or proteinaceous plant material for use in a consumable food or beverage. The method can include, or consist essentially of, treating the plant material with an acid in aqueous solution until the plant material reaches a pH of about 1 to about 5, thereby generating an acid-treated plant material; roasting the acid-treated plant material to generate a roasted, acid-treated plant material; and grinding the roasted, acid-treated plant material to yield the ground plant substrate.

In some embodiments, a method for preparing a ground plant substrate from a fibrous, lignocellulosic and/or proteinaceous plant material includes, or consists essentially of, treating the plant material with an acid in aqueous solution until the plant material reaches a pH of about 3 to about 7, thereby generating an acid-treated plant material; roasting the acid-treated plant material to generate a roasted, acid-treated plant material; and grinding the roasted, acid-treated plant material to yield the ground plant substrate. In some embodiments, the plant material is treated with an acid in aqueous solution until the plant material reaches a pH of about 4 to about 7.

The plant material can include legumes. The legumes can include chickpeas, lentils, peas, black beans, or cranberry beans. The plant material can include fruit seeds or vegetable seeds. The fruit seeds or vegetable seeds can include date seeds or grape seeds. In some embodiments, the plant material includes legumes, fruit seeds, vegetable seeds, or a combination thereof.

The acid can include phosphoric acid, hydrochloric acid, or sulfuric acid. In some embodiments, the acid includes phosphoric acid, hydrochloric acid, sulfuric acid, or a combination thereof. The method can include treating the plant material until a pH between about 2 to about 3 is reached. In some embodiments, the method includes treating the plant material until a pH between about 4 to about 7 is reached.

The method can include treating the plant material at a temperature of about 40° C. to about 90° C. The method can include treating the plant material for about 15 minutes to about 120 minutes. The acid can be phosphoric acid, and the method can include incubating the plant material with the phosphoric acid at a temperature of about 60° C. to about 90° C. until a pH of 2 to 3 is reached. In some embodiments, the acid is phosphoric acid, and the method includes incubating, soaking, spraying, or combining of the plant material with the phosphoric acid at a temperature of about 60° C. to about 90° C. until a pH of about 4 to about 7 is reached.

The method can include roasting the acid-treated plant material to a temperature of about 165° C. to about 250° C. The method can include grinding the roasted, acid-treated plant material to an average particle size of about 0.1 mm to about 5 mm.

The method can further include extracting the ground plant substrate with an aqueous solution to produce an extract. The method can include extracting the ground plant substrate with water at a temperature of about 60° C. to about 195° C. In some embodiments, the method can include extracting the ground plant substrate with water at a temperature of about 60° C. to about 85° C. In some embodiments, the method includes extracting the ground plant substrate with water at a temperature of about 60° C. to about 85° C., about 85° C. to about 100° C., about 100° C. to about 120° C., about 120° C. to about 175° C. or about 175° C. to about 195° C. In some embodiments, the extraction takes place at 1 bar or in pressured conditions above atmospheric pressure, such as between about 1 to about 3 bars, about 3 to about 5 bars, about 5 to about 8 bars, about 8 to about 10 bars, about 10 to about 12 bars, or about 12 to about 15 bars. Extraction equipment and procedures utilized for extraction of traditional coffee are applicable for extracting the coffee-like products of the present invention. (See Wang, X., & Lim, L. (2021). Modeling study of coffee extraction at different temperature and grind size conditions to better understand the cold and hot brewing process. Journal of Food Process Engineering, 44 (3); Córdoba, N., Fernandez-Alduenda, M., Moreno, F. L., & Ruiz, Y. (2020). Coffee extraction: A review of parameters and their influence on the physicochemical characteristics and flavour of coffee brews. Trends in Food Science and Technology, 96, 45-60; Zhang, L., Wang, X., Manickavasagan, A., & Lim, L. (2022). Extraction and Physicochemical Characteristics of High Pressure-assisted Cold Brew Coffee. Future Foods, 5 (1): 100113).

The method can further include cooling the extract. The method can further include filtering the extract. The method can further include concentrating the extract to form a concentrate. The method can include concentrating the extract by removing at least a portion of the water. A portion of the water can be removed by evaporation, freezing, and/or thawing of the extract. In some embodiments, the method further includes drying the concentrate to form a solid concentrate (e.g., a powder concentrate, a pellet concentrate, or a granule concentrate). The method can further include drying the concentrate to form a powder concentrate. The drying can include spray drying, freeze drying, or dehydrating. In some embodiments, drying includes spray drying, freeze drying, air drying, dehydrating, or heat drying. In some embodiments, the solid concentrate is a soluble powder concentrate, a soluble pellet concentrate, or a soluble granule concentrate having a moisture content from about 1% w/w to about 10% w/w. The powder concentrate can include a soluble powder having a moisture content from about 1% w/w to about 10% w/w. The soluble powder can be water soluble. In some embodiments, the solid concentrate (e.g., the soluble powder concentrate, soluble pellet concentrate, or soluble granule concentrate) is water soluble.

In another aspect, this document features a composition containing, consisting essentially of, or consisting of a ground plant substrate prepared using a method described herein. The composition can be a consumable food or beverage.

In another aspect, this document features a composition containing, consisting essentially of, or consisting of an extract prepared using a method described herein.

In another aspect, this document features a composition containing, consisting essentially of, or consisting of a concentrate prepared using a method described herein.

In still another aspect, this document features a method for preparing a ground plant substrate from fibrous, lignocellulosic and/or proteinaceous plant material for use in a consumable food or beverage. The method can include, or consist essentially of, contacting the plant material with an enzymatic solution containing one or more enzymes with agitation (e.g., stirring) from about 15 to about 120 minutes to generate an enzymatically-treated plant material; roasting the enzymatically-treated plant material to generate a roasted, enzymatically-treated plant material; and grinding the roasted, enzymatically-treated plant material to yield the ground plant substrate.

The one or more enzymes (e.g., one, two, three, four, or more enzymes) in the enzymatic solution can be present at a concentration of about 1% w/w or less, and the enzymatic solution can be aqueous. The one or more enzymes in the enzymatic solution can be present at a concentration between about 0.1% and about 1% w/w, and the enzymatic solution can be aqueous.

The roasting can take place at a temperature from about 165° C. to about 250° C. The one or more enzymes can include a carbohydrase, protease, amylase, pectinase, cellulase, hemicellulase, xylanase, ligninase, or tannase. In some embodiments, the one or more enzymes are selected from a carbohydrase, a protease, and a pectinase. In some embodiments, the one or more enzymes is a carbohydrase. In some embodiments, the one or more enzymes are a carboydrase and a protease. In some embodiments, the one or more enzymes are a carboydrase, a protease, and a pectinase.

The method can further include extracting the ground plant substrate with an aqueous solution to produce an extract. The method can include extracting the ground plant substrate with water at a temperature of about 60° C. to about 85° C. The method can further include cooling the extract. The method can further include filtering the extract.

The method can further include contacting the plant material with one or more chemical solutions, each chemical solution containing an acid or a base, where the plant material is contacted with the one or more chemical solutions before the plant material is contacted with the enzymatic solution containing one or more enzymes. The method can further include contacting the enzymatically-treated plant material with one or more chemical solutions containing an acid or base, where the enzymatically-treated plant material is contacted with the one or more chemical solutions before roasting, after roasting, before grinding and/or after grinding. The one or more chemical solutions can contain an acid including phosphoric acid, hydrochloric acid, or sulfuric acid, or can contain a base including sodium hydroxide, potassium hydroxide, lye, sodium carbonate, calcium carbonate, calcium hydroxide, or potassium bicarbonate. The plant material can be contacted with a base under agitation (e.g., stirring) for about 15 to about 120 minutes until the plant material reaches a pH between about 8 to about 10. In some embodiments, the plant material is contacted with a base comprising sodium hydroxide or potassium hydroxide with stirring for about 15 to about 120 minutes until the plant material reaches a pH between about 8 to about 10. The enzymatically-treated material can be contacted with a base under agitation (e.g., stirring) for about 15 to about 120 minutes until the enzymatically-treated plant material reaches a pH between about 8 to about 10. In some embodiments, the enzymatically-treated material can be contacted with a base comprising sodium hydroxide or potassium hydroxide with stirring for about 15 to about 120 minutes until the enzymatically-treated plant material reaches a pH between about 8 to about 10. The plant material can be contacted with an acid under agitation (e.g., stirring) for about 15 to about 120 minutes until the plant material reaches a pH between about 1 to about 4. In some embodiments, the plant material can be contacted with an acid comprising phosphoric acid, hydrochloric acid, or sulfuric acid under with stirring for about 15 to about 120 minutes until the plant material reaches a pH between about 1 to about 4. The enzymatically-treated plant material can be contacted with an acid under agitation (e.g., stirring) for about 15 to about 120 minutes until the plant material reaches a pH of between about 1 to about 4. In some embodiments, the enzymatically-treated plant material can be contacted with an acid comprising phosphoric acid, hydrochloric acid, or sulfuric acid under with stirring for about 15 to about 120 minutes until the plant material reaches a pH between about 1 to about 4. The method can further include contacting the plant material with a chemical solution under agitation (e.g., stirring) for about 15 to about 120 minutes, where the chemical solution contains an acid including phosphoric acid or contains a base including sodium hydroxide, where the contacting with the chemical solution occurs before or after the plant material is contacted with the enzymatic solution, and where the enzymatic solution contains about 1% w/w or less of one or more enzymes including pectinase, cellulase, hemicellulase, xylanase, or tannase. The plant material can contain legumes including chickpeas, lentils, peas, black beans or cranberry beans, or fruit seeds including date seeds or grape seeds. In some embodiments, the plant material contain legumes (such as chickpeas, lentils, peas, black beans, cranberry beans, or a combination thereof), and/or fruit seeds (such as date seeds and/or grape seeds). The method can include grinding the roasted, enzymatically-treated plant material to an average particle size of about 0.1 mm to about 0.5 mm.

In another aspect, this document features a composition containing a ground plant material substrate prepared using a method described herein. The composition can be a consumable food or beverage. In some embodiments, the consumable food or beverage is a substitute for at least one of the following coffee or chocolate products: coffee grounds, water-soluble coffee granules, a ready-to-drink coffee beverage, a coffee concentrate, a cacao-based chocolate, a chocolate liquor, or a cocoa-based chocolate beverage.

In another aspect, this document features a method of preparing a concentrate for a consumable food or beverage from a plant material. For example, in some embodiments, provided herein is a method of preparing a concentrate for a coffee-substitute from a plant material (e.g., a legume and/or fruit seed). The method can include, or consist essentially of, contacting a plant material with an aqueous solution containing an acid to form a pre-treated (e.g., an acid-treated) plant material having a pH between about 1 and about 5, or contacting the plant material with a base to form a pre-treated (e.g., a base-treated) plant material having a pH between about 8 and about 10; contacting the pre-treated plant material (e.g., the acid- or base-treated plant material) with an enzymatic solution containing one or more enzymes with agitation (e.g., stirring) from 15 to 120 minutes to generate an enzymatically-treated plant material; roasting the enzymatically-treated plant material to generate a roasted plant material; grinding the roasted, pre-treated plant material to yield a ground plant substrate having an average particle size of about 0.1 mm to about 5 mm; extracting the ground plant substrate with water to produce an extract; and concentrating the extract by removing at least a portion of the water to form a concentrate.

In some embodiments, a method provided herein includes, or consists essentially of, contacting a plant material (e.g., a legume, fruit seed, or a combination thereof) with an aqueous solution containing an acid to form an acid-treated plant material (e.g., an acid-treated legume, an acid-treated fruit seed, or a combination thereof) having a pH between about 4 and about 7; roasting the acid-treated plant material to generate a roasted, acid-treated plant material (e.g., a roasted, acid-treated legume, a roasted, acid-treated fruit seed, or a combination thereof); grinding the roasted, acid-treated plant material to yield a ground plant substrate (e.g., a ground legume substrate, a ground fruit seed substrate, or a combination thereof) having an average particle size of about 0.1 mm to about 5 mm; extracting the ground plant substrate with water to produce an extract (e.g., a legume extract, a fruit seed extract, or a combination thereof); and concentrating the extract by removing at least a portion of the water to form a concentrate (e.g., a legume concentrate, a fruit seed concentrate, or a combination thereof).

The methods described above can further include adding caffeine, one or more acids, and/or one or more flavors to the extract (e.g., a legume extract, a fruit seed extract, or a combination thereof). The methods described above can include removing the extract water by evaporation, freezing, and/or thawing of the extract. The one or more acids added to the extract can include malic acid, tartaric acid, citric acid, lactic acid, fumaric acid, succinic acid, phosphoric acid, or any combination thereof. The one or more flavors added to the extract can include volatile organic compounds, essential oils, plant extracts, or oleoresins.

In some embodiments, the methods described above can further comprise the step of mixing the legume extract or fruit seed extract (e.g., a first extract) with an additional extract (e.g., a second extract) to form a combined extract, wherein preparation of the additional extract comprises contacting an additional legume and/or an additional fruit seed with an aqueous solution containing an acid to form an additional acid-treated legume or an additional acid-treated fruit seed having a pH between about 4 and about 7 that is different from the pH of the acid-treated legume or acid-treated fruit seed. The method can include removing the extract water by evaporation, freezing, and/or thawing of the additional extract.

In some embodiments, the acid-treated legume or acid-treated fruit seed (e.g., first acid-treated legume or first acid-treated fruit seed) has a pH between about 4 and about 5.5 and the additional acid-treated legume or additional acid-treated fruit seed (e.g., second acid-treated legume or second acid-treated fruit seed) has a pH between about 5.5 and about 7.0. The acid-treated legume or acid-treated fruit seed can be the same as the additional acid-treated legume or additional acid-treated fruit seed. In some embodiments, the acid-treated legume or acid-treated fruit seed is different from the additional acid-treated legume or additional acid-treated fruit seed.

The methods described above can further include adding caffeine, one or more acids, and/or one or more flavors to the additional extract or the combined extract. The one or more acids added to the additional extract or the combined extract can include malic acid, tartaric acid, citric acid, lactic acid, fumaric acid, succinic acid, phosphoric acid, or any combination thereof. The one or more flavors added to the additional extract or the combined extract can include volatile organic compounds, essential oils, plant extracts, or oleoresins.

In another aspect, this document features a method for making a soluble plant-based granule, a soluble plant-based pellet, or a soluble plant-based powder for use in a consumable food or beverage. In some embodiments, this document features a method for making a soluble plant-based powder for use in a consumable food or beverage. In some embodiments, the method can include, or consist essentially of, (a) treating a plurality of plant seeds, beans, or peas with (i) one or more chemical solutions, each chemical solution comprising water and an acid or a base, and/or (ii) one or more enzymatic solutions, each enzymatic solution comprising water and one or more enzymes, thereby producing a plurality of treated plant seeds, a plurality of treated beans, or a plurality of treated peas; (b) roasting the treated plant seeds, the treated beans, or the treated peas, thereby producing roasted, treated plant seeds, roasted, treated beans, or roasted, treated peas; (c) grinding the roasted, treated plant seeds, roasted, treated beans, or roasted, treated peas, thereby producing plant seed grounds, bean grounds, or pea grounds comprising particles having an average particle size of about 0.10 mm to about 5 mm; (d) extracting the plant seed grounds, bean grounds, or pea grounds in water at a temperature of about 60° C. to about 85° C. to produce a plant seed extract, a bean extract, or a pea extract; (e) concentrating the plant seed extract, the bean extract, or the pea extract by removing at least a portion of the water by evaporation, freezing, or thawing to form a plant seed concentrate, a bean concentrate, or a pea concentrate; and (f) drying the plant seed concentrate, the bean concentrate, or the pea concentrate, thereby yielding a soluble plant-based granule, a soluble plant-based pellet, or a soluble plant-based powder.

The plant seed concentrate, the bean concentrate, or the pea concentrate can be dried to a moisture content between about 1% w/w to about 10% w/w. The plant seed concentrate, the bean concentrate, or the pea concentrate can be dried by spray drying, freeze drying, or dehydration using a kettle, vacuum kettle, rising film evaporator, falling film evaporator, scraped film evaporator, dehydrator, or freeze concentrator. The soluble plant-based granule, a soluble plant-based pellet, or a soluble plant-based powder can be water soluble. The acid can comprise phosphoric acid and the soluble granule can have an average particle size of about 0.1 mm to about 5 mm.

In some embodiments, the method can include, or consist essentially of, (a) treating a plurality of plant seeds, beans, or peas with one or more chemical solutions, each solution including an aqueous solution containing an acid or a base, and/or one or more enzymatic solutions, each enzymatic solution including an aqueous solution containing one or more enzymes, thereby producing a plurality of treated plant seeds, beans, or peas; (b) roasting the treated plant seeds, beans, or peas, thereby producing roasted plant seeds, beans, or peas; (c) grinding the roasted plant seeds, beans, or peas, thereby producing a ground paste containing particles having an average particle size of about 0.10 mm to about 5 mm; (d) extracting the ground paste in water at a temperature of about 60° C. to about 85° C. to produce an extract; (e) concentrating the extract by removing at least a portion of the water by evaporation, freezing, or thawing to form a concentrate; and (f) drying the concentrate, thereby yielding a soluble plant-based powder.

The plant seeds, beans, or peas can contain legumes including chickpeas, lentils, peas, black beans, or cranberry beans or fruit or vegetable seeds including date seeds or grape seeds. The concentrate can be dried to a moisture content between about 1% w/w to about 10% w/w. The concentrate can be dried by spray drying, freeze drying, or dehydration using a kettle, vacuum kettle, rising film evaporator, falling film evaporator, scraped film evaporator, dehydrator, or freeze concentrator. The soluble plant-based powder can be water soluble.

In another aspect, this document features a replica of a coffee bean or a coffee ground, wherein the replica comprises a solid substrate comprising acid-hydrolyzed and roasted plant material (e.g., any of the grains, legumes or legume seeds, fruit seeds, or a combination thereof described herein). The replica of a coffee ground can have an average particle size of about 0.10 mm to about 5 mm. The replica of a coffee bean can have an average particle size of about 4 mm to about 10 mm. The solid substrate can be acid hydrolyzed with phosphoric acid, hydrochloric acid, sulfuric acid, or a combination thereof.

In another aspect, this document features a coffee granule replica comprising an aqueous extract of acid-hydrolyzed and roasted chickpeas dried into the shape of a granule. The chickpeas can be dried by spray drying, freeze drying, or dehydration using a kettle, vacuum kettle, rising film evaporator, falling film evaporator, scraped film evaporator, dehydrator, or freeze concentrator. The dried granule can be water-soluble.

In another aspect, this document features a coffee beverage replica comprising an aqueous extract of acid-hydrolyzed and roasted chickpeas, caffeine, and/or flavors. The coffee beverage replica can further comprise a sugar or sugar substitute. In some the sugar or sugar substitute comprises sucrose, fructose, a sugar alcohol, allulose, stevia, monk fruit, aspartame, acesulfame potassium, sucralose, a derivative of the above, or any combination thereof. The coffee beverage replica can further comprising milk, dairy solids, milk substitute, or non-dairy solids.

In another aspect, this document features a coffee replica having the form of an aqueous extract, wherein the coffee replica comprises acid-hydrolyzed and roasted legumes, and wherein the acid comprises phosphoric acid, hydrochloric acid, or sulfuric acid.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are graphs plotting TA.XT break force testing of chickpeas with and without acid pre-treatment. FIG. 1A is a graph plotting a hardness curve for roasted chickpeas that had not been pre-treated with acid. The TA.XT maxed out on force and could not break the chickpeas. In contrast, FIG. 1B is a graph plotting a hardness curve for roasted chickpeas that were pre-treated with acid hydrolysis. The TA.XT successfully broke the chickpeas into multiple pieces, indicating their improved breakability with pre-treatment to adjust their pH.

FIG. 2 is table showing data for pH adjustment and enzymatic treatments of grape seeds.

FIG. 3 is a representative chromatogram of a hydrolyzed dark roast “coffee” sample.

FIGS. 4A, 4B, and 4C are representative chromatograms of samples of roasted chickpea “coffee” that was produced from chickpeas hydrolyzed with phosphoric acid and then roasted.

FIG. 5 is a representative chromatogram of a sample of medium roast chickpea “coffee” that was acid hydrolyzed with phosphoric acid and then roasted.

FIG. 6 is a heatmap of sample peak areas of a select panel of volatile organic compounds found in chickpea “coffee” roasted to dark and medium roast levels and chickpea “coffee” that are pre-treated with phosphoric acid before roasting to dark and medium roast levels. In the original figure, the dark gray rectangles indicate compounds with larger peak areas and the light gray rectangles indicate compounds with smaller peak areas. The first three columns of rectangles represent peak areas for dark roasted unhydrolyzed chickpeas, the second set of three columns of rectangles represents peak areas for acid-hydrolyzed dark roast chickpeas, the third set of three columns represents acid-hydrolyzed medium roasted chickpeas, and the last set of three columns represents unhydrolyzed medium roasted chickpeas. Euclidian distance measure and Ward clustering methods also were used, and the branching at the top and to the left of the heatmap indicates closeness of samples analytically.

FIG. 7 is a graph showing sensory panel ratings of the flavor profile of an unhydrolyzed medium roast chickpea cold brew “coffee,” a hydrolyzed medium roast chickpea cold brew “coffee”, and a commercial black and unsweetened traditional cold brew coffee.

FIG. 8 is a graph showing the total sugars (% w/w dry basis) measured in chickpeas that were acid hydrolyzed with phosphoric acid to a pH of 4.5, 5.0, 5.5, 6.0, or 6.5.

FIG. 9 is a graph showing the increase in total sugars (% w/w dry basis) measured in chickpeas that were acid hydrolyzed with phosphoric acid to a pH of 4.5, 5.0, 5.5, or 6.0 as compared to untreated chickpeas.

FIG. 10 is a graph showing the relative concentrations of pyrazine compounds found in acid-hydrolyzed chickpeas as a function of pH.

FIG. 11 is a graph showing the relative concentrations of furan compounds found in acid-hydrolyzed chickpeas as a function of pH.

FIG. 12 is a graph showing the relative concentrations of dione compounds found in acid-hydrolyzed chickpeas as a function of pH.

FIG. 13 is a graph showing the relative concentrations of pyrrole compounds found in acid-hydrolyzed chickpeas as a function of pH.

FIG. 14 is a graph showing the relative concentrations of pyridine compounds found in acid-hydrolyzed chickpeas as a function of pH.

FIG. 15 is a graph showing the relative concentrations of alcohol compounds found in acid-hydrolyzed chickpeas as a function of pH.

FIG. 16 is a graph showing the relative concentrations of sulfur compounds found in acid-hydrolyzed chickpeas as a function of pH.

FIG. 17 is a graph showing the relative concentrations of ester compounds found in acid-hydrolyzed chickpeas as a function of pH.

FIG. 18 is a graph showing the relative concentrations of thiol compounds found in acid-hydrolyzed chickpeas as a function of pH.

FIG. 19 is a graph showing the relative concentrations of aldehydes compounds found in acid-hydrolyzed chickpeas as a function of pH.

### DETAILED DESCRIPTION

This document provides compositions for consumable food or beverages such as chocolate-like products (e.g., solids and liquids), coffee-like products (e.g., solids and liquids), and nut butter-like products (e.g., solids, liquids, and pastes).

In some embodiments, this document describes compositions for coffee-like products (e.g., solids and liquids) as well as methods for making coffee-like products. Generally, these products can be called “coffee-like products,” “coffee substitutes,” or “coffee replicas.” The coffee replica can be a solid. The coffee replica can be a coffee granule replica. The coffee replica can be a coffee grounds replica. The coffee replica can include a solid substrate. The solid substrate can include processed or unprocessed grains or grain products, legumes or legume seeds, oil plants or seeds, fruits or fruit products, roots, tubers, or root or tuber products, sugar processing by-products, or other plant by-products. The solid substrate can include chickpeas, for example, to produce “chickpea coffee.”

Examples of coffee solids include beans, grounds, and granules (e.g., as used in ready-to-mix or instant coffee, for granules). Accordingly, this document provides replicas of these solids, which can be termed “coffee-like beans” or “coffee bean replicas,” “coffee-like grounds” or “coffee ground replicas,” or “coffee-like granules” or “coffee granule replicas,” “replica of a coffee bean” or a “replica of a coffee ground,” “replica of a coffee soluble granule, pellet, or powder,” respectively.

Examples of coffee liquids (e.g., solutions, suspensions, or emulsions) include coffee beverages (e.g., a ready-to-drink beverage), coffee extracts, or coffee concentrates. The solution, suspension, or emulsion can be a ready-to-drink beverage. The solution, suspension, or emulsion can be a coffee concentrate. Accordingly, this document provides replicas of these liquids, which can be termed “coffee-like beverages” or “coffee beverage replicas” or “coffee-like extracts” or “coffee-like concentrates” or “coffee concentrate replicas,” respectively. It will be understood that, while solid in form, coffee granule replicas, coffee pellet replicas, or coffee powder replicas are dehydrated versions of coffee beverage replicas or coffee concentrate replicas. The coffee-like products described herein can have characteristics—including taste, aroma, mouthfeel, and appearance—of traditionally generated coffees, and are meant to be consumed and enjoyed in the same manner as traditional coffees. The coffee-like products made according to the invention, can be a solution, suspension, or emulsion.

In some embodiments, this document provides chocolate-like products (e.g., solids and liquids) as well as methods for making chocolate-like products. Generally, these products can be called “chocolate-like products” or “chocolate replicas.” Examples of chocolate include beans, molded bars, countlines, straightlines, boxed, cocoa powder, novelties, panned chocolate, coatings, liquors, and drinks. Accordingly, this document provides replicas of these, which can be termed “cocoa-like beans,” “cocoa bean replicas,” or “chocolate bean replicas;” “chocolate-like bars” or “chocolate bar replicas;” or “chocolate-like coatings” or “chocolate coating replicas,” respectively. The chocolate-like products described herein can have characteristics—including taste, aroma, mouthfeel, and appearance—of traditionally generated dark, white, or milk chocolates, and are meant to be consumed and enjoyed in the same manner as traditional chocolates.

In some embodiments, this document provides nut butter-like products (e.g., solids, liquids, and pastes) as well as methods for making nut butter-like products. Generally, these products can be called “nut butter-like products” or “nut butter replicas.” Examples of nut butters include peanut butter, almond butter, hazelnut butter, acorn butter, cashew butter, macadamia butter, pecan butter, pistachio butter, walnut butter, other nut butters, coatings, and spreads. Accordingly, this document provides replicas of these, which can be termed “nut butter-like spreads” or “nut butter replicas”, “nut butter-like coatings”, or “nut butter coating replicas”, or “spread replicas”, respectively. The nut butter-like products described herein can have characteristics—including taste, aroma, mouthfeel, and appearance—of traditionally generated nut butters, and are meant to be consumed and enjoyed in the same manner as traditional nut butters.

This document also provides materials and methods for processing legumes, fruit and vegetable seeds, and/or other lignocellulosic, proteinaceous plant material to produce ingredients that can be used (e.g., as a filler, as a blend with traditional coffee or chocolate products, and/or to replace one or more traditional ingredients) in consumable food and beverage products. In some cases, for example, a processed plant material generated by the methods provided herein can be used in coffee replacement beverages, chocolate replacement products, soluble powder, pellets, or granules, blends for coffee and chocolate beverages, plant and fruit extracts, beverage concentrates, fat-based spreads, and alternative plant-based foods. In general, the methods provided herein can include treating a legume or a fruit or vegetable seed with one or more treatments before or after it is further processed by roasting and/or grinding, in order to facilitate the further processing and to produce ground products having desirable sensory characteristics. For example, the methods provided herein can include one or more treatment steps (e.g., any of the treatments described herein), one or more roasting steps, and one or more grinding steps. A treatment step may occur before and/or after a roasting step. A treatment step may occur before and/or after a grinding step. A grinding step may occur before and/or after a roasting step. The methods provided herein for processing plant materials (e.g., legumes and other plant seeds) successfully overcome technical challenges and increase the “roastability” and “extractability” of such plant materials.

As used herein, the terms “traditional” and “reference” coffee refer to coffee products produced through standard coffee making processes, which include the farming, drying, and milling of coffee beans. “Traditionally-produced coffee” is coffee that was generated using standard coffee making process.

Traditional coffees are complex mixtures on a chemical level. This chemical signature is unique to coffee and as would be expected, is distinct from that of other foods. This document provides coffee replicas made without coffee but with other plant substrates and in particular, legumes such as chickpeas that do not share the identical chemical complexity of traditional coffee. Chickpeas, for instance, are not known for having the aroma and flavor characteristics of roasted coffee beans, even when roasted but have their own “bean-like” organoleptic properties. Most consumers would not perceive the odor of roasted chickpeas as being even remotely similar to the strong odorants evident in traditional coffee. It is surprising that the replicas disclosed herein can have the aroma, flavor, and dark brown color of coffee without sharing the chemical complexity of a traditional coffee in order to be perceived as such. It is also surprising that by modulating the conditions under which the plant substrate, such as legumes, are processed, such as by pre-treatment via acid hydrolysis at various pH levels, the creation (or reduction) of certain important classes of volatile compounds can be encouraged. The result is that, without having to replicate the complex mixture of compounds found in traditional coffee, coffee-like products can be produced by enhancing or reducing some of the key aromatic compound classes that have previously been shown to be responsible for the characteristic aroma of coffee, such as pyrazines, furans, esters, pyrroles, aldehydes, ketones, and sulfur compounds. Thus, manipulation of the treatment (e.g., chemical treatment and/or enzymatic treatment) and roasting conditions during processing of these plant substrates, can enhance the taste and/or smell of the coffee replicas disclosed herein.

It is also surprising that coffee-like characteristics can be further enhanced by combining two or more processing batches, each processed under different pH and/or roasting conditions according to the methods provided herein, to increase or reduce the presence of certain volatile compounds. Thus, a first coffee-like extract produced according to one set of pH and roasting conditions can be combined with a second coffee-like extract produced according to a second set of pH and roasting conditions. It is surprising that certain volatile organic compound classes are conducive to lower pH (e.g., aldehydes which exhibit a higher concentration when chickpeas are hydrolyzed at a pH of 4.5) and others to a less acidic pH (e.g., pyrazines which exhibit a higher concentration when chickpeas are hydrolyzed at a pH of 6). Batches produced at different hydrolysis and roasting conditions can be combined to produce a finished coffee-like product that contains higher concentrations of desired volatile compounds that are known in the literature as contributors to the intense aroma and flavor of traditional coffee.

It is further surprising that by adjusting acid hydrolysis conditions of a plant substrate such as chickpeas, an increase in total sugars, including reducing sugars that participate in Maillard reactions was observed. Similarly, it is surprising that even though the source plant-substrate, such as chickpeas, likely possesses its own chemical signature and potentially, contain compounds not found in traditional coffee, once processed according to the methods disclosed herein, did not result in characteristic “bean-like” odors or flavors typically expected of roasted legumes. Therefore, this document provides coffee replicas that are not mere replicas of existing traditional coffee products, but instead may provide a similar sensory experience with a different chemical composition.

As used herein, the terms “traditional” and “reference” chocolate refer to chocolate products produced through standard chocolate making processes, which include the farming, drying, grinding, and tempering of chocolate beans. “Traditionally-produced chocolate” is chocolate that was generated using a standard chocolate making process.

Traditional chocolates are complex mixtures on a chemical level. In some aspects, this document provides chocolate replicas that are less complex than a traditional chocolate. It is surprising that the replicas disclosed herein, do not need to have the complexity of a traditional chocolate in order to be perceived as such. Therefore, in another aspect, this document provides chocolate replicas that are not mere replicas of existing products, but instead provide a similar sensory experience with a different chemical composition.

As used herein, the terms “traditional” and “reference” nut butter refer to nut butter products produced through standard nut butter making processes, which include the farming, processing, drying, roasting, cooling, blanching, and grinding of tree nuts. “Traditionally-produced nut butter” is nut butter that was generated using standard nut butter making process.

Traditional nut butters are complex mixtures on a chemical level. In some aspects, this document provides nut butter replicas that are less complex than a traditional nut butter. It is surprising that the replicas disclosed herein, do not need to have the complexity of a traditional nut butter, such as peanut butter or hazelnut butter, in order to be perceived as such. Therefore, in another aspect, this document provides nut butter replicas that are not mere replicas of existing products, but instead provide a similar sensory experience with a different chemical composition.

As used herein, a “fibrous plant substrate” or “plant substrate” refers to a plant-based material having a fiber content that includes soluble fiber and insoluble fiber (e.g., fiber that is not readily soluble in water), and constitutes more than about 5% w/w of dry matter of the plant material. Many legumes and fruit seeds are high in fiber, having greater than about 5% w/w (e.g., about 5 to about 10% w/w, about 10% to about 15% w/w, about 15% to about 20% w/w, about 20% to about 25% w/w, about 25% to about 30% w/w, about 30% to about 35% w/w, about 35% to about 40%, about 40% to about 45%, about 45% to about 50% w/w, or even greater than about 50% w/w) fiber content on a dry basis. Legumes, such as chickpea, cowpea, field bean, guar, lentil, pea (green), and pigeon pea, contain fibers that include pectin, cellulose, lignin, and hemicellulose content. See Khan et al., Sarhad J. Agric., 23 (3): 763-766, 2007. Chickpeas, for example, possess a fibrous husk high in lignins, and the pod is high in a soluble fiber called raffinose. Details regarding the high fiber content of chickpeas can be found, e.g., in Vasquez-Banda et al., Emirates J Food Agr., 35 (1): 17-22, 2023. Fibers in grape seeds also include pectin, cellulose, lignins, and hemicellulose, where the cellulose, lignins, and hemicellulose are typically integrated into a network called lignocellulose. Details regarding the fiber content of fruit seeds can be found, for example, in Alba et al., J Sci Food Agr., 99 (9): 4189-4199, 2019.

As used herein, the term “lignocellulose” refers to a component found in plant-based material made mainly of three types of carbon-based polymers: cellulose, hemicellulose, and lignin. Details about lignocellulose and its properties are described, for example, in Sanderson, Nature, 474:S12-S14, 2011.

When broken down, lignocellulosic plant materials may yield useful components desirable in food products. For example, cellulose is a polymer of glucose. Hemicelluloses are polymers of various sizes that incorporate a range of different sugars, whereas lignin has a polymer backbone made from phenolic groups, which are ring-shaped, carbon-based structures. The glucose polymer chains in cellulose are largely insoluble and exist in crystalline microfibrils that make the sugars hard to reach. These cellulose microfibrils are attached to hemicellulose, which contains a variety of sugars, making it more complicated to convert to a single product such as ethanol. Surrounding all this is lignin, which protects the cellulose and hemicellulose. Lignin is a complex mass of polymers that are cross-linked to each other via strong bonds that make it difficult to break lignin down. Grape seeds and other berry seeds as well chickpeas and other legumes, as detailed above, are examples of edible plant substrates known to be high in lignocellulose.

As used herein, the term “high-protein plant” or “proteinaceous plant material” refers to plant seeds, fruit seeds, grains, and legumes, including whole, ground, processed, pulverized, fractionated, or broken plant seeds, fruit seeds, grains, and legumes, that contain an average protein composition of at least about 5% w/w protein on a dry basis. Many legumes and fruit seeds are high in protein, having greater than about 5% w/w protein (e.g., about 5% to about 10% w/w, about 10% to about 15% w/w, about 15% to about 20% w/w, about 20% to about 25% w/w, about 25% to about 30% w/w, about 30% to about 35%, about 35% to about 40%, or about 45 to about 55% w/w protein) on a dry basis. For example, chickpeas contain about 24% protein weight by weight. Grape seeds contain about 11% w/w protein. Lentils contain about 26% w/w protein. Split peas contain about 10% w/w protein. Date seeds contain between about 6% to about 15% w/w protein on a dry basis. Depending on growing conditions, moisture content, lot to lot variability, and other factors, there may be some variability in the protein content of a particular high-protein plant or proteinaceous plant material. Roasting or other processing of a high-protein plant or proteinaceous plant material may reduce total protein but increase the amount of digestible proteins and starches in the form of amino acids, peptides, and reducing or simple sugars such as dextrose, fructose, galactose, maltose, glucose, or non-reducing sugars such as sucrose.

The term “roastability” generally refers to the physical ease of roasting a product (e.g., whether the product is of an appropriate size for roasting), but “roastability” also can be used to describe products or conditions that are conducive to better roasting results. See, e.g., Jiang, “Flavor testing and more from the food technology side of peanut breeding,” available online at peanutgrower.com/feature/flavor-testing-and-more-from-the-food-technology-side-of-peanut-breeding/and Hendrix et al., “Effect of kernel characteristics on color and flavor development during peanut roasting: Two years of data,” Meeting Abstract. Vol. 49, 2017, available online atars.usda.gov/research/publications/publication/?seqNo115=340222. An increase in positive, desirable aspects of a product after roasting can be described to have higher “roastability.”

As used herein, the term “roastability” therefore can be linked to the quantity and concentration of volatile organic compounds that arise from Maillard reactions, Strecker degradation, and caramelization reactions that occur when roasting. See, Sucan and Weerasinghe, “Process and Reaction Flavors: An Overview,” Am Chem Soc, 2005. In some cases, a product's roastability refers to a measure of the L value of a material (on a colorimeter), where a higher L value indicates a higher level of compounds associated with a browning reaction (e.g., Maillard, Strecker degradation, and/or caramelization reaction). Thus, a higher L value can serve as an analytical indicator of higher roastability of the treated ingredients.

As used herein, the term “breakability,” otherwise known as “friability,” refers to how easily an ingredient breaks under the application of force, as measured by TA.XT. The breakability (friability) of a plant material has been found to be a good predictor of its milling/grinding characteristics in downstream processing. Details regarding friability as a predictor of milling of corn kernels is found, e.g., in Mestres et al., Cereal Chem., 72 (6): 652-657, 1995.

As used herein, the term “liquefaction” refers to the breakdown of complex carbohydrates, lignin, and/or proteins present in leguminous plants, fruits, vegetables, seeds, and even wood-like material. These ingredients are broken down into their micronutrient constituents in order to improve bioavailability and processability.

These ingredients contain starches and other polysaccharides that are converted into glucose and other monosaccharides through a process called acidic and enzymatic hydrolysis by blending plant material with water and then mechanically breaking it down to create a liquid or semi-liquid mixture. The mixture is cooked, acid treated, and/or enzymatically treated to break down macronutrients into their constituents. The final liquefied product can be used for further down processing (e.g., fermentation) or as a ready to drink beverage. This technology is used in many industries ranging from biofuel production to creation of milk replacements, such as oat milk. Details regarding liquefaction can be found, e.g., in Deswal et al., Food Bioprocess Technol., 7:610-618, 2014.

In some cases, this document relates to the breakdown of fibrous, proteinaceous plant materials without causing liquefaction, as described above, that destroys the integrity of the individual unit of plant material, such as a chickpea, a lentil, a pea, a bean, a grape seed, or a date seed. Even though liquefaction is a versatile and useful process when complete disintegration of a solid plant material into a liquid matter is desired, such as in the production of oat milk from oat grains, it disintegrates an ingredient's structure and renders it unusable for most roasting processes.

As used herein, the term “extractability” of a material refers to the ability to solubilize the material (e.g., after roasting) in a manner such that the extract will contain a higher amount of total dissolved solids, a lower amounts of insoluble solids, and a lower amount of sedimentation while keeping the yields as high as possible. See, e.g., Sankar, “Extraction Processes,” Conventional and Advanced Food Processing Technologies, First Edition, Ed. Suvendu Bhattacharya, John Wiley & Sons, Ltd., pp. 129-158, 2015).

As used herein, “sedimentation” in an extract refers to the process by which solid particles and substances settle to the bottom of the liquid extract, forming a layer of sediment. In beverages, beverage extracts, and/or extract concentrates, for example, the sediment may be caused by agglomerated particles. As used herein, “agglomeration” refers to the process of small particles clumping or coming together to form larger aggregates or clusters. An association of fiber, starch, and/or protein molecules into larger aggregate structures tend to be insoluble and may be visible as a gel or sediment during the extraction process. The occurrence of agglomeration can impact the clarity and appearance of a final product. Sedimentation settling of agglomerated particles in a liquid due to gravity can be a concern with customer acceptability. In addition, sedimentation can reduce the stability of a product over time. If the sediment contains spoilage organisms or undergoes undesirable chemical reactions, it may also accelerate product degradation, reducing shelf life.

The unavailability in legumes and other plant seeds of “roasting precursors” (e.g., saccharides, peptides, and free amino acids) available for downstream reactions such as the Maillard reaction, Strecker degradation, or caramelization reaction that impact the taste, aroma, and color of products results in a limited amount of volatile organic compounds that are key for roasted products. It has been established that out of the thousands of compounds in roasted coffee, a small number of compounds and classes of compounds are considered to be the main contributors to the aroma and flavor of coffee. See Cannon, Robert & Trinnaman, Laurence & Grainger, Brian & Trail, Amy. (2010). The Key Odorants of Coffee from Various Geographical Locations. Flavors in noncarbonated beverages. 1036. 77-90. 10.1021/bk-2010-1036.ch006, which ascribes 26 compounds with corresponding odor and/or flavor such as “nutty, roasted, coffee-like” odor/flavor to trimethylpyrazine and “chocolate-like” odor/flavor to 2-methylbutanal. (Id. at 82). In fact, prior research indicates that for coffee, although the volatile fraction of espresso, for example is extremely complex, only a few compounds are responsible for the characteristic aroma of coffee, such as aldehyde, ketones, furanones, furans, sulfur compounds, and pyrazines. See Angeloni S, Mustafa A M, Abouelenein D, Alessandroni L, Acquaticci L, Nzekoue F K, Petrelli R, Sagratini G, Vittori S, Torregiani E, et al. Characterization of the Aroma Profile and Main Key Odorants of Espresso Coffee. Molecules. 2021; 26 (13): 3856. doi.org/10.3390/molecules26133856.

As used herein, the term “about” when used to refer to an amount of an ingredient or compound means ±10% of the amount. As used herein, the term “about” when used to refer to measured characteristics of a composition provided herein means ±20% of the reported value. As used herein, the term “about” when used to a condition for making a composition provided herein means ±20% of the value.

Legumes, particularly starchy ones like chickpeas, are not as aromatic as roasted coffee or cacao beans but rather possess relatively mild flavor and odor profiles. Further, the physical structures of many legumes do not lend themselves to the release of odorants when roasted. This may be due to the fact that reaction precursors that normally participate in flavor-producing reactions are tied-up, bound, or physically integrated within complex starches and proteins in legumes and other plant seeds, and thus, the precursors cannot be used as reagents for the Maillard, Strecker degradation, or caramelization reactions. In addition, the high protein and fiber contents of legumes and fruit or vegetable seeds can cause issues when these plant substrates are processed by extracting, grinding, and/or conching.

For example, starches tend to be insoluble in either water or oil. When extracted, these large molecules will not go into solution, which can lead to several problems. For example, liquid products generated from such extracts may contain insoluble matter, which can lead to haziness and sedimentation, neither of which are appealing to consumers when the products should be non-turbid. Sedimentation, as discussed above, also can cause product instability. In addition, higher amounts of insoluble fiber in a solution can make common physical filtration methods, such as cartridge filtration and membrane filtration, virtually impossible. Since these large molecules accumulate in filtration media to form a dense, mat-like fibrous mass, they can block and clog the filters, resulting in extract solutions that are unfilterable by common means.

Proteins can cause similar issues. Proteins, like complex starches, tend to be large molecules and they also tend to have a positive or negative charge. When there is a large amount of protein in an extract, the proteins can bind together to create even larger and more complex molecules. As the proteins bind to themselves and other charged molecules, they can become so large that they lose their solubility—a phenomenon known as flocculation. As used herein, the term “flocculation” refers to a phenomenon in which protein molecules bind to themselves and other charged molecules to form a mass with decreased solubility in aqueous solution, which can cause sedimentation as some of dissolved proteins come out of solution and gravitate toward the bottom of the mixture. Details regarding flocculation, as it relates to biofuel production, can be found, for example, in Burke et al., Biomass and Bioenergy, 35 (1): 391-401, 2011.

Another issue is that fibers and proteins found in fibrous, proteinaceous plant substrates, are difficult to physically break down in mechanical particle reduction processes, such as grinding (milling). Common grinders struggle to break the compact, dense structures of fibrous, proteinaceous plant substrates, which may become even more difficult instead of less difficult to grind, after the substrates have been roasted. Thus, such substrates are not fit to be used as ingredients in applications where the particle size of the substrate needs to be reduced. In many food applications, the particle size of the substrate needs to be reduced to a fine particle size, be undetectable by the human tongue and/or readily incorporate into food and beverage products such as powdered drink mixes that dissolve into water, milk, or other liquids without grittiness or discernible particles.

The methods and materials provided herein can be used to enable crushing or grinding and/or reduction in seed/bean particle size, to improve the extractability of desired food components, and/or enhance the roasted qualities of fibrous, lignocellulosic and/or proteinaceous plant substrates such as legumes and other seeds. As described herein, by hydrolyzing starches into smaller sugars and/or denaturing proteins into amino acids and peptides, desirable roasting precursors for Maillard, Strecker degradation, and caramelization reactions can be generated. When these hydrolyzed ingredients are roasted, the free precursors can react with one another to create volatile organic compounds that are important to provide sensory qualities to roasted food products such as coffee or coffee-alternatives, chocolate or chocolate-alternatives, powdered drinks, beverage concentrates, and nut or nut-alternative spreads. In addition, since the starches and proteins may be broken down and also reacted, there may be significantly less or even no residual constituents to create haze, clog filters, or cause sedimentation issues.

The methods provided herein can be used to reduce the amount of starch in legume and plant seed samples, as demonstrated by the finding that more sugars were available in processed samples. In addition, the breakdown of fibers and proteins was shown to prevent agglomeration in the extraction process, enabling ingredients to be extracted in an efficient manner. While there are a variety of potential causes, such agglomeration or aggregation in food products, such as beverage extracts, is highly undesirable, since it typically leads to a solid mass that cannot be used or processed in beverage or other food applications. Such agglomerated or aggregated gels or solids can form a precipitate or sediment-like layer within an extract or other solution, which can interfere with or clog evaporators, spray dryers, or other food processing equipment.

This problem can be exacerbated in food applications such as coffee or coffee substitute beverages where the roasted materials result in a concentrated format, since the extract must be able to concentrate and still maintain a relatively low viscosity that is suitable for beverages. As with the protein flocculation problem discussed above, agglomeration during processing of fibrous, proteinaceous materials in the food manufacturing industry continues to pose challenges.

Any appropriate plant material can be used in the methods provided herein. The plant material can be, for example, in raw form or in dried and/or roasted form and can be in whole seed form or can have been physically broken into smaller pieces prior to processing according to the methods provided herein. Many plant materials, either in their raw state or in their dried and/or roasted forms, can be difficult to grind or otherwise process for downstream applications. In some cases, the plant material can be from a legume, such as chickpeas, lentils, or split peas. In some cases, the plant material can include fruit and/or vegetable seeds, such as grape seeds or date seeds. In some cases, the methods provided herein can be used for treatment and processing of one or more food stream waste products, such as one or more processed or unprocessed, fermented, or malted grains or grain products, legumes or legume seeds, oil plants or seeds, fruits or fruit products, roots, taproots, tubers, or root or tuber products, sugar processing by-products, or other plant by-products.

Non-limiting examples of legumes include members of the legume family Leguminosae (Fabaceae), including, but not limited to, lentils, chickpeas, split peas, peas (green), peas (yellow), peanuts, red beans, black beans, pinto beans, and cranberry beans.

Non-limiting examples of grains or grain products that can be used in the methods provided herein include atella, barley distillery by-products, barley, barley grain, brown rice, brewers grains, cockspur grass (Echinochloa crusgalli) grain, corn gluten feed, com distillers grain, com gluten meal, ear maize, finger millet (Eleusine coracana) grain, foxtail millet (Setaria italica) grain, fonio (Digitaria exilis) grain, maize bran or hominy feed, maize green forage, maize cobs, maize stover, maize germ meal or maize germ, malt culms, maize grain, millet hulls, oat hulls or oat mill feed, oats, pearl millet (Pennisetum glaucum) grain, proso millet (Panicum miliaceum) grain, quinoa (Chenopodium quinoa), red oat (Avena sativa) grain, rice protein concentrate, rice bran or other rice by-products, rough rice (paddy rice), rice hulls, rye grain or by-products, sorghum by-products, sorghum grain, tef (Eragrostis tef) grain, triticale, Venezuela grass (Paspalum fasciculatum), wheat (general), wheat germ, wheat bran, wheat grain, wheat distillers grain, wheat shorts, wheat middlings, feed flour, and/or combinations thereof. The grains or grain products include malted and/or fermented forms (e.g., malted barley, malted rye).

Non-limiting examples of legumes or legume seeds that can be used in the methods provided herein include African locust bean (Parkia biglobosa or Parkia filicoidea), African yam bean (Sphenostylis stenocarpa), bambara groundnut (Vigna subterranea) crop residue and straw, black gram (Vigna mungo), bambara groundnut (Vigna subterranea) pods, shells and offals, blue lupin (Lupinus angustifolius) seeds, bambara groundnut (Vigna subterranea) seeds, butterfly pea (Clitoria ternatea), carob (Ceratonia siliqua), common bean (Phaseolus vulgaris), centra (Centrosema molle), common vetch (Vicia sativa), chickpea (Cicer arietinum), cowpea (Vigna unguiculata) seeds, cranberry bean (Borlotti), fava bean (Vicia faba), field bean (Lablab purpureus), grass pea (Lathyrus sativus), guar (Cyamopsis tetragonoloba) forage, seed and meal, guanacaste (Enterolobium cyclocarpum), hairy vetch (Vicia villosa), horse gram, (Macrotyloma uniflorum), jack bean (Canavalia ensiformis), lablab (Lablab purpureus), lima bean (Phaseolus lunatus), lentil (Lens culinaris), mat bean (Vigna aconitifolia), mung bean (Vigna radiata), narbon vetch (Vicia narbonensis), pea (green), pea (yellow), pea by-products, peanut seeds, pea protein concentrate, peanut skins, pea seeds, pigeon pea (Cajanus cajari) seeds, peanut forage, prickly sesban (Sesbania bispinosa), peanut hulls, purple vetch (Vicia benghalensis), peanut meal, rain tree (Albizia saman), rice bean (Vigna umbellata), sesban (Sesbania sesban), soybean seeds, soybean (general), sword bean (Canavalia gladiata), soybean forage, Syrian mesquite (Prosopis farcta), soybean meal, tamarind (Tamarindus indica), tamarugo (Prosopis tamarugo), velvet bean (Mucuna pruriens), white bean, white lupin (Lupinus albus) seeds, winged bean (Psophocarpus tetragonolobus), yellow lupin (Lupinus luteus) seeds, and combinations thereof. In some cases, the plant material used in the methods provided herein can include chickpeas.

Non-limiting examples of oil plants or seeds than can be used in the methods provided herein include Almond kernels and by-products, argan (Argania spinosa), babassu (Attalea speciosa), borneo tallow nut (Shorea stenoptera) oil meal, bactris (Bactris gasipaes), camelina (Camelina sativa) seeds and oil meal, cotton (general), cashew (Anacardium occidentale) nuts and by-products, castor (Ricinus communis) seeds, oil meal and by-products, cotton straw and cotton crop residues, ceylon ironwood (Mesua ferrea), cottonseed hulls, cottonseed meal, copra meal and coconut by-products, crambe (Crambe abyssinica), corozo (Attalea cohune) seed and oil meal, doum palm (Hyphaene thebaica), dragon's head (Lallemantia iberica), flax straw and flax crop by-products, grape seeds and grape seed oil meal, hemp, jatropha (Jatropha sp.) kernel meal and other jatropha products, jojoba (Simmondsia chinensis), kapok (Ceiba pentandra), kenaf (Hibiscus cannabinus), karanja (Millettia pinnata), kusum (Schleichera oleosa), linseed meal, luffa (Luffa aegyptiaca), linseeds, macadamia (Macadamia integrifolia), moringa (Moringa oleifera), mahua (Madhuca longifolia), mustard oil meal and mustard bran, maize germ meal and maize germ, neem (Azadirachta indica), niger (Guizotia abyssinica), oil palm fronds and oil palm crop residues, olive oil cake and by-products, oil palm kernels, palm kernel meal, peanut seeds, palm oil mill effluent, peanut skins, palm press fibre, pinto peanut (Arachis pintoi), peanut forage, poppy (Papaver somniferum), peanut hulls, pumpkin, squash, gourd and other Cucurbita species, peanut meal, rapeseed forage, rapeseed hulls, rapeseed meal, rapeseeds, rubber (Hevea brasiliensis), safflower (Carthamus tinctorius) seeds and oil meal, sal (Shorea robusta) seeds and oil meal, soybean meal, soybean seeds, seje (Oenocarpus bataua), sunflower (general), sesame (Sesamum indicum) seeds and oil meal, sunflower forage and crop residues, sunflower hulls and sunflower screenings, sunflower meal, sunflower seeds, soybean (general), soybean forage, soybean hulls, tung tree (Aleurites fordii), tomato seed cake, walnut (Juglans regia), watermelon (Citrullus lanatus) seeds and oil meal, and combinations thereof.

Non-limiting examples of fruits or fruit products that can be used in the methods provided herein include apple pomace and culled apples, banana (general), banana peels, banana fruits, banana leaves and pseudostems, breadfruit (Artocarpus altilis), breadnut (Brosimum alicastrum), cashew (Anacardium occidentale) nuts and by-products, citrus pulp, fresh, citrus fruits, citrus seed meal, citrus molasses, citrus pulp, dried, colocynth (Citrullus colocynthis), date molasses, date palm leaves and date pedicels, date palm fruits, grape pomace, guava (Psidium guajava), grape seeds and/or grape seed oil meal, jackfruit (Artocarpus heterophyllus), kokum (Garcinia indica), luffa (Luffa aegyptiaca), mango (Mangifera indica) fruit and by-products, moringa (Moringa oleifera), melon (Cucumis melo), olive oil cake and by-products, papaya (Carica papaya) fruits, leaves and by-products, pineapple by-products, pineapple leaves, pumpkin, squash, gourd and other Cucurbita species, sapucaia (Lecythis pisonis), Spanish lime (Melicoccus bijugatus), seje (Oenocarpus bataua), tomato fruits, tomato pomace, tomato skins and tomato seeds, tomato leaves and crop residues, tomato seed cake, walnut (Juglans regia), watermelon (Citrullus lanatus) forage and fruit, watermelon (Citrullus lanatus) seeds and oil meal, and combinations thereof. In some cases, the plant material used in the methods provided herein can include grape seeds.

Non-limiting examples of roots, tubers, or root or tuber products that can be used in the methods provided herein include arrowroot (Maranta arundinacea), beet molasses, canna (Canna indica), carrot (Daucus carota), cassava leaves and foliage, cassava peels, cassava pomace and other cassava by-products, cassava roots, chicory and chicory root (Cichorium intybus), Chinese yam (Dioscorea esculenta), dandelion (Taraxacum officinale), enset (Ensete ventricosum) corms and pseudostems, fodder beet roots, Jerusalem artichoke (Helianthus tuberosus), malanga (Xanthosoma sagittifolium), potato (Solarium tuberosum) by-products, potato (Solarium tuberosum) tubers, sugar beet pulp, dehydrated, sugar beet pulp, pressed or wet, sugar beet roots, sugar beet tops, sweet potato (Ipomoea batatas) by-products, sweet potato (Ipomoea batatas) forage, sweet potato (Ipomoea batatas) tubers, taro (Colocasia esculenta), white yam (Dioscorea rotundata), winged yam (Dioscorea alata), whitespot giant arum (Amorphophallus campanulatus), yacon (Smallanthus sonchifolius), yellow yam (Dioscorea cayenensis), and combinations thereof. This document encompasses the use of edible plant parts in addition to the root or tuber of a plant. For example, edible parts of a chicory plant include the root, stems, and leaves, and all are contemplated for use in the methods provided herein.

Non-limiting examples of sugar processing by-products that can be used in the methods provided herein include beet molasses, sugar, molasses, sugar beet pulp, pressed or wet, sugarcane bagasse, sugarcane forage, whole plant, sugarcane juice, sugarcane molasses, sugarcane press mud, sugarcane tops, and mixtures thereof.

Non-limiting examples of other plant materials that can be used in the methods provided include carob (Ceratonia siliqua), citrus molasses, date molasses, date palm leaves and date pedicels, date palm seeds, enset (Ensete ventricosum) corms and pseudostems, leaf protein concentrate and grass juice, Mexican marigold (Tagetes erecta), mushrooms and spent mushroom substrate, molasses/urea blocks, potato (Solarium tuberosum) tubers, pyrethrum marc, spent hops, straws, sugarcane juice, sugarcane molasses, sugarcane press mud, vinasses, wood, wood sugar or wood molasses, and combinations thereof.

In general, the methods provided herein include treating a plant material (e.g., any of the plant materials described herein such as legumes or other plant seeds (e.g., fruit or vegetable seeds)) with one or more chemical agents to reduce the pH and cause acid hydrolysis, and/or with one or more enzymes that can break down components of the plant material (e.g., proteins and/or fiber). In some embodiments, following such treatment, the plant materials can be processed by roasting, grinding, and/or any other appropriate steps.

As used herein, “hydrolysis” refers to a chemical reaction whereby compounds are broken down or cleaved into smaller constituents by the addition of water in acidic or alkaline conditions. The term also refers to enzymatic hydrolysis, whereby compounds are broken down into smaller constituents by the addition of an enzymatic solution containing enzymes such as proteases or carbohydrases that breakdown carbohydrates and proteins into smaller units such as less complex starches or sugars, peptides, and/or amino acids. In acidic conditions, functional groups in carbohydrates and proteins are protonated, water then binds to this functional group, cleaving it from the macromolecule. In proteins, amino acids are cleaved, while in carbohydrates sugars are cleaved. Both acid and enzymatic hydrolysis frees sugars from starch and amino acids from proteins.

In some cases, plant material (e.g., any of the plant materials described herein such as legumes or other plant seeds) can be treated with one or more chemical agents. Any appropriate chemical agent(s) can be used. Non-limiting examples of suitable chemical agents include one or more acids (e.g., sulfuric acid, hydrochloric acid, phosphoric acid, lactic acid, citric acid, malic acid, acetic acid, fumaric acid, tartaric acid, nitric acid, and glucono-delta-lactone), caustic agents (e.g., bases such as sodium hydroxide, potassium hydroxide, lye, sodium carbonate, calcium carbonate, calcium hydroxide, and potassium bicarbonate), one or more oxidizing agents (e.g., hydrogen peroxide), and/or iodine. One or more additional ingredients can be included in the reaction. In some cases, for example, one or more sugars, amino acids, transition/catalyst metals, and/or salts can be included in a reaction mixture that includes plant material and a chemical agent.

In some cases, plant material (e.g., any of the plant materials described herein such as legumes or other plant seeds) can be treated with one or more chemical agents (e.g., one, two, three, four, five, or more chemical agents). For example, for neutral or slightly acidic plant materials such as many legumes and chickpeas (which has a pH of about 6.5 to 6.9), phosphoric acid, sulfuric acid, or hydrochloric acid can be used. In some embodiments, a combination of two or more of lactic acid, malic acid, tartaric acid, glucono-delta-lactone can be used. In some embodiments, for tannic plant-based materials such as grape seeds, caustic alkali agents including sodium hydroxide and potassium hydroxide can be used. In some embodiments, a combination of one, two or more of softer alkali agents such as sodium carbonate, calcium carbonate, and potassium bicarbonate can be used.

Any appropriate reaction conditions can be used when treating plant material with a chemical agent as described herein. For example, an acid solution can be combined with plant material in an amount sufficient to fully cover the plant material, such that as much of the plant material as possible is in contact with the solution. In some cases, a solution of water and an acid (e.g., phosphoric acid, hydrochloric acid, or sulfuric acid) can be used, where the solution contains about 30% to about 99% acid (e.g., about 30% to about 40%, about 35% to about 45%, about 40% to about 50%, about 45% to about 55%, about 50% to about 60%, about 55% to about 65%, about 60% to about 70%, about 65% to about 75%, about 70% to about 80%, about 75% to about 85%, about 80% to about 90%, about 85% to about 95%, about 90% to about 99%, about 30%, about 35%, about 40%, about 45%, about 50%, about 55%, about 60%, about 65%, about 70%, about 75%, about 80%, about 85%, about 90%, about 95%, or about 99% acid). In some cases, the acid solution can be heated from about 50° C. to about 100° C. (e.g., about 50° C. to about 60° C., about 55° C. to about 65° C., about 60° C. to about 70° C., about 65° C. to about 75° C., about 70° C. to about 80° C., about 75° C. to about 85° C., about 80° C. to about 90° C., about 85° C. to about 95° C., about 90° C. to about 100° C., about 95° C. to about 100° C., about 60° C., about 65° C., about 70° C., about 75° C., about 80° C., about 85° C., about 90° C., about 95° C., or about 100° C.) before or while it is combined with plant material.

Once combined, the plant material and one or more chemical agents can be incubated/contacted (e.g., with or without mixing) for any appropriate length of time. For example, a plant material can be incubated/contacted with one or more chemical agents for about 10 minutes to about 3 hours (e.g., about 10 to about 15 minutes, about 10 to about 20 minutes, about 15 to about 20 minutes, about 15 to about 25 minutes, about 20 to about 30 minutes, about 30 to about 45 minutes, about 30 to about 60 minutes, about 45 to about 60 minutes, about 45 to about 90 minutes, about 60 to about 90 minutes, about 60 to about 120 minutes, about 90 to about 120 minutes, about 90 to about 180 minutes, about 120 to about 180 minutes, about 15 minutes, about 20 minutes, about 30 minutes, about 45 minutes, about 60 minutes, about 75 minutes, about 90 minutes, about 105 minutes, or about 120 minutes). In some cases, the plant material and one or more chemical agents can be incubated or contacted until a desired pH is reached. For example, a plant material and one or more chemical agents can be incubated or contacted until the pH of the material is about 1 to about 5 (e.g., about pH 1 to about pH 2, pH 2 to about pH 3, about pH 3 to about pH 4, about pH 4 to about pH 5, about pH 2, about pH 3, about pH 4, or about pH 5). In some embodiments, a plant material and one or more chemical agents can be incubated or contacted until the pH of the material is about 1 to about 11 (e.g., about pH 2.5 to about pH 3.5, about pH 3 to about pH 4, about pH 3.5 to about pH 4.5, pH 4 to about pH 5, about pH 4.5 to about pH 5.5, about pH 5 to about pH 6, about pH 5.5 to about pH 6.5, about pH 6 to about pH 7, about pH 6.5 to about pH 7.5, about pH 7 to about pH 11). In some embodiments, a plant material and one or more chemical agents can be incubated or contacted until the pH of the material is about 1, about 1.5, about 2, about 2.5, about 3, about 3.5, about 4, about 4.5, about 5, about 5.5, about 6, about 6.5, about 7 or about 7.5.

After the plant material has been treated for a suitable length of time or until a desired pH is reached, the material (e.g., the chemically-treated plant material) can be further processed in any appropriate manner. For example, the liquid solution can be removed from the plant material (e.g., the chemically-treated plant material), which can then be roasted to an appropriate temperature, ground to an appropriate particle size, and/or extracted. In some cases, for example, the chemically-treated plant material can be roasted to a temperature of about 165° C. to about 250° C. (e.g., about 165° C. to about 170° C., about 170° C. to about 175° C., about 175° C. to about 180° C., about 180° C. to about 185° C., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 165° C. to about 175° C., about 170° C. to about 180° C., about 175° C. to about 185° C., about 180° C. to about 190° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 220° C. to about 230° C., about 225° C. to about 235° C., about 230° C. to about 240° C., about 235° C. to about 245° C., about 240° C. to about 250° C., about 185° C. to about 200° C., about 200° C. to about 225° C., about 225° C. to about 250° C., about 165° C., about 170° C., about 175° C., about 180° C., about 185° C., about 190° C., about 195° C., about 200° C., about 205° C., about 210° C., about 215° C., about 220° C., about 225° C., or about 250° C.). In some cases, the pre-treated plant material (e.g., chemically-treated plant material) can be roasted to a temperature of about 165° C. to about 175° C., about 170° C. to about 180° C., about 175° C. to about 185° C., about 180° C. to about 190° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 220° C. to about 230° C., about 225° C. to about 235° C., about 230° C. to about 240° C., about 235° C. to about 245° C., or about 240° C. to about 250° C.). Any appropriate type of roaster can be used (e.g., an electric coffee roaster, a convective/conductive roaster, a drum roaster, a tangential roaster, or an impingement oven roaster).

In some cases, the chemically-treated and optionally roasted plant material can be ground to any appropriate particle size. For example, a chemically-treated and optionally roasted plant material can be ground to a mean particle size from about 0.1 mm to about 5 mm (e.g., about 0.1 mm to about 0.25 mm, about 0.15 mm to about 0.30 mm, about 0.25 mm to about 0.5 mm, about 0.4 mm to about 0.6 mm, about 0.5 mm to about 1 mm, about 0.75 mm to about 1.25 mm, about 1 mm to about 2 mm, about 1.5 mm to about 2.5 mm, about 2 mm to about 3 mm, about 2.5 mm to about 3.5 mm, about 3 mm to about 4 mm, about 3.5 mm to about 4.5 mm, or about 4 mm to about 5 mm). Any suitable equipment can be used to grind the plant material (e.g., a wet mill, a crushing mill, a burr mill, an espresso grinder, a stone mill, a jet mill, a blade grinder, or a hammer mill).

In some cases, plant material (e.g., legumes or other plant seeds) can be treated with one or more enzymes (e.g., one or more enzymes that can break components of the plant material into smaller pieces). For example, one or more enzymes can be used to break down lignin, cellulose, and/or protein in a plant material into dimers or monomers of protein and carbohydrate units (e.g., peptides and/or amino acids for proteins and simple sugars such as dextrose, fructose, galactose, or sucrose for carbohydrates). Any appropriate enzyme(s) can be used. Non-limiting examples of suitable enzymes include carbohydrases (e.g., amylase, α-amylase, β-amylase, lactase, sucrase, isomaltase, pectinase, cellulase, hemicellulase, xylanase, and/or tannase), proteases (e.g., bromelain, alkaline proteases, papain, and/or actinidin), and ligninase. In some cases, the plant material can be ground prior to being treated with one or more enzymes.

In some embodiments, plant material (e.g., legumes or other plant seeds) is treated with one or more enzymes (e.g., one, two, three, four, five, or more enzymes). In some embodiments, plant material can be treated with one enzyme (e.g., any of the enzymes described herein such as a carbohydrase, a protease, or a pectinase). In some embodiments, plant material can be treated with two or more enzymes (e.g., any two of the enzymes described herein such as a carbohydrase and a protease). In some embodiments, plant material can be treated with three or more enzymes (e.g., any three of the enzymes described herein such as a carbohydrase, a protease, and a pectinase).

The enzyme treatment can be carried out under any appropriate conditions. Enzyme treatments can be repeated with the same or a different enzyme. For example, a first enzymatic treatment can occur with one or more enzymes or group (e.g., two or more) of enzymes (e.g., two or more enzymes), followed by a second enzymatic treatment with the same or different enzyme or group of enzymes.

In some cases, one or more enzymatic treatments can be used in a process in conjunction with one or more chemical treatments with an acid or base. For example, a chemical treatment of a fruit seed such as date seeds or fruit seeds can be a treatment with a caustic agent such as NaOH and be followed by one or more enzymatic treatments with one or more enzymes such as a carbohydrases. A treatment for a legume such as a chickpea, for example can include an initial treatment with an acid solution to facilitate acid hydrolysis followed by one or more enzymatic treatment to break down starches using one or more carbohydrases followed by a second enzymatic treatment to break down proteins using one or more proteases. The caustic, acid, or enzymatic treatments can occur in series fashion one after another, can occur before or after roasting the material that is treated, or can occur before the treated material is ground. In some cases, the plant-based material is treated with carbohydrases after acid hydrolysis. For example, the plant-based material can be treated with the carbohydrases, α-amylase and/or β-amylase, either individually and/or in combination. α-Amylase is known to hydrolyze the internal α-1,4-glycosidic bonds within starch and glycogen, resulting in maltose, maltotriose, and dextrins. β-amylase acts on the non-reducing ends of starch and glycogen, breaking the terminal α-1,4-glycosidic bond to produce maltose.

In some cases, α-amylase and/or β-amylase treatment can be followed by enzymatic treatment with lactase, sucrase, and/or isomaltase; these enzymes break down products produced by enzymatic treatment of the plant material with α-amylase & β-amylase. In certain other cases, the plant-based material can be treated with proteases after acid hydrolysis. Proteases, include, but are not limited to, bromelain, alkaline proteases, papain, and actinidin. In yet other cases, combinations of carbohydrases and proteases can be used simultaneously or in series. In some cases, a caustic treatment with a base can be followed by acid treatment in plant-based material, including, but not limited to, fruit or vegetable seeds such as grape seeds or date seeds. In some cases, the caustic treatment of a plant-based material (e.g., any of the plant-based materials described herein) with a base can be followed by acid treatment, followed by enzymatic treatment with enzymes including carbohydrases and/or proteases in in plant-based material, including but not limited to, legumes such as chickpeas, lentils, peas, beans, or fruit or vegetable seeds such as grape seeds or date seeds.

After treatment with one or more enzymes, the plant material can be further processed in any appropriate manner. In some cases, for example, the enzyme solution can be removed from the plant material, and the enzyme pre-treated plant material (e.g., enzymatically-treated plant material) can then be roasted to an appropriate temperature, ground to an appropriate particle size, and/or extracted.

In some cases, for example, the enzymatically-treated plant material can be roasted to a temperature of about 165° C. to about 250° C. (e.g., about 165° C. to about 170° C., about 170° C. to about 175° C., about 175° C. to about 180° C., about 180° C. to about 185° C., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 165° C. to about 175° C., about 170° C. to about 180° C., about 175° C. to about 185° C., about 180° C. to about 190° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 220° C. to about 230° C., about 225° C. to about 235° C., about 230° C. to about 240° C., about 235° C. to about 245° C., about 240° C. to about 250° C., about 185° C. to about 200° C., about 200° C. to about 225° C., about 225° C. to about 250° C., about 165° C., about 170° C., about 175° C., about 180° C., about 185° C., about 190° C., about 195° C., about 200° C., about 205° C., about 210° C., about 215° C., about 220° C., about 225° C., or about 250° C.). In some cases, the enzymatically-treated plant material can be roasted to a temperature of about 185° C. to about 225° C., about 185° C. to about 195° C., about 190° C. to about 200° C., about 195° C. to about 205° C., about 200° C. to about 210° C., about 205° C. to about 215° C., about 210° C. to about 220° C., about 215° C. to about 225° C., about 185° C. to about 190° C., about 190° C. to about 195° C., about 195° C. to about 200° C., about 200° C. to about 205° C., about 205° C. to about 210° C., about 210° C. to about 215° C., about 215° C. to about 220° C., about 220° C. to about 225° C., about 185° C. to about 200° C., about 200° C. to about 225° C., about 180° C., about 185° C., about 190° C., about 195° C., about 200° C., about 205° C., about 210° C., about 215° C., about 220° C., or about 225° C. Any appropriate type of roaster can be used (e.g., an electric coffee roaster, a convective/conductive roaster, a drum roaster, a tangential roaster, or an impingement oven roaster).

In some cases, the enzymatically-treated and/or chemically-treated, and optionally roasted plant material can be ground to any appropriate particle size. For example, an enzymatically-treated and/or chemically-treated and optionally roasted plant material can be ground to a mean particle size from about 0.1 mm to about 5 mm (e.g.,
about 0.1 mm to about 0.25 mm, about 0.15 mm to about 0.30 mm, about 0.25 mm to about 0.5 mm, about 0.4 mm to about 0.6 mm, about 0.5 mm to about 1 mm, about 0.75 mm to about 1.25 mm, about 1 mm to about 2 mm, about 1.5 mm to about 2.5 mm, about 2 mm to about 3 mm, about 2.5 mm to about 3.5 mm, about 3 mm to about 4 mm, about 3.5 mm to about 4.5 mm, or about 4 mm to about 5 mm). Any suitable equipment can be used to grind the plant material (e.g., a wet mill, a crushing mill, a burr mill, an espresso grinder, a stone mill, a jet mill, a blade grinder, or a hammer mill).

In some cases, chemical treatment can include contacting the plant material with an acid treatment, followed by a caustic treatment, followed by enzymatic treatment with one or more enzymes including, but not limited to carbohydrases and/or proteases. In some cases, the plant-based material can be treated with an acid solution, either before or after roasting and/or before or after grinding the material into a grounds. In some cases, plant materials can be treated with one or more enzymes prior to extraction. In some cases, the plant-based material can be treated with an acid treatment, after which it can be roasted and ground, and then treated with one or more enzymes such as one or more carbohydrases and/or one or more proteases during extraction in water. In some cases, the plant-based material can be treated with an acid or base followed by roasting and then treatment with one or more enzymes including one or more carbohydrates and/or proteases before the material is ground.

In some cases, plant-based material such as, without limitation, fruit seeds (e.g., grape seeds or date seeds) can be enzymatically treated with one or more enzymes such as tannase, followed by a caustic treatment with a base. In some cases, the plant-based material, such as materials that contain lignocellulose, lignins, hemicellulose and/or cellulose, such as fruit seeds, berry seeds, date seeds, and grape seeds, can be treated with one or more enzymes such as cellulases, ligninases, and/or hemicellulases before acid or caustic treatment.

In some cases, the plant-based material can be treated with cellulases, ligninases, and/or hemicellulases followed or preceded by enzymatic treatment one or more enzymes such as carbohydrases and/or proteases, where no caustic or acid treatment of the plant-based material is carried out prior to roasting. In some cases, plant-based material can be treated with one or more enzymes such as cellulases, ligninases, and/or hemicellulases after roasting.

In some cases, plant-based material can be treated with one or more enzymes such as cellulases, ligninases, and/or hemicellulases after grinding. For example, ground plant material (e.g., ground plant substrate) can be treated with a solution containing about 0.1% to about 1% enzyme (e.g., about 0.3% or about 0.5% enzyme) at a weight ratio of about 100:1 seed to enzyme. In some cases, the plant material can be incubated or contacted with an enzyme solution for about 15 to about 60 minutes (e.g., about 15 to about 30 minutes, about 20 to about 30 minutes, about 30 to about 45 minutes, about 40 to about 50 minutes, about 45 to about 60 minutes, about 15 minutes, about 20 minutes, about 25 minutes, about 30 minutes, about 30 minutes, about 35 minutes, about 40 minutes, or about 45 minutes). In some cases, the plant material can be incubated or contacted with an enzyme solution at a temperature of about 30° C. to about 80° C. (e.g., about 30° C. to about 40° C., about 35° C. to about 45° C., about 40° C. to about 50° C., about 45° C. to about 55° C., about 50° C. to about 60° C., about 55° C. to about 65° C., about 60° C. to about 70° C., about 65° C. to about 75° C., about 70° C. to about 80° C., about 35° C., about 40° C., about 45° C., about 50° C., about 55° C., about 60° C., about 65° C., about 70° C., about 75° C., or about 80° C.). In some cases, a plant material can be incubated or contacted with an enzyme solution at a pH of about 7 to about 9 (e.g., about 7 to about 7.5, about 7.25 to about 7.75, about 7.5 to about 8, about 7.75 to about 8.25, about 8 to about 8.5, about 8.25 to about 8.75, about 8.5 to about 9, about 8.75 to about 9.25, about 7, about 7.25, about 7.5, about 7.75, about 8, about 8.25, about 8.5, about 8.75, or about 9).

The ground particles of plant material, e.g., ground plant substrates, (e.g., any of the ground particles of plant material or ground plant substrates described above) can be used in consumable food and beverage products. In some cases, ground particles of plant material can be used in consumable food and beverage products such as coffee substitute beverage made of acid-hydrolyzed and roasted chickpeas ground and extracted in water.

In some cases, ground particles of plant material can be extracted, and the extract can be used in consumable food and beverage products. In some cases, ground particles of plant material (e.g., ground plant substrate) can be extracted in an aqueous solution (e.g., water), and the extract can be used in consumable food and beverage products.

In some embodiments, a treated (e.g., a chemically and/or enzymatically treated), roasted and ground plant material (e.g., a treated, roasted, and ground plant substrate) can be combined with water for an appropriate length of time to form an extract. In some embodiments, a treated (e.g., a chemically and/or enzymatically treated), roasted and ground plant material (e.g., a treated, roasted, and ground plant substrate) is combined with water at any appropriate temperature (e.g., about 50° C. to about 195° C., about 50° C. to about 175° C., about 50° C. to about 150° C., about 50° C. to about 125° C., about 50° C. to about 100° C., about 50° C. to about 75° C., about 50° C. to about 60° C., about 60° C. to about 195° C., about 60° C. to about 175° C., about 60° C. to about 150° C., about 60° C. to about 125° C., about 60° C. to about 100° C., about 60° C. to about 85° C., about 60° C. to about 75° C., about 70° C. to about 195° C., about 70° C. to about 175° C., about 70° C. to about 150° C., about 70° C. to about 125° C., about 70° C. to about 100° C., about 70° C. to about 90° C., about 80° C. to about 195° C., about 80° C. to about 175° C., about 80° C. to about 150° C., about 80° C. to about 125° C., about 80° C. to about 100° C., about 80° C. to about 90° C., about 100° C. to about 195° C., about 100° C. to about 175° C., about 100° C. to about 150° C., about 100° C. to about 125° C., about 125° C. to about 195° C., about 125° C. to about 175° C., about 125° C. to about 150° C., about 150° C. to about 195° C., about 150° C. to about 175° C., or about 175° C. to about 195° C.,) (e.g., in a recirculating pot) for an appropriate length of time (e.g., about 5 to about 60 minutes, about 5 to about 45 minutes, about 5 to about 20 minutes, about 10 to about 45 minutes, about 10 to about 60 minutes, about 10 to about 20 minutes, about 20 to about 60 minutes, about 20 to about 30 minutes, about 20 to about 45 minutes, about 30 to about 60 minutes, about 30 to about 45 minutes, or about 45 to about 60 minutes). In some embodiments, a roasted and ground plant material (e.g., a roasted and ground plant substrate) can be combined with water at any appropriate temperature (e.g., about 50° C. to about 175° C., about 50° C. to about 150° C., about 50° C. to about 125° C., about 50° C. to about 100° C., about 50° C. to about 75° C., about 50° C. to about 60° C., about 60° C. to about 175° C., about 60° C. to about 150° C., about 60° C. to about 125° C., about 60° C. to about 100° C., about 60° C. to about 85° C., about 60° C. to about 75° C., about 70° C. to about 175° C., about 70° C. to about 150° C., about 70° C. to about 125° C., about 70° C. to about 100° C., about 70° C. to about 90° C., about 80° C. to about 175° C., about 80° C. to about 150° C., about 80° C. to about 125° C., about 80° C. to about 100° C., about 80° C. to about 90° C., about 100° C. to about 175° C., about 100° C. to about 150° C., about 100° C. to about 125° C., about 125° C. to about 175° C., about 125° C. to about 150° C., about 150° C. to about 175° C.) (e.g., in a recirculating pot) for an appropriate length of time (e.g., about 5 to about 60 minutes, about 5 to about 45 minutes, about 5 to about 20 minutes, about 10 to about 45 minutes, about 10 to about 60 minutes, about 10 to about 20 minutes, about 20 to about 60 minutes, about 20 to about 30 minutes, about 20 to about 45 minutes, about 30 to about 60 minutes, about 30 to about 45 minutes, or about 45 to about 60 minutes).

The ground plant material (e.g., any of the ground particles of plant material or ground plant substrates described above including treated and/or roasted plant substrates) and the water can be combined in any appropriate relative amount. For example, the ground plant material can be combined with water at about 3% w/w to about 50% w/w (e.g., about 3% w/w to about 5% w/w, about 3% w/w to about 10% w/w, about 5% w/w to about 10% w/w, about 5% w/w to about 15% w/w, about 10% w/w to about 20% w/w, about 15% w/w to about 25% w/w, about 20% w/w to about 30% w/w, about 25% w/w to about 35% w/w, about 30% w/w to about 40% w/w, about 35% w/w to about 45% w/w, about 40% w/w to about 50% w/w, about 3% w/w, about 5% w/w, about 10% w/w, about 15% w/w, about 20% w/w, about 25% w/w, about 30% w/w, about 35% w/w, about 40% w/w, about 45% w/w, or about 50% w/w) grounds to water.

After extraction, the extract can be cooled and/or filtered, and then combined with other ingredients to generate a food or beverage product. In some cases, for example, an extract can be combined with caffeine, acids, and/or flavors or flavoring agents to generate a beverage suitable for use as a coffee replacement.

After extraction, the extract can be cooled, filtered, concentrated and/or dried and then combined with other ingredients to generate a food or beverage product. In some cases, for example, an extract can be combined with caffeine, acids, and flavors to generate a beverage suitable for use as a coffee replacement. In some cases, the extract can be further processed, such as by concentrating into a liquid concentrate or a soluble powder form. In some cases, the extract can be concentrated through evaporation and then spray dried to create a soluble solid (e.g., any of the solids described herein).

As used herein, “concentration” refers to the process of removing water from an extract through evaporation or freezing and thawing to increase the percent solids of the overall extract. This can be accomplished, for example, by processing an extract in a heated kettle, vacuum kettle, rising film evaporator, falling film evaporator, scraped film evaporator, freeze concentrator. The term “concentrate,” as a noun, generally refers to the liquid that results when an extract (e.g., any of the extracts described herein) has been processed to remove at least a portion, some, or most of the solvent base of the extract, including an aqueous solution such as water, an alcohol or other organic solvent base. A “concentrate” is also referred to herein as a “liquid concentrate.”

In some cases, a liquid concentrate can be dried to form a solid concentrate. As used herein, the term “solid concentrate,” as a noun, refers to the solid that results when an extract (e.g., any of the extracts described herein) or a liquid concentrate (e.g., any of the liquid concentrates described herein) has been dried (whether by spray-drying, freeze-drying, air-drying, heat-drying, or any other drying method) such that most or all of the solvent base of the extract or liquid concentrate has been removed. A solid concentrate can have the form of a granule, a pellet, or a powder.

In certain aspects, this document provides a powder concentrate, a granular concentrate, or a pelletized concentrate. In some cases, most of the water can be removed from the liquid concentrate to create a soluble granule, a soluble pellet, or a soluble powder that has between about 1%-10% moisture content (e.g., for beverage applications such as instant coffee powder “crystals”; ready-to-drink coffee beverages with caffeine, flavoring agents, sugar or sugar substitutes, and/or milk or milk substitutes; powdered milk; hot cocoa mix; or flavored drink powders) and dissolves readily in water, milk, or other beverage liquid substrates, whether hot or cold.

Drying the concentrate (e.g., a liquid concentrate) into a solid (e.g., a powder, granule, or pellet) can occur through any appropriate drying method, including, but not limited to, spray drying, freeze drying, and dehydrating. In some cases, one or more additional ingredients, such as maltodextrin or gum arabica, flow agents, anti-caking agents such as tricalcium phosphate, powdered or microcrystalline cellulose, or magnesium stearate, can be added to the soluble powder. A powder can be secondarily formed by grinding (e.g., power grinding) formed granules or pellets to reduce the average particle size of the granules or pellets and transform them into a powder.

The ground particles of plant material can be used in consumable food and beverage products. In some cases, ground particles of plant material can be extracted, and the extract can be used in consumable food and beverage products. For example, an enzyme-treated, roasted and ground plant material can be combined with water at any appropriate temperature (e.g., about 50° C. to about 100° C., about 50° C. to about 75° C., about 60° C. to about 85° C., about 70° C. to about 90° C., about 75° C. to about 100° C., or about 80° C. to about 100° C.) (e.g., in a recirculating pot) for an appropriate length of time (e.g., about 5 to about 60 minutes, about 5 to about 45 minutes, about 10 to about 20 minutes, about 20 to about 30 minutes, about 30 to about 45 minutes, or about 45 to about 60 minutes). The ground plant material and the water can be combined in any appropriate relative amount. For example, the ground plant material can be combined with water at about 3% w/w to about 50% w/w (e.g., about 3% w/w to about 5% w/w, about 3% w/w to about 10% w/w, about 5% w/w to about 10% w/w, about 5% w/w to about 15% w/w, about 10% w/w to about 20% w/w, about 15% w/w to about 25% w/w, about 20% w/w to about 30% w/w, about 25% w/w to about 35% w/w, about 30% w/w to about 40% w/w, about 35% w/w to about 45% w/w, about 40% w/w to about 50% w/w, about 3% w/w, about 5% w/w, about 10% w/w, about 15% w/w, about 20% w/w, about 25% w/w, about 30% w/w, about 35% w/w, about 40% w/w, about 45% w/w, or about 50% w/w) grounds to water.

After extraction, the extract can be cooled, filtered, concentrated and/or dried and then combined with other ingredients to generate a food or beverage product. In some cases, for example, an extract can be combined with caffeine, acids, and flavors to generate a beverage suitable for use as a coffee replacement.

Also provided herein is a composition containing a ground plant substrate prepared using a method described herein (e.g., any of the ground plant substrates prepared using a method described herein). In some cases, a composition provided herein contains an extract prepared using a method described herein (e.g., any of the extracts prepared using a method described herein). In some cases, a composition provided herein contains a concentrate prepared using a method described herein (e.g., any of the concentrates prepared using a method described herein).

The compositions described herein can be a consumable food or beverage. For example, the compositions described herein can be a coffee replica such as a coffee granule replica, a coffee grounds replica, a coffee beverage replica.

In some embodiments, a coffee beverage replica further comprises one or more of caffeine, a flavor, a sugar or sugar substitute, milk, a dairy solid, milk substitute, and a non-dairy solid. Non-limiting examples of a sugar or sugar substitute include sucrose, fructose, a sugar alcohol, allulose, stevia, monk fruit, aspartame, acesulfame potassium, sucralose, a derivative of the above or a combination thereof. Dairy solids can include milk solids, whey solids, casein, lactose, or a combination thereof. Milk solids include the non-water components of milk (e.g., carbohydrates such as lactose sugar, fats, and proteins such as casein and whey). Whey is a liquid byproduct obtained during cheese production. Whey solids include the non-water components of whey, such as proteins, lactose, and minerals. Casein is a protein found in milk. Lactose is a carbohydrate found in milk. Milk substitutes include liquid substitutes for animal milk (e.g., cow, goat, or sheep milk). Milk substitutes can be non-dairy or plant-based, e.g., a milk based on soy, coconut, almond, oat, cashew, peanut, flax, or hemp. Non-dairy solids include solids made from plant-derived oils such as coconut oil, palm oil, or soybean oil, emulsifiers, thickeners, and/or stabilizers.

### Exemplary Embodiments

Embodiment 1 is a method for preparing a ground plant substrate from a fibrous, lignocellulosic and/or proteinaceous plant material for use in a consumable food or beverage, wherein the method comprises: treating the plant material with an acid in aqueous solution until the plant material reaches a pH of 1 to 5, thereby generating an acid-treated plant material, roasting the acid-treated plant material to generate a roasted, acid-treated plant material, and grinding the roasted, acid-treated plant material to yield the ground plant substrate.

Embodiment 2 is the method of embodiment 1, wherein the plant material comprises legumes.

Embodiment 3 is the method of embodiment 2, wherein the legumes comprise chickpeas, lentils, peas, black beans, or cranberry beans.

Embodiment 4 is the method of embodiment 1, wherein the plant material comprises fruit seeds or vegetable seeds.

Embodiment 5 is the method of embodiment 4, wherein the fruit seeds or vegetable seeds comprise date seeds or grape seeds.

Embodiment 6 is the method of any one of embodiments 1 to 5, wherein the acid comprises phosphoric acid, hydrochloric acid, or sulfuric acid.

Embodiment 7 is the method of any one of embodiments 1 to 6, comprising treating the plant material until a pH between about 2 to about 3 is reached.

Embodiment 8 is the method of any one of embodiments 1 to 7, comprising treating the plant material at a temperature of about 40° C. to about 90° C.

Embodiment 9 is the method of any one of embodiments 1 to 8, comprising treating the plant material for about 15 minutes to about 120 minutes.

Embodiment 10 is the method of any one of embodiments 1 to 9, wherein the acid is phosphoric acid, and wherein the method comprises incubating the plant material with the phosphoric acid at a temperature of about 60° C. to about 90° C. until a pH of 2 to 3 is reached.

Embodiment 11 is the method of any one of embodiments 1 to 10, comprising roasting the acid-treated plant material to a temperature of about 165° C. to about 250° C.

Embodiment 12 is the method of any one of embodiments 1 to 11, comprising grinding the roasted, acid-treated plant material to an average particle size of about 0.1 mm to about 5 mm.

Embodiment 13 is the method of any one of embodiments 1 to 12, further comprising extracting the ground plant substrate with an aqueous solution to produce an extract.

Embodiment 14 is the method of embodiment 13, wherein the method comprises extracting the ground plant substrate with water at a temperature of about 60° C. to about 85° C.

Embodiment 15 is the method of embodiment 13 or embodiment 14, further comprising cooling the extract.

Embodiment 16 is the method of any one of embodiments 13 to 15, further comprising filtering the extract.

Embodiment 17 is the method of any one of embodiments 13 to 16, further comprising concentrating the extract to form a concentrate.

Embodiment 18 is the method of embodiment 17, wherein the method comprises concentrating the extract by removing at least a portion of the water.

Embodiment 19 is the method of embodiment 18, wherein a portion of the water is removed by evaporation, freezing, and/or thawing of the extract.

Embodiment 20 is the method of any one of embodiments 17 to 19, further comprising drying the concentrate to form a powder concentrate.

Embodiment 21 is the method of embodiment 20, wherein the drying comprises spray drying, freeze drying or dehydrating.

Embodiment 22 is the method of embodiment 20 or embodiment 21, wherein the powder concentrate comprises a soluble powder having a moisture content from about 1% w/w to about 10% w/w.

Embodiment 23 is the method of embodiment 22, wherein the soluble powder is water soluble.

Embodiment 24 is a composition comprising a ground plant substrate prepared using the method of any one of embodiments 1 to 23.

Embodiment 25 is the composition of embodiment 24, wherein the composition is a consumable food or beverage.

Embodiment 26 is a composition comprising an extract prepared using the method of any one of embodiments 13 to 16.

Embodiment 27 is a composition comprising a concentrate prepared using the method of any one of embodiments 17 to 23.

Embodiment 28 is a method for preparing a ground plant substrate from fibrous, lignocellulosic and/or proteinaceous plant material for use in a consumable food or beverage, wherein the method comprises: contacting the plant material with an enzymatic solution containing one or more enzymes with agitation (e.g., stirring) from 15 to 120 minutes to generate an enzymatically-treated plant material, roasting the enzymatically-treated plant material to generate a roasted, enzymatically-treated plant material, and grinding the roasted, enzymatically-treated plant material to yield the ground plant substrate.

Embodiment 29 is the method of embodiment 28, wherein the one or more enzymes in the enzymatic solution are present in a concentration of about 1% w/w or less, and wherein the enzymatic solution is aqueous

Embodiment 30 is the method of embodiment 28, wherein the one or more enzymes in the enzymatic solution are present in a concentration between about 0.1% and about 1% w/w, and wherein the enzymatic solution is aqueous.

Embodiment 31 is the method of any one of embodiments 28 to 30, wherein the roasting takes place at a temperature from about 165° C. to about 250° C.

Embodiment 32 is the method of any one of embodiments 28 to 31, wherein the one or more enzymes comprise a carbohydrase, protease, amylase, pectinase, cellulase, hemicellulase, xylanase, ligninase, or tannase.

Embodiment 33 is the method of any one of embodiments 28 to 32, further comprising extracting the ground plant substrate with an aqueous solution to produce an extract.

Embodiment 34 is the method of embodiment 33, wherein the method comprises extracting the ground plant substrate with water at a temperature of about 60° C. to about 85° C.

Embodiment 35 is the method of embodiment 33 or 34, further comprising cooling the extract.

Embodiment 36 is the method of any one of embodiments 33 to 35, further comprising filtering the extract.

Embodiment 37 is the method of any one of embodiments 28 to 36, further comprising contacting the plant material with one or more chemical solutions, each chemical solution comprising an acid or a base, wherein the plant material is contacted with the one or more chemical solutions before the plant material is contacted with the enzymatic solution containing one or more enzymes.

Embodiment 38 is the method of any one of embodiments 28 to 36, further comprising contacting the enzymatically-treated plant material with one or more chemical solutions comprising an acid or base, wherein the enzymatically-treated plant material is contacted with the one or more chemical solutions before roasting, after roasting, before grinding and/or after grinding.

Embodiment 39 is the method of embodiment 37 or embodiment 38, wherein the one or more chemical solutions comprise an acid comprising phosphoric acid, hydrochloric acid, or sulfuric acid, or comprise a base comprising sodium hydroxide, potassium hydroxide, lye, sodium carbonate, calcium carbonate, calcium hydroxide, or potassium bicarbonate.

Embodiment 40 is the method of any one of embodiments 37 to 39, wherein the plant material is contacted with a base under agitation (e.g., stirring) for 15 to 120 minutes until the plant material reaches a pH between about 8 to about 10.

Embodiment 41 is the method of any one of embodiments 37 to 39, wherein the enzymatically-treated material is contacted with a base under agitation (e.g., stirring) for 15 to 120 minutes until the enzymatically-treated plant material reaches a pH between about 8 to about 10.

Embodiment 42 is the method of any one of embodiments 37 to 39, wherein the plant material is contacted with an acid under agitation (e.g., stirring) for 15 to 120 minutes until the plant material reaches a pH between about 1 to about 4.

Embodiment 43 is the method of any one of embodiments 37 to 39, wherein the enzymatically-treated plant material is contacted with an acid under agitation (e.g., stirring) for 15 to 120 minutes until the plant material reaches a pH of between about 1 to about 4.

Embodiment 44 is the method of embodiment 28, further comprising contacting the plant material with a chemical solution under agitation (e.g., stirring) for 15 to 120 minutes, wherein the chemical solution comprises an acid comprising phosphoric acid or comprises a base comprising sodium hydroxide, wherein the contacting with the chemical solution occurs before or after the plant material is contacted with the enzymatic solution, and wherein the enzymatic solution contains about 1% w/w or less of one or more enzymes comprising pectinase, cellulase, hemicellulase, xylanase, or tannase.

Embodiment 45 is the method of embodiment 44, wherein the plant material comprises legumes comprising chickpeas, lentils, peas, black beans or cranberry beans, or fruit seeds comprising date seeds or grape seeds.

Embodiment 46 is the method of embodiment 44, comprising grinding the roasted, enzymatically-treated plant material to an average particle size of about 0.1 mm to about 0.5 mm.

Embodiment 47 is a composition comprising a ground plant material substrate prepared using the method of any one of embodiments 28 to 46.

Embodiment 48 is the composition of embodiment 47, wherein the composition is a consumable food or beverage.

Embodiment 49 is a method of preparing a concentrate for a consumable food or beverage from a plant material, wherein the method comprises: contacting a plant material with an aqueous solution containing an acid to form a pre-treated plant material having a pH between about 1 and about 5, or contacting the plant material with a base to form a pre-treated plant material having a pH between about 8 and about 10, contacting the pre-treated plant material with an enzymatic solution containing one or more enzymes with agitation (e.g., stirring) from 15 to 120 minutes to generate an enzymatically-treated plant material, roasting the enzymatically-treated plant material to generate a roasted plant material, grinding the roasted, pre-treated plant material to yield a ground plant substrate having an average particle size of about 0.1 mm to about 5 mm, extracting the ground plant substrate with water to produce an extract, and concentrating the extract by removing at least a portion of the water to form a concentrate.

Embodiment 50 is the method of embodiment 49, further comprising adding caffeine, one or more acids, and/or one or more flavors to the extract.

Embodiment 51 is the method of embodiment 49 or embodiment 50, wherein the extract water is removed by evaporation, freezing, and/or thawing of the extract.

Embodiment 52 is the method of embodiment 50 or embodiment 51, wherein the one or more acids added to the extract comprise malic acid, tartaric acid, citric acid, lactic acid, fumaric acid, succinic acid, phosphoric acid, or any combination thereof.

Embodiment 53 is the method of embodiment 50 or embodiment 51, wherein the one or more flavors added to the extract comprise volatile organic compounds, essential oils, plant extracts, or oleoresins.

Embodiment 54 is a method for making a soluble plant-based powder for use in a consumable food or beverage, wherein the method comprises: (a) treating a plurality of plant seeds, beans, or peas with one or more chemical solutions, each solution comprising an aqueous solution containing an acid or a base, and/or one or more enzymatic solutions, each enzymatic solution comprising an aqueous solution containing one or more enzymes, thereby producing a plurality of treated plant seeds, beans, or peas; (b) roasting the treated plant seeds, beans, or peas, thereby producing roasted plant seeds, beans, or peas; (c) grinding the roasted plant seeds, beans, or peas, thereby producing a ground paste comprising particles having an average particle size of about 0.10 mm to about 5 mm; (d) extracting the ground paste in water at a temperature of about 60° C. to about 85° C. to produce an extract; (e) concentrating the extract by removing at least a portion of the water by evaporation, freezing, or thawing to form a concentrate; and (f) drying the concentrate, thereby yielding a soluble plant-based powder.

Embodiment 55 is the method of embodiment 54, wherein the plant seeds, beans, or peas comprise legumes comprising chickpeas, lentils, peas, black beans, or cranberry beans or fruit or vegetable seeds comprising date seeds or grape seeds.

Embodiment 56 is the method of embodiment 54 or embodiment 55, wherein the concentrate is dried to a moisture content between about 1% w/w to about 10% w/w.

Embodiment 57 is the method of any one of embodiments 54 to 56, wherein the concentrate is dried by spray drying, freeze drying, or dehydration using a kettle, vacuum kettle, rising film evaporator, falling film evaporator, scraped film evaporator, dehydrator, or freeze concentrator.

Embodiment 58 is the method of any one of embodiments 54 to 57, wherein the soluble plant-based powder is water soluble.

The invention will be further described in the following examples, which do not limit the scope of the invention described in the claims.

### EXAMPLES

### Methods for Measuring Suspended and Dissolved Solids

Turbidity by nephelometry for measurement of suspended solids: Nephelometric Turbidity Units (NTUs) are commonly used to classify the turbidity of a solution or liquid. NTUs provide a measure of suspended solids in a liquid, and often are used to define the quality and purity of drinking water, for example. The method involves passing light through a sample. The light bounces off of solids suspended in the sample, and the measure of scattered light is translated into an electronic signal that relates to the concentration of suspended solids.

Degrees Brix and Refractive Index for measurements of dissolved solids: Degrees Brix is a measure of the dissolved solids in a liquid and is usually measured via refractive index or specific gravity. One Degree Brix represents one gram of pure sucrose dissolved in 100 grams of solution and indicates the strength of the solution as a mass percent. Since there are generally more solids than just sucrose in solutions, Brix acts as an approximation of dissolved solids. With regard to the methods described herein, other simple sugars (e.g., glucose/dextrose, fructose, and other monosaccharides) were included in the Brix measurement. Refractive index is most often used as a rapid method for measuring dissolved solids. The refractive index method involves passing light through a sample. The degree of change in the rotation of the plane of light is correlated with the percentage of sugars dissolved in the liquid. That number is reflected directly as the Degrees Brix in the sample.

### Example 1—Hydrolysis of Legumes and Evaluation of their Roastability, Extractability, and Breakability

### Hydrolysis

To hydrolyze legumes (e.g., chickpeas), it is necessary to add enough acid, caustic agent, and/or enzyme to hydrolyze the starch and denature proteins without fully liquifying the legumes, such that the structure of the chickpeas is preserved and observed after the hydrolysis process. To achieve this, a solution of water and chickpeas was prepared. While measuring the pH continuously, sulfuric acid was added until a pH of 2 was reached. To determine the appropriate temperature and time of hydrolysis, the amount of acid was kept at a constant wt % concentration, and hydrolysis was performed at three different temperatures (60° C., 75° C., and 90° C.) for a fixed amount of time (30 minutes). The chickpeas were then roasted to a bean temperature of 215° C. in a drum roaster, and the roasted chickpeas were then extracted in a recirculating pot. The extract was cooled and degrees brix and NTUs were measured.

TABLE 1
Insoluble solids as a function of treatment temperature
Temperature Study

| | % of Acid | | | | |
|---|---|---|---|---|---|
| Acid | added | Time | Temperature | NTUs | Brix |
| Sulfuric Acid | 0.290 | 30 min | 60° C. | 220 | 1.6 |
| Sulfuric Acid | 0.290 | 30 min | 75° C. | 49.0 | 1.5 |
| Sulfuric Acid | 0.290 | 30 min | 90° C. | 51.3 | 1.4 |

As shown in TABLE 1, temperature affected the pre-treatment (e.g., acid-treatment) of chickpeas with sulfuric acid. Specifically, the acid hydrolysis improved as the treatment temperature increased, as shown by the reduced amount of insoluble solids indicated by the lower NTUs. A slight reduction in the Brix values as a function of temperature also was observed. Thus, there was a dramatic difference in the amount of insoluble solids observed in chickpeas treated at 60° C. versus 75° C., while the amount of soluble solids remained about the same. The observed difference in insoluble solids became negligible between 75° C. and 90° C.

The next parameter tested was time. In an attempt to ensure efficiency while still improving roastability and extractability, the temperature, amount of acid, and type of acid remained the same, but the hydrolysis reaction for different lengths of time (30 min, 60 min, or 90 min). The chickpeas were then roasted to a bean temperature of 215° C. in a drum roaster, and the roasted chickpeas were extracted in a recirculating pot. The individual structure of the chickpeas was preserved and observed after hydrolysis and again after roasting. No liquefaction of the chickpeas was observed. The extract was cooled and Degrees Brix and NTUs were measured.

TABLE 2
Insoluble solids as a function of treatment time
Time Study

| | % of Acid | | | | |
|---|---|---|---|---|---|
| Acid | added | Time | Temperature | NTUs | Brix |
| Sulfuric Acid | 0.290 | 30 mins | 75° C. | 84.3 | 1.8 |
| Sulfuric Acid | 0.290 | 60 mins | 75° C. | 63.0 | 2.0 |
| Sulfuric Acid | 0.290 | 90 mins | 75° C. | 38.6 | 1.6 |

As shown in TABLE 2, there was a consistent improvement in treatment as treatment time was increased. The insoluble solids present in the extract, as reflected by the NTU values, decreased consistently as the hydrolysis time was increased. The level of dissolved solids, reflected by the Brix values, initially rose but then decreased as a function of time.

After the hydrolysis parameters were identified, the efficiency of different acids was evaluated. Phosphoric acid, hydrochloric acid, and sulfuric acid were tested in order to determine which acid was the most efficient at denaturing proteins and hydrolyzing starches. In these studies, the reaction temperature was kept constant, but the type of acid was varied. Hydrolysis was performed with the different acids (and a no acid control) at acid quantities such that the final pH of the chickpeas was the same. The chickpeas were then roasted to a bean temperature of 215° C. in a drum roaster. The individual structure of the chickpeas was preserved and observed after hydrolysis and again after roasting. No liquefaction of the chickpeas was observed. The roasted chickpeas were extracted in a recirculating pot. The extract was cooled and Degrees Brix and NTUs were measured.

As shown in TABLE 3, all three acids showed improvements over non-acid treated chickpeas, as a significant decrease in insoluble solids was observed in the final extract when the chickpeas had been treated with an acid. Phosphoric acid and hydrochloric acid showed the most dramatic results. Since phosphoric acid is generally less corrosive than hydrochloric acid, phosphoric acid may be more suitable for these applications.

TABLE 3
Insoluble solids measured after treatment with different acids
Type of Acid

| | % of Acid | | | | |
|---|---|---|---|---|---|
| Acid | added | Time | Temperature | NTUs | Brix |
| No Acid | 0.00 | 30 min | 75° C. | 135.6 | 1.78 |
| Sulfuric Acid | 0.290 | 30 min | 75° C. | 84.3 | 1.80 |
| Phosphoric Acid | 0.175 | 30 min | 75° C. | 31.1 | 1.91 |
| Hydrochloric Acid | 0.175 | 30 min | 75° C. | 16.8 | 1.75 |

### Roastability

When pH adjusted and/or enzymatically treated ingredients were roasted in the same manner (i.e., for the same roast time and at the same temperature) and assessed using the LAB color scale, the L values, which indicate roast level, decreased significantly as compared to ingredients that were not pH adjusted and/or enzymatically treated. The LAB color space is a color model that is designed to approximate human vision and perception. It consists of three components: L for lightness of color, A for the green-to-red axis, and B for the blue-to-yellow axis. The L value, which ranges from 0 to 100, represents the perceived lightness of the color. A value of 0 represents black, while a value of 100 represents white. The L value measures how dark or light a color appears, independent of its chromatic properties. This makes it a valuable tool in color analysis and color correction, as it allows for precise adjustments to the lightness of a color while keeping the color's perceived hue and saturation constant. A Nix Colorimeter Pro 2, which is a device designed for color measurement and analysis, was used to determine L values for chickpeas that had been roasted to an internal temperature of 160° C., 180° C., 200° C., or 215° C. and then ground using a Baratza ESP grinder. Two (2) grams of ground and roasted chickpeas were placed on disposable sample containers. Color values were obtained three times per roast. Only the L value (of the LAB color scale values) was considered since the L value is commonly used to indicate the degree of roasting. A decrease in the L value is an indication of an increase in compounds that cause a browning reaction (e.g., Maillard, Strecker degradation, and/or caramelization), and also is an analytical indicator of higher roastability of the treated ingredients.

TABLE 4
L values of acid-treated v. non-treated chickpeas

| | |
|---|---|
| Acid Treated Chickpeas | Non-Treated Chickpeas |

| Temperature (° C.) | L Value | Temperature (° C.) | L Value |
|---|---|---|---|
| 160 | 48.3 | 160 | 53.4 |
| 180 | 37.4 | 180 | 41.7 |
| 200 | 22.4 | 200 | 29.2 |
| 215 | 11.6 | 215 | 17.5 |

As shown in TABLE 4, there was a marked color difference between acid-treated chickpeas and non-treated chickpeas (both of which were roasted). In particular, it was observed that when acid treated and non-treated beans were heated to the same bean temperature, the acid treated chickpeas had significantly lower L values. This was observed when beans were tested at 160° C., 180° C., 200° C., and 215° C. Thus, for a given roast temperature, acid-treated chickpeas had significantly lower L values than their non-treated counterparts, and thus demonstrated an increase in roastability.

### Extractability

The pre-treatment (e.g., acid treatment) processes increased the extractability of the chickpeas, as evidenced by the higher percentage of solids achieved in hydrolyzed chickpeas as compared to untreated control chickpeas. In these studies, ground roasted chickpeas were extracted in water in a recirculation pot in which the grounds were laid on top of a false bottom. The extraction was conducted at 85° C. for ten minutes. As the water percolated through the bed of ground chickpeas, it was pumped over the top. When analyzing yields, the volume of water going in versus the volume of extract that comes out were taken into account.

As shown in TABLE 5, the acid hydrolyzed chickpeas treated with phosphoric acid absorbed less water when extracted and thus, when using the same extraction method, the yield of extract was much higher. In addition, the Brix values were higher and the NTUs were lower. These results indicate a higher quality, higher soluble solids extract and thus, higher extractability. When the ingredients were extracted in hot water, the NTU's (indicating turbidity) were appreciably lower, and a reduction in sedimentation also was observed.

TABLE 5
Extractability of acid treated and non-treated chickpeas

| | % Chickpeas | Water in | Water Out | Yield | Brix | NTU |
|---|---|---|---|---|---|---|
| Acid Hydrolyzed | 16% | 3679.6 | 2944.0 | 80.01% | 4.30 | 27 |
| Chickpeas | | | | | | |
| Non-Acid hydrolyzed | 16% | 3679.6 | 2328.2 | 63.27% | 4.05 | 43 |
| Chickpeas | | | | | | |

TABLES 6A and 6B expand on the findings presented in TABLE 5 to evaluate other legumes. In addition to chickpeas discussed above, and as shown in TABLES 6A and 6B, extractability experiments were conducted with other legumes-specifically, lentils, split peas, black beans, and cranberry beans. It was found that the same acid treatment, when applied to the other legumes, resulted in improved extractability and roastability. For example, treating these legumes with phosphoric acid before roasting generally resulted in an increase in Brix, a decrease in NTUs, and a decrease in L value, indicating an increase in soluble solids and a decrease in insoluble solids while producing a darker roast when using the same roasting and extracting techniques as the untreated counterparts.

TABLE 6A
Extractability of acid-treated and non-treated legumes

| | % Phosphoric | | L Value of | Water | Water | | |
|---|---|---|---|---|---|---|---|
| | Acid | % Legume | Grounds | in (gs) | out (gs) | % Yield | Brix |
| Un-treated Lentils | 0.175% | 10% | 20.6 | 200 | 179.66 | 89.83% | 0.5 |
| Phosphoric Acid | 0.175% | 10% | 15.30 | 200 | 178.22 | 89.11% | 1.10 |
| Treated Lentils | | | | | | | |
| Un-treated Split | 0.175% | 10% | 21.7 | 200 | 177.00 | 88.50% | 0.4 |
| Peas | | | | | | | |
| Phosphoric Acid | 0.175% | 10% | 17.4 | 200 | 177.00 | 88.50% | 0.6 |
| Treated Split Peas | | | | | | | |

TABLE 6B
Extractability of acid-treated and non-treated legumes

| | % | % | L Value of | Water | Water | % | | |
|---|---|---|---|---|---|---|---|---|
| | Acid | Legume | Grounds | in (gs) | out (gs) | Yield | Brix | NTU |
| Un-treated | 0.000% | 10% | 20.6 | 200 | 179.66 | 89.83% | 0.5 | 20.12 |
| Lentils | | | | | | | | |
| Phosphoric Acid | 0.175% | 10% | 15.30 | 200 | 178.22 | 89.11% | 1.10 | 17.21 |
| Treated Lentils | | | | | | | | |
| Un-treated Split | 0.000% | 10% | 21.7 | 200 | 177.00 | 88.50% | 0.4 | 26 |
| Peas | | | | | | | | |
| Phosphoric Acid | 0.175% | 10% | 17.4 | 200 | 181.20 | 90.60% | 0.6 | 22.82 |
| Treated Split | | | | | | | | |
| Peas | | | | | | | | |
| Un-treated Black | 0.000% | 10% | 15.3 | 200 | 176.00 | 88.00% | 0.15 | 21.53 |
| Beans | | | | | | | | |
| Phosphoric Acid | 0.175% | 10% | 14.70 | 200 | 178.23 | 89.12% | 0.30 | 25.94 |
| Black Beans | | | | | | | | |
| Un-treated | 0.000% | 10% | 19.7 | 200 | 175.10 | 87.55% | 0.1 | 47.13 |
| Cranberry Beans | | | | | | | | |
| Phosphoric Acid | 0.175% | 10% | 17.4 | 200 | 176.60 | 88.30% | 0.3 | 40.18 |
| Cranberry Beans | | | | | | | | |

### Breakability

A texture analysis instrument, commonly referred to as TA.XT, was used to determine the breakability (or break force) of the ground roasted legumes. When grinding a roasted ingredient, the first step is to break the ingredient, and it is common to correlate a roasted ingredient's grindability to its breakability. As used herein, breakability, otherwise known as friability, refers to how easily an ingredient breaks under the application of force, as measured by TA.XT. How well a roasted ingredient will grind is correlated to how easily it can be broken. Additionally, it has now been found that this observed correlation between grindability and breakability can be extrapolated to indicate how a product will respond to food processing operations such as grinding, which breaks down food products into smaller pieces to facilitate manufacturing. In general, breakability testing is performed by placing an ingredient on a testing stage. A flat moving instrument probe of the TA.XT is lowered mechanically onto the material on the testing stage. The machine is designed to measure the force the probe exerts to move downward. When the probe reaches the material on the stage, it experiences resistance and thus must exert more force to continue moving downward. If the material is extremely hard, the probe will experience high levels of resistance and will exert an increasing amount of force until the machine reaches its maximum and the test ends. Once the material breaks, the force needed to continue lowering the probe to the stage height is reduced. The probe typically experiences a higher degree of resistance in the beginning of a test, with a sudden drop in force required as the material being tested breaks into pieces. This is referred to as the “initial break force.” However, the probe continues to move downward toward the stage and exerts force on the smaller pieces of the material, resulting in peaks of higher force followed by large drops in force as the pieces break into smaller and smaller portions. Once the probe hits the stage, the test is over. If a material is very friable (i.e., prone to breaking), the instrument probe will experience multiple breakage events.

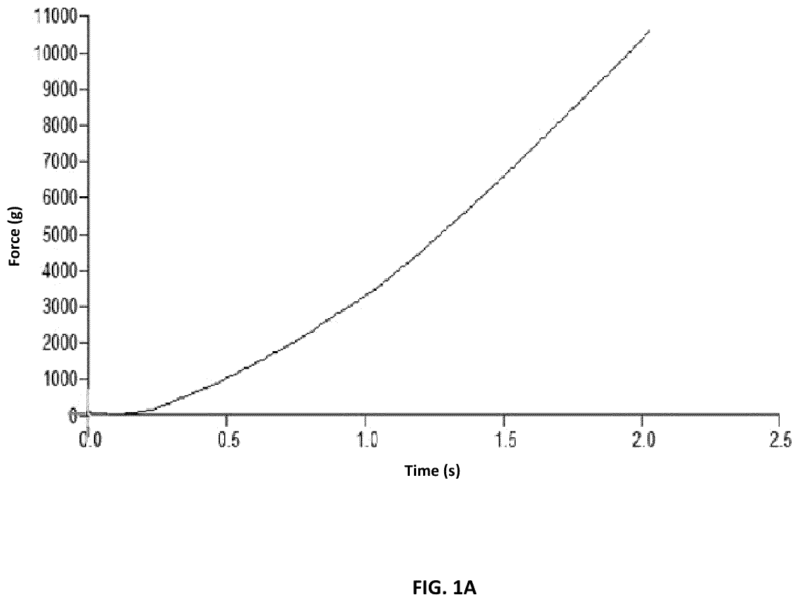

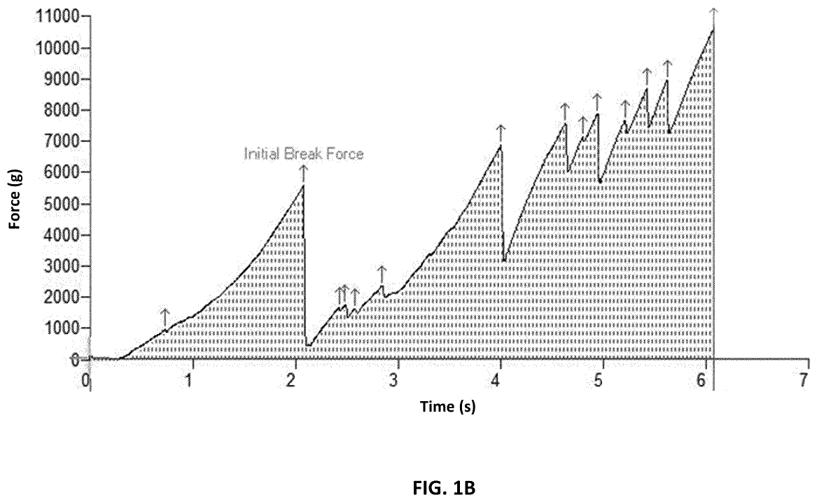

Chickpeas typically have a dense and hard starchy structure upon drying or roasting and therefore, are difficult to grind/break down. When chickpeas that had not been pre-treated (e.g., by acid hydrolysis) were roasted until they reached an internal temperature of 209° C., the chickpeas were extremely dense and hard. In fact, the TA.XT instrument could not break the untreated roasted chickpeas in a standard break force test. In fact, the equipment overloaded due to the hardness of the chickpeas and was unable to show a measurement (FIG. 1A). This indicated that it would be particularly challenging to grind chickpeas for processing into a food product, such as a coffee replica beverage. However, when the chickpeas were subjected to acid hydrolysis test with 0.175% phosphoric acid for 30 minutes at 75° C., followed by dehydrating the chickpeas until they reached a moisture content of 12% and then roasting the chickpeas to an internal chickpea temperature of 209° C. for the same amount of time as the control (non-treated) chickpeas, the chickpeas were much more friable. When performing a break force test was performed on pretreated (e.g., acid-treated) and roasted chickpeas, the TA.XT was successful at breaking the chickpeas with multiple breakage events. A representative plot is graphically represented in FIG. 1B. These results indicated that the acid hydrolysis treatment enhanced the processability of the chickpeas by increasing their breakability.

### Example 2—Enzymatic Treatment of Lignocellulosic Plant Substrates

Grape seeds, with their fibrous structure and relatively high lignin (lignocellulosic) content, are typically challenging to break down with traditional food processing methods. Further studies were conducted to test the efficacy of enzyme breakdown as a pre-treatment for grape seeds. As discussed below with regard to the grape seed processing studies, lignin swelling at higher pH along with caustic treatment, in combination with an enzyme treatment, showed higher grindability for every enzyme treatment tested as compared to control and also as compared to pH treatment alone. As described below, grape seeds from white wine grapes were subjected to various treatments and then ground in a stone melanger, demonstrating that the presently described treatment methods dramatically improved process efficiency, as the grape seeds were more friable and more readily ground, without causing liquefaction such that the structure of the grape seeds were preserved to make them suitable for roasting and grinding.

A Hegman gauge (grindometer) can be used to measure the mean particle size of wet material, such as roasted and milled wet seeds, grapeseed liquor, seeds to which fat or liquid has been added then wet milled into a paste, seeds to which fat or liquid has been added after dry milling, grapeseed filler, berry seed filler, control chocolate product, chocolate with filler, or any other chocolate product. To prepare the grape seed samples for the present studies, an aliquot was diluted 1:1 with a neutral oil (e.g., sunflower oil) to break up any agglomerates. The grindometer has a base with grooves having heights that can be calibrated to the diameter of the particles. An aliquot of diluted material was poured into the grooves. Moving from the larger end to the smaller end (that is, from deeper to shallower grooves), the grindometer was pressed with a steel flat edge (a scraper) at a slight angle. Upon reaching the end of the gauge, a pattern in the grooves was observed. In particular, streaking indicated that the particle size was larger than the groove depth at that point. The groove location where the streaking initially formed indicated the high end of the distribution, and the point at which 50-75% of the surface streaking was observed indicated the average particle size. Thus, the grindometer provided an indication of particle size distribution in addition to average particle size.

Additional measurements were obtained to determine if there was any evidence of further breakdown of the grape seeds into smaller pieces. These measurements were obtained using a Zahn cup (ASTM D4212), which is a measure often used in the dairy industry to measure the viscosity of materials. In particular, a Zahn cup measures the time it takes for a material to flow through a standardized hole drilled through the cup. The less time it takes for a material to flow through the cup, the less viscous the material is. In contrast, if a material takes more time to flow through the cup, it is more viscous.

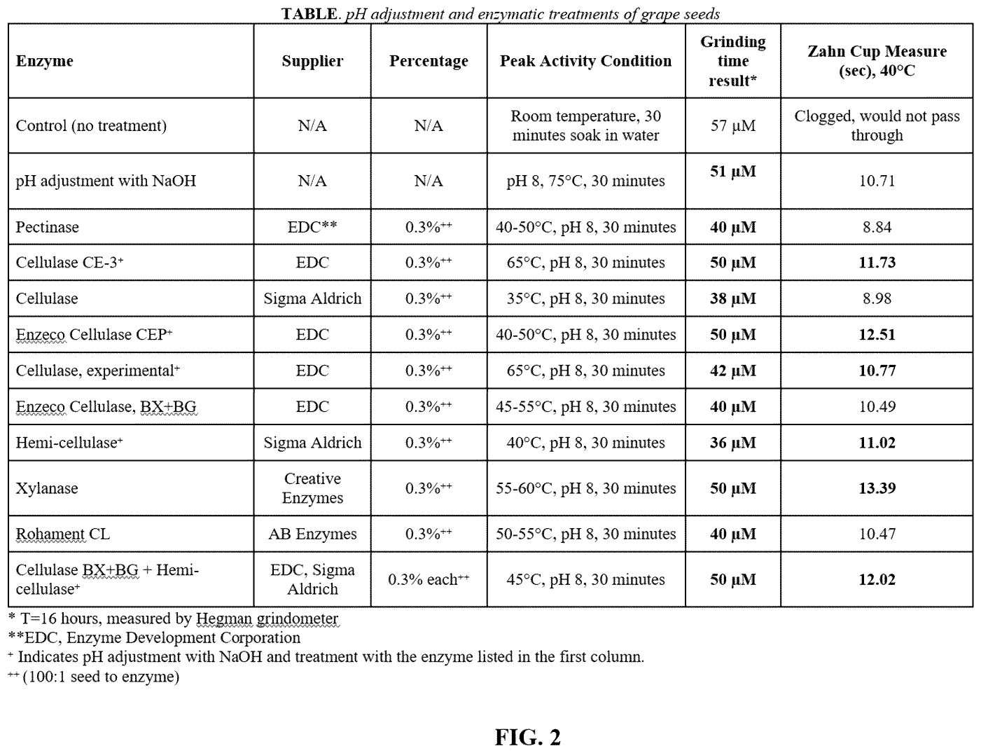

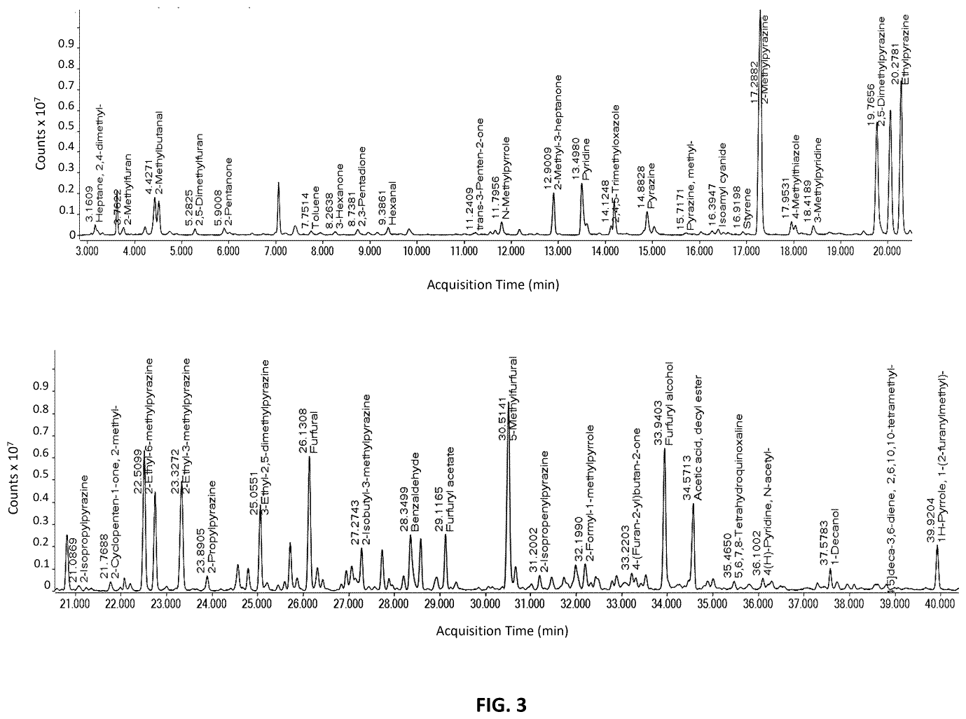

In the present studies, grape seeds were roughly ground in a spice grinder until the seed particles were about 0.2-0.5 mm in size. That product was mixed with water and treated as shown in FIG. 2 for 30 minutes. The treated products were poured into a tray and dehydrated at 60° C. for 24 hours, and then roasted in a conduction benchtop roaster at 160° C. for 30 minutes. The product from the roaster was then added to a stone melanger (Cocoatown), mixed with melted palm oil at 40-50° C. at a seeds:fat ratio of 40:60, and ground at the highest stone pressure for 16 hours. Particle size was measured at 16 hours of grinding with a Hegman Grindometer. Measurements were repeated to provide a mean particle size for each sample, which is reported in FIG. 2. All treatments showed enhanced breakability of the seeds, as indicated by a lower particle size than the controls.

In addition, a Zahn cup was used to measure the viscosity of the slurries at 40° C. with enzymatic treatment. When the various slurries from the melangers were assessed after taking a particle size measurement, the control slurry of seeds and fat was slightly too large in particle size to freely run through the Zahn cup, and it clogged midway through the measurement. The pH treatment sample ran through the cup freely, with a time of 10.71 seconds. Values that were higher than the pH adjustment treatment value (no enzyme treatment) indicated samples that took more time to pass through the cup, suggesting that there was more interaction between the seed material and the fat medium and therefore a thicker product. Some of the enzyme-treated samples demonstrated increased viscosity as compared to the pH treatment sample, indicating more interaction between the seeds and the fat medium. It is possible that the reduced particle size created an increase in surface area of the seed particles, causing more fat to be adsorbed onto the surface of the particles by nature of the liquid grinding process, creating less freely flowing fat and a thicker viscosity. In some cases, however, the increased viscosity may have been caused by additional particle interaction between the fat medium and seed breakdown products, because samples with smaller particles did not always show increased viscosity of the slurry. For example, pectinase treatment of the seeds resulted in better seed breakdown, with a 20% increase in seed particle size reduction, but the Zahn cup measurement was lower than the pH treatment alone. This indicates that pectinase may have resulted in less breakdown of macromolecules into smaller building blocks than other enzymes that were tested. Multiple cellulases, a xylanase, and a hemicellulase showed enhanced interaction with the fat medium as compared to the pH treatment alone (FIG. 2). Treatments with both right-most columns (in bold) were highly effective at achieving a more grindable product. Thus, these studies demonstrated that a combination of pH treatment and enzyme treatment can enhance the functionality of food stocks that typically are more challenging to use in food and beverage production.

### Example 3—Chickpea Coffee Replacement Beverage Generated with Phosphoric Acid Treatment

The following steps were used to obtain a chickpea coffee beverage replica.
1) A solution containing water and 0.1-0.6% w/w of a 65% phosphoric acid solution was prepared and heated to 85° C.
2) Chickpeas were added to the phosphoric acid solution to generate a 50% chickpea, 50% acid solution mixture, which was gently stirred so that all chickpeas were in contact with the acid solution. Stirring was continued for 15-60 minutes.
3) After 15-60 minutes, the slurry was drained, and the chickpeas were placed in an electric coffee roaster.
4) The chickpeas were roasted to 185-225° C. resulting in roasted chickpeas with retention of individual structure suitable for grinding in the next step.
5) The pre-treated (e.g., acid-treated) and roasted chickpeas were ground to a particle size from about 0.250 mm to about 5 mm.
6) The ground particles were extracted with 60-85° C. water via a recirculating pot for 5-45 minutes at 4-36% w/w grounds to water.
7) The extract was cooled to 10° C. and filtered through a 25 micron filter paper.
8) The extract was diluted with water, and up to about 1% w/w of caffeine, one or more acids (e.g., citric acid, malic acid, tartaric acid, lactic acid, succinic acid, fumaric acid, and/or phosphoric acid), and/or one or more flavors (e.g., volatile organic compounds, essential oils, plant extracts, and/or oleoresins) were added to yield a final beverage for use as a coffee replacement.

### Example 4—Chickpea Coffee Replacement Beverages Prepared Using Different Acids, Temperatures, and Lengths of Time

The following steps were used to generate chickpea coffee beverage replicas, using either sulfuric acid pre-treatment or hydrochloric acid pre-treatment of the chickpeas, and using different temperatures.

### Sulfuric Acid Treated Chickpeas

1) A solution containing water and 0.1-1% w/w of a 99% sulfuric acid solution was prepared and heated to 60-90° C.
2) Chickpeas were added to the sulfuric acid solution to generate a 50% chickpeas, 50% sulfuric acid solution mixture, and the mixture was gently stirred so all legumes were in contact with the acid solution. Stirring was continued for 15-60 minutes.
3) After 15-60 minutes, the slurry was drained and the chickpeas were placed in an electric coffee roaster.
4) The chickpeas were roasted to 185-225° C., resulting in pre-treated and roasted chickpeas with integrity of the chickpea preserved and suitable for grinding in the next step.
5) The pre-treated and roasted chickpeas were ground to generate particles from about 0.250 mm to about 5 mm in size.
6) The ground particles were extracted with 60-85° C. water via a recirculating pot for 5-45 minutes at 4-36% w/w grounds to water.
7) The extract was cooled to 10° C. and filtered through a 25 micron filter paper.
8) The extract was diluted, caffeine, one or more acids (e.g., citric acid, malic acid, tartaric acid, lactic acid, succinic acid, fumaric acid, and/or phosphoric acid), and/or one or more flavors (e.g., volatile organic compounds, essential oils, plant extracts, and/or oleoresins) were added to yield a final beverage for use as a coffee replacement.

Several additional batches were prepared with slight variations in the reaction conditions (e.g., percent of acid solution added, type of acid utilized, temperature, and/or time). These preparations also produced successful results.

### Hydrochloric Acid Treated Chickpeas

1) A solution containing water and 0.1-0.6% w/w of a 37% hydrochloric acid solution was prepared and heated to 60-90° C.
2) Chickpeas were added to the hydrochloric acid solution to generate a 50% chickpeas, 50% hydrochloric acid solution mixture, and the mixture was gently stirred so all legumes were in contact with the acid solution. Stirring was continued for 15-60 minutes.
3) After 15-60 minutes, the slurry was drained, and the chickpeas were placed in an electric coffee roaster.
4) The chickpeas were roasted to 185-225° C., resulting in pre-treated and roasted chickpeas with integrity of the chickpea preserved and suitable for grinding in the next step.
5) The pre-treated and roasted chickpeas were ground to a particle size of about 0.250 mm to about 5 mm.
6) The grounds were extracted with 60-85° C. water via a recirculating pot for 5-45 minutes at 4-36% w/w grounds to water.
7) The extract was cooled to 10° C. and filtered through a 25 micron filter paper.
8) The extract was diluted, and caffeine, one or more acids (e.g., citric acid, malic acid, tartaric acid, lactic acid, succinic acid, fumaric acid, and/or phosphoric acid), and/or one or more flavors (e.g., volatile organic compounds, essential oils, plant extracts, and/or oleoresins) were added to yield a final beverage for use as a coffee replacement.

### Example 5—Seed Material Processing (Changing pH as a Solution)

Grape seeds were processed according to the following procedure to result in treated, roasted grape seeds that were suitable for grinding without causing liquefaction. The integrity of the grape seeds structure was preserved, making the seeds suitable for roasting and grinding.
1) Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To determine impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample (about 0.1-10% impurities, about 90-99.9% cleaned seeds).
2) The cleaned whole seeds were treated with a chemical solution including one or more caustic agents (e.g., bases such as sodium hydroxide, potassium hydroxide, lye, sodium carbonate, calcium carbonate, calcium hydroxide, and/or potassium bicarbonate), one or more oxidizing agents (e.g., hydrogen peroxide and/or iodine), with optional reaction ingredients (e.g., one or more sugars, amino acids, transition/catalyst metals, and/or salts) in water at an elevated temperature (e.g., 75° C. to 100° C.) with agitation for 30 to 120 minutes, to reach a pH of 8-10. It was observed that a rise in pH was a function of both the temperature and the length of time that the seeds were agitated in the caustic solution; treating the whole seeds in the caustic solution at a temperature in the higher end of the 75° C. to 100° C. range and/or for a length of time in the higher end of the 30 to 120 minute range resulted in a pH at the higher end of the pH 8-10 range. In some cases, in conjunction with the above-described treatment with a chemical solution (either before or after treatment with the chemical solution), the whole seeds also were treated enzymatically with a solution containing one or more enzymes such as pectinase, cellulase, hemicellulase, xylanase, and/or tannase in aqueous solution with agitation for 30 to 120 minutes. The enzymes were observed to assist with breakdown of the tough, lignin-heavy, fibrous material of the grape seeds or other fruit seeds.
3) The seeds were either sieved and the two resulting streams were dried separately, and/or a vacuum was used to suction away liquid and further moisture was then evaporated from the slurry. The target moisture content after drying was between 2 and 10% w/w (e.g., about 6% w/w). When a vacuum was pulled on the slurry itself, the target moisture content was less than 25% w/w (e.g., about 20% w/w). Moisture content was measured using a moisture balance based on the loss on drying method. A wet sample was weighed on a balance, placed in an oven, heated until the end of the drying period (until the sample reached equilibrium), and then re-weighed on the balance. The weight loss was the moisture content of the sample.
4) The seeds and solids from step 3 were roasted for about 20 to about 120 minutes (e.g., about 15-60 minutes or about 45 minutes) using convection, conduction, or a combination of the two at 140-200° C. (e.g., 150-175° C.). After roasting was completed, it was observed that the seeds had turned a dark brown color and produced coffee-like sensory notes. A dark brown color was particularly noticeable upon roasting of seeds that had been pH adjusted to the higher end of the pH 8-10 range in step 2. Moisture content was again measured using a moisture balance based on the loss on drying method, as described in step 3. The target moisture content after roasting was less than 2% w/w.
5) The seeds and other solids from the roasting step were ground to a refined paste having a particle size of 350 μm or less (e.g., 150 μm or less) using a mill (e.g., a wet mill, a crushing mill, a burr mill, an espresso grinder, a stone mill, or a jet mill), and optionally sifted to remove unwanted material. For example, after mill grinding, sifting with a sieve or mesh allowed for removal of any larger particles or foreign material (e.g., leaf or stem parts) that had passed through the earlier seed material processing steps inadvertently. For some wet milling examples, a fat or liquid oil (e.g., a vegetable fat such as cocoa butter or a cocoa butter equivalent) was added to the roasted seeds pre-grinding in an amount of 30-60%, and the combination was then ground to a paste by wet milling on a stone mill (e.g., stone melanger), a colloid mill, a blade mill, or a corundum mill.

### Example 6—Seed Material Processing (Reacting Agents During Dutching/Roasting)

Grape seeds were processed according to the following procedure to result in treated, roasted grape seeds that were suitable for grinding without causing liquefaction. The integrity of the grape seeds structure was preserved, making the seeds suitable for roasting and grinding.
1) Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To measure impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample (about 0.1-10% impurities, about 90-99.9% cleaned seeds).
2) Under agitation, the seeds were sprayed with a chemical solution including one or more caustic agents (e.g., bases such as sodium hydroxide, potassium hydroxide, lye, sodium carbonate, calcium carbonate, calcium hydroxide, and/or potassium bicarbonate), one or more oxidizing agents (e.g., hydrogen peroxide and/or iodine), with optional additional reaction ingredients (e.g., sugars, amino acids, transition/catalyst metals, and/or salts) at an elevated temperature (e.g., 60° C. to 150° C.), and mixed to disperse and coat each seed until a pH of 5.5 to 10.5 was reached. For example, the seeds were dutched with a solution to pH 8.5. It was observed that a rise in pH was a function of both the temperature and the length of time that the seeds were agitated with the caustic solution; treating the whole seeds in the caustic solution at a temperature in the higher end of the 60° C. to 150° C. range and/or for a length of time in the higher end of the 30 to 120 minute range resulted in a pH at the higher end of the pH 5.5-10.5 range. In some cases, in conjunction with the above-described treatment with a chemical solution (either before or after treatment with the chemical solution), the whole seeds were treated enzymatically with a solution containing one or more enzymes (e.g., pectinase, cellulase, hemicellulase, xylanase, and/or tannase) in aqueous solution with agitation for 30 to 120 minutes. The enzymes were observed to help in the breakdown of the tough, lignin-heavy, fibrous material of the grape seeds. The temperature and air speed were increased to evaporate water and dry seeds.
3) The seeds were placed in a convective/conductive roaster at a temperature of at least 100° C. with full convection, and dried until the moisture content was measured to be less than about 4% w/w.
4) Once dry, the roasting temperature was increased above 125° C. (e.g., up to 200° C.) and the seeds were roasted using convection, conduction, or a combination of the two. For example, the dried seeds were roasted in a convective roaster at a temperature of 140° C. to 200° C. for 20 to 120 minutes (e.g., at 380° F. for 30 minutes), resulting in roasted seeds. After roasting was completed, it was observed that the seeds had turned a dark brown color and produced coffee-like sensory notes. A dark brown color was particularly noticeable upon roasting of seeds that had been adjusted to a pH in the higher end of the pH range in step 2.
5) The seeds and other solids from the roasting step were ground to a particle size of 350 μm or less (e.g., 150 μm or less) using a mill (e.g., a wet mill, a crushing mill, a burr mill, an espresso grinder, a stone mill, or a jet mill) and optionally sifted to remove unwanted material. For wet milling, a fat or liquid oil (e.g., a vegetable fat such as cocoa butter or a cocoa butter equivalent) was added to the seeds in an amount of 30-60% by weight, and the combination was then ground to a paste by wet milling on a stone mill (e.g., stone melanger), a colloid mill, a blade mill, or a corundum mill to produce wet milled grapeseed in a paste form.

### Example 7—Seed Material Processing (Changing pH as a Solution Followed by Enzymatic Hydrolysis)

Grape seeds were processed according to the following procedure to result in treated, roasted grape seeds that were suitable for grinding without causing liquefaction. The integrity of the grape seeds structure was preserved, making the seeds suitable for roasting and grinding.
1) Whole seeds were cleaned with equipment such as a destoner, a scalping deck, an aspiration channel, a sizing deck, an optical sorter, a sieve, or a combination thereof, to remove chaff, broken material, and other products of agricultural origin (e.g., stones, skins, stems, and sticks). The target impurity at the end of the cleaning process was less than 0.5% w/w. To determine impurities, one kilogram sample of cleaned whole seeds was visually inspected and hand-sorted to remove chaff, broken material, and other products that were not removed during the cleaning process. This resulted in two hand-sorted samples, which were weighed. The impurities were reported as a percent of the cleaned sample (about 0.1-10% impurities, about 90-99.9% cleaned seeds).
2) The cleaned whole seeds were treated with a chemical solution including one or more caustic agents (e.g., bases such as sodium hydroxide, potassium hydroxide, lye, sodium carbonate, calcium carbonate, calcium hydroxide, and/or potassium bicarbonate), one or more oxidizing agents (e.g., hydrogen peroxide and/or iodine), with optional reaction ingredients (e.g., one or more sugars, amino acids, transition/catalyst metals, and/or salts) in water at an elevated temperature (e.g., 75° C. to 100° C.) with agitation for 30 to 120 minutes, to reach a pH of 8-10. For example, utilizing sodium hydroxide to achieve a final pH of 8-8.5 while agitating the mixture at 75-100 C for 30-60 minutes. It was observed that a rise in pH was a function of both the temperature and the length of time that the seeds were agitated in the caustic solution; treating the whole seeds in the caustic solution at a temperature in the higher end of the 75° C. to 100° C. range and/or for a length of time in the higher end of the 30 to 120 minute range resulted in a pH at the higher end of the pH 8-10 range. In some cases, in conjunction with the above-described treatment with a chemical solution (either before or after treatment with the chemical solution containing, for example, a caustic), the whole seeds also were treated enzymatically with a solution containing one or more enzymes such as carbohydrases, proteases, ligninases, pectinase, cellulase, hemicellulase, xylanase, and/or tannase in aqueous solution with agitation for 30 to 120 minutes. The enzymes were observed to assist with breakdown of the tough, lignin-heavy, fibrous material of the grape seeds or other fruit seeds. For example, cellulase can be utilized at 0.1-0.5% at 50-65° C. for 30 minutes after the pH adjustment process to increase breakdown while keeping the seeds whole for future processing. Optionally, either before or after the caustic treatment and/or enzymatic treatment, the grape seeds can be treated with an acid treatment such as a chemical solution containing hydrochloric acid, sulfuric acid, or phosphoric acid. Further optionally, the seeds can be treated with an enzymatic solution containing one or more enzymes such as carbohydrases, proteases, cellulases, ligninases, hemicellulases, xylanases, or tannase, before or after roasting and/or before or after grinding into particles.
3) The seeds were either sieved and the two resulting streams were dried separately, and/or a vacuum was used to suction away liquid and further moisture was then evaporated from the slurry. The target moisture content after drying was between 2 and 10% w/w (e.g., about 6% w/w). When a vacuum was pulled on the slurry itself, the target moisture content was less than 25% w/w (e.g., about 20% w/w). Moisture content was measured using a moisture balance based on the loss on drying method. A wet sample was weighed on a balance, placed in an oven, heated until the end of the drying period (until the sample reached equilibrium), and then re-weighed on the balance. The weight loss was the moisture content of the sample.
4) The seeds and solids from step 3 were roasted for about 20 to about 120 minutes (e.g., about 15-60 minutes or about 45 minutes) using convection, conduction, or a combination of the two at 140-200° C. (e.g., 150-175° C.). After roasting was completed, it was observed that the seeds had turned a dark brown color and produced coffee-like sensory notes. A dark brown color was particularly noticeable upon roasting of seeds that had been pH adjusted to the higher end of the pH 8-10 range in step 2. Moisture content was again measured using a moisture balance based on the loss on drying method, as described in step 3. The target moisture content after roasting was less than 2% w/w.
5) The seeds and other solids from the roasting step were ground to a refined paste having a particle size of 350 μm or less (e.g., 150 μm or less) using a mill (e.g., a wet mill, a crushing mill, a burr mill, an espresso grinder, a stone mill, or a jet mill), and optionally sifted to remove unwanted material. For example, after mill grinding, sifting with a sieve or mesh allowed for removal of any larger particles or foreign material (e.g., leaf or stem parts) that had passed through the earlier seed material processing steps inadvertently. For some wet milling examples, a fat or liquid oil (e.g., a vegetable fat such as cocoa butter or a cocoa butter equivalent) was added to the roasted seeds pre-grinding in an amount of 30-60%, and the combination was then ground to a paste by wet milling on a stone mill (e.g., stone melanger), a colloid mill, a blade mill, or a corundum mill.

### Example 8—GC-MS Analysis of Acid-Treated and Non-Treated Chickpeas

As discussed above, roasting is a combination of Maillard browning and caramelization reactions that increase volatile compound concentration, which generally correlates with increased consumer preference and also increased darker brown colors in the food product. In addition to the colorimeter (L value) data shown above, which demonstrated the effects of acid hydrolysis pre-treatment on roasting, gas chromatography mass spectrometry (GC-MS) analysis was conducted to quantify the volatile compounds that were present after roasting. As described below, hydrolyzed and unhydrolyzed chickpea brew samples from medium and dark roast chickpeas were analyzed by GC-MS to compare volatile compound profiles, demonstrating that chickpeas pre-treated with acid hydrolysis prior to roasting had superior VOC profiles as compared to non-treated chickpeas.

### Sample Preparation

Both stir bar sorptive extraction (SBSE) and thin film solid phase micro-extraction (TF-SPME) were used simultaneously to extract VOCs from chickpea brew samples for GC-MS analysis. Samples were prepared by adding 5 mL of each chickpea brew sample (n=3) to a 20 mL glass headspace vial. Five μL of an internal standard solution containing 2-methyl-3-heptanone (50 μg/mL), 6-undecanone (50 μg/mL), 2-isobutyl-3-methylpyrazine (50 μg/mL), 6-amyl-2-pyrone (100 μg/mL), and 4-tert-butylphenol (500 μg/mL) in methanol was added to each sample with a 10 μL glass gas-tight syringe. For SBSE, a 10 mm length TWISTER™ stir bar coasted in 0.5 mm thick polydimethylsiloxane (PDMS) film (Gerstel GmbH, Germany) was submerged into the 5 mL sample in the headspace vial. For TF-SPME a device (20 mm×4.8 mm) coated with 450 μM thick phase of polydimethylsiloxane/divinylbenzene (PDMS/DVB) (Gerstel GmbH, Germany). The TF-SPME was held in the headspace above the 5 mL of sample in the headspace vial with a TF-SPME holder (20 mm) (Gerstel GmbH, Germany). Headspace vials were capped, and samples were extracted at ambient temperature with 800 rpm of stirring for 23 hours. After 23 hours, the TF-SPME and TWISTER™ were removed from the samples. The TF-SPME was blotted dry with a KIMWIPE® and transferred to a desorption liner (Gerstel GmbH, Germany). The TWISTER™ was rinsed with a few mL of deionized water, blotted dry with a KIMWIPE®, and transferred to the same desorption liner as the TF-SPME. The desorption liners containing TF-SPME and Twister were analyzed by GC-MS.

### GC-MS Analysis

The GC-MS system consisted of an Agilent 8890 GC with a 7000D triple quadrupole MS (Agilent Technologies, USA). The GC-MS was equipped with a Gerstel MultiPurpose Sampler Robotic Pro (MPS), a Thermal Desorption Unit 2 (TDU), a Cooled Injection System 4C (CIS), a C506 controller with liquid nitrogen cooling for CIS, a Universal Peltier Cooling (UPC) for TDU, an EPC pneumatic module for CIS use with Agilent 8890, and an Automatic Tube Exchange (ATEX) option for MPS (Gerstel GmbH, Germany). A Stabilwax-MS (30 meter, 0.25 mmID, 0.25 UM film thickness) GC column was used (Restek, USA). The CIS was equipped with a deactivated, notched, glasswool liner (Gerstel GmbH, Germany). The Agilent GC-MS was controlled by MassHunter GCMS Acquisition software (Agilent Technologies, USA). The Gerstel components were controlled by Maestro software (Gerstel GmbH, Germany).

Samples were desorbed in the TDU at an initial temperature of 30° C., delay time of 0.5 minutes, after which the temperature was ramped at 720° C./min to 250° C. and held for 5 minutes. The TDU transfer temperature was fixed at 280° C. and the desorption mode in the TDU was splitless. Desorbed compounds were trapped in the CIS at an initial temperature of −120° C. with a 0.2 min equilibration time, after which the temperature was ramped at 12° C./s to 275° C. and held for 3 minutes. The inlet pneumatics were operated in solvent vent mode with a pressure of 13.356 psi, a purge flow to split vent of 20 mL/min at 0.01 min, and a vent flow of 60 mL/min. Helium was used as a carrier gas at a flow rate of 1 mL/min. The GC oven was set to an initial temperature of 40° C. with a 5 minute hold time, after which the temperature was ramped to 190° C. at 3° C./min and then ramped again to 250° C. at a rate of 10° C./min and held for 5 minutes, for a total run time of 66 minutes. The collision cell used helium as a quench gas with 2.25 mL/min flow rate and nitrogen as collision gas at 1.5 mL/min flow rate. The MS transfer line was set to 250° C., the source temperature was 230° C., and the quadrupoles set to 150° C. The ion source was operated in electron impact (EI) mode at 70 eV. A 2.8 min solvent delay was used. The MS was operated in scan mode with a scan time of 245 ms and a scan range of 35 to 350 amu.

### Identification of Volatile Compounds

Compounds were identified by comparison of their retention time and mass spectra with a library generated by analysis of reference standards. Compounds where no reference was available were identified by comparison of retention index (RI) and mass spectra with available databases. An alkane mix containing C8-C20 linear alkanes at 40 μg/mL in hexane (Sigma, USA) was spiked (5 μL) into 5 mL of water and analyzed in the same manner as chickpea brew samples to calculate RI. The NIST mass spectral database (Version 2.4, build Mar. 24, 2020) was used to search mass spectra and polar RI values. In addition, Flavornet (www.flavornet.org/index.html) and the Leibniz-LSB@TUM Odorant Database (www.leibniz-lsb.de/en/databases/leibniz-lsbtum-odorant-database/start/) were searched for RI values.

### Data Analysis

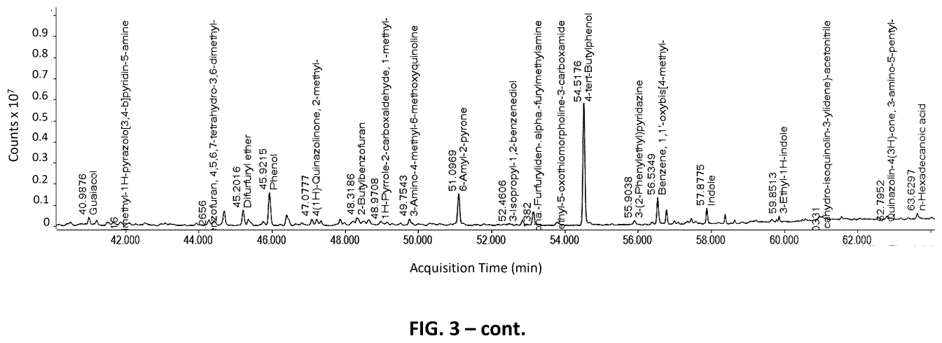

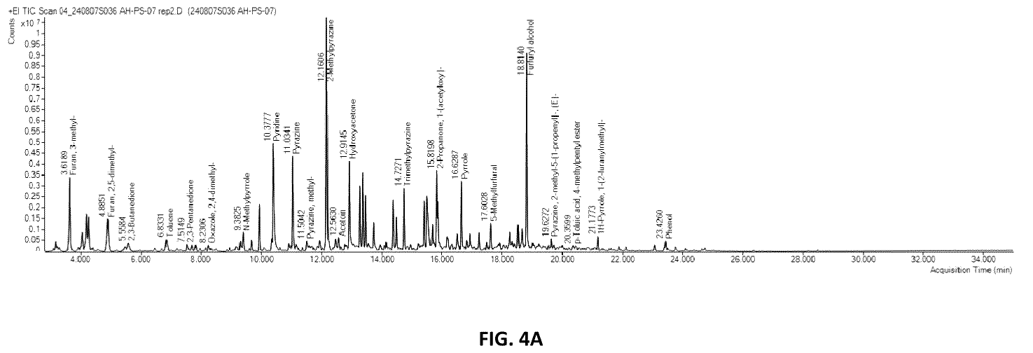

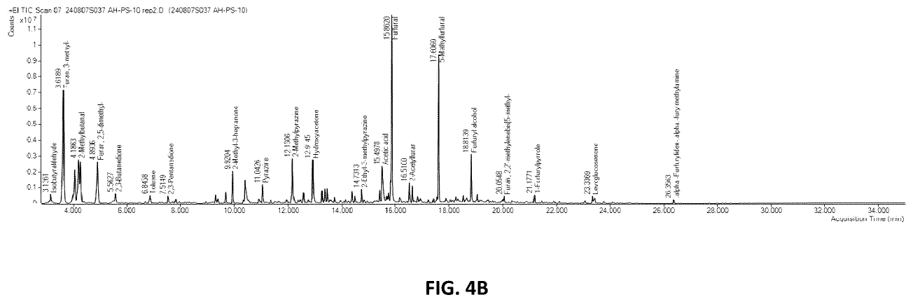

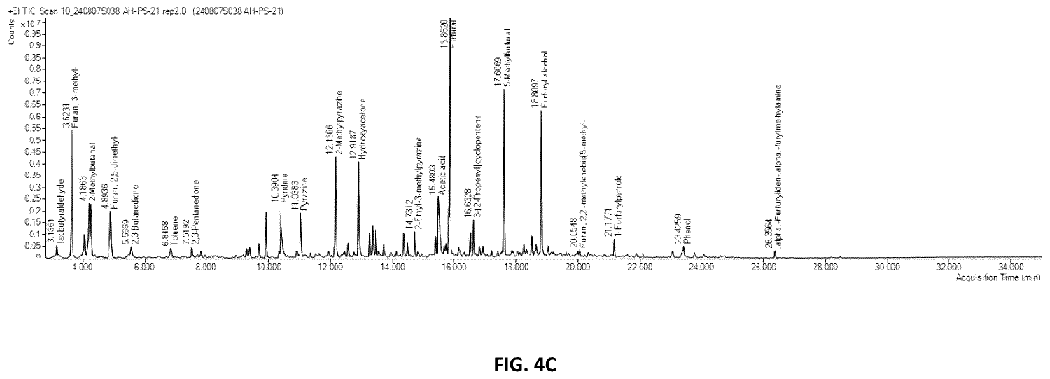

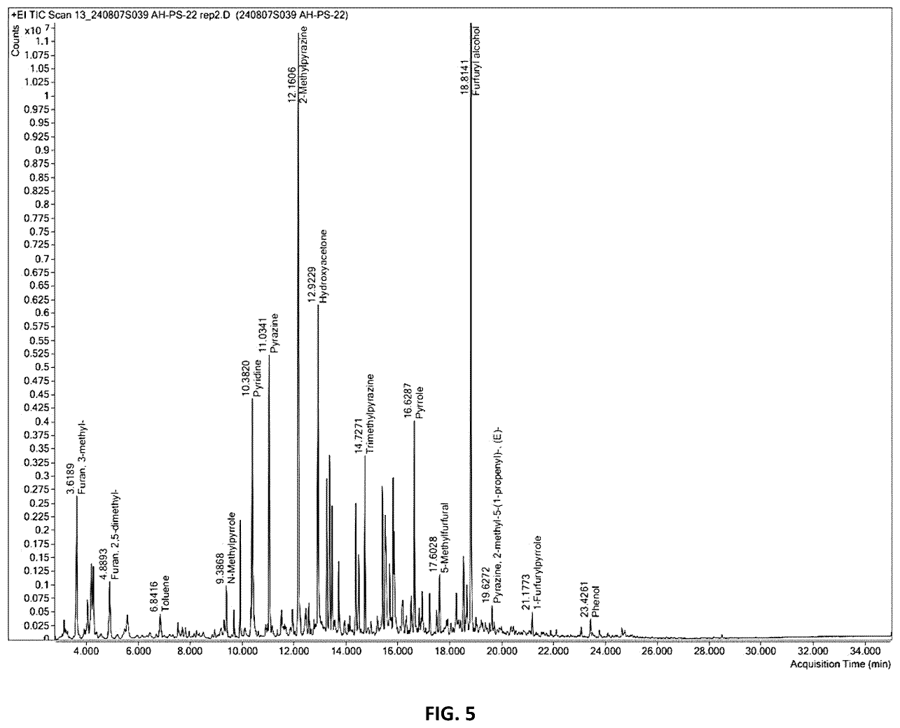

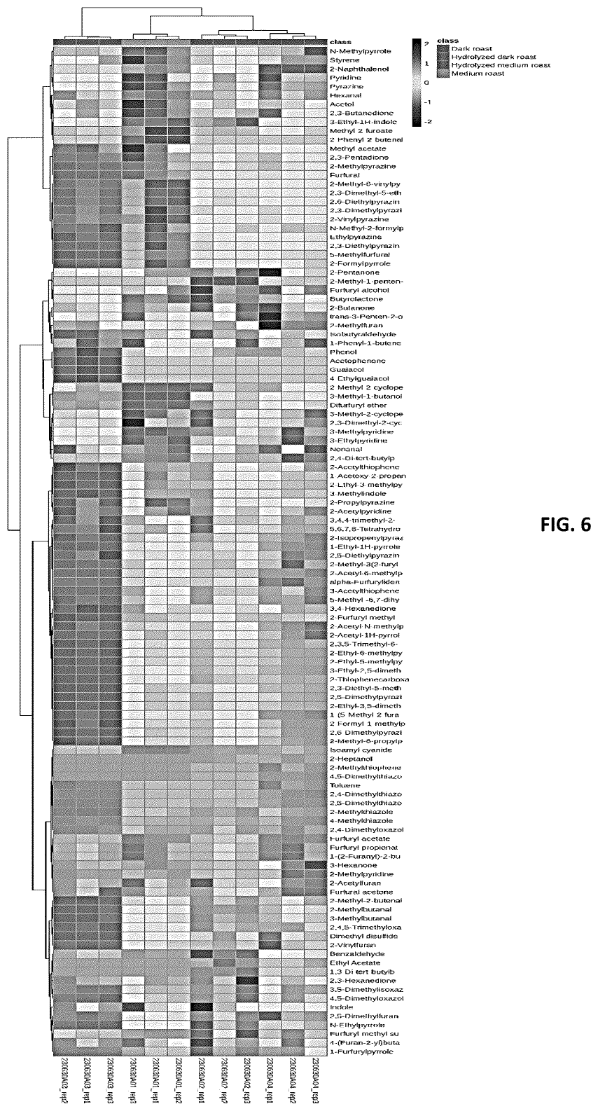

TABLE 7 lists the compounds that were identified in these studies, the ions used for peak integration, and the retention time. Representative chromatograms are shown in FIGS. 3, 4A-4C, and 5. The average peak areas for each compound in the sample treatments are shown in TABLE 8. Peak area data from each sample was used to generate a heatmap with MetaboAnalyst software (new.metaboanalyst.ca/MetaboAnalyst/home.xhtml, Version 5.0). The distance measure was Euclidian, and the clustering method was Ward (FIG. 6).

TABLE 7
Identified compounds, ion used for peak
integration, and retention time

| | Ion | Retention Time |
|---|---|---|
| Compound | (m/z) | (min) |
| Isobutyraldehyde | 72 | 3.169 |
| Methyl acetate | 43 | 3.318 |
| 2-Methylfuran | 82 | 3.762 |
| Ethyl Acetate | 43 | 4.067 |
| 2-Butanone | 43 | 4.220 |
| Isopropyl acetate | 43 | 4.220 |
| 2-Methylbutanal | 41 | 4.423 |
| 3-Methylbutanal | 44 | 4.512 |
| 2,5-Dimethylfuran | 96 | 5.278 |
| 2-Pentanone | 43 | 5.905 |
| n-Propyl acetate | 43 | 5.905 |
| 2,4,5-Trimethyl-1,3-dioxolane | 43 | 6.024 |
| 2,3-Butanedione | 43 | 6.024 |
| Methyl isovalerate | 74 | 7.265 |
| Toluene | 91 | 7.760 |
| Ethyl butanoate | 71 | 8.264 |
| 3-Hexanone | 43 | 8.277 |
| 2,3-Pentadione | 43 | 8.751 |
| 2-Methyl-1-penten-3-one | 69 | 8.878 |
| Dimethyl disulfide | 94 | 8.967 |
| 2-Vinylfuran | 94 | 9.166 |
| Hexanal | 44 | 9.394 |
| 2,4-Dimethyloxazole | 42 | 9.822 |
| 2-Methylthiophene | 97 | 9.839 |
| 2-Methyl-2-butenal | 84 | 9.873 |
| Ethylbenzene | 91 | 11.169 |
| trans-3-Penten-2-one | 69 | 11.249 |
| 2,3-Hexanedione | 43 | 11.554 |
| 3,5-Dimethylisoxazole | 97 | 11.664 |
| N-Methylpyrrole | 81 | 11.796 |
| 3,4-Hexanedione | 57 | 11.935 |
| 4,5-Dimethyloxazole | 97 | 12.172 |
| 2,3-Heptanedione | 43 | 12.562 |
| 2-Methyl-3-heptanone | 57 | 12.897 |
| Pyridine | 79 | 13.502 |
| N-Ethylpyrrole | 80 | 13.604 |
| 2,4,5-Trimethyloxazole | 111 | 14.125 |
| 3-Methyl-1-butanol | 55 | 14.836 |
| Pyrazine | 80 | 14.887 |
| 2-Methylpyridine | 93 | 15.044 |
| 2-Methylthiazole | 58 | 16.035 |
| 2-Furfuryl methyl ether | 81 | 16.268 |
| Isoamyl cyanide | 55 | 16.395 |
| 3-Methyl-3-buten-1-ol | 68 | 16.776 |
| Styrene | 104 | 16.915 |
| 3-Methyl-2-butenyl acetate | 68 | 17.284 |
| 2-Methylpyrazine | 94 | 17.287 |
| 4-Methylthiazole | 99 | 17.970 |
| 2,4-Dimethylthiazole | 113 | 18.042 |
| Cyclohexanone | 55 | 18.296 |
| 3-Methylpyridine | 93 | 18.419 |
| Furfuryl ethyl ether | 81 | 18.610 |
| Acetol | 43 | 18.965 |
| 2,5-Dimethylthiazole | 113 | 19.486 |
| 2,5-Dimethylpyrazine | 108 | 19.754 |
| 2-Heptanol | 45 | 20.011 |
| 2,6-Dimethylpyrazine | 108 | 20.036 |
| Ethylpyrazine | 107 | 20.274 |
| 2,3-Dimethylpyrazine | 108 | 20.807 |
| 4,5-Dimethylthiazole | 112 | 21.057 |
| 1-Hexanol | 56 | 21.426 |
| 2-Methyl-2-cyclopenten-1-one | 67 | 21.773 |
| 3-Ethylpyridine | 92 | 22.201 |
| 2-Ethyl-6-methylpyrazine | 121 | 22.734 |
| 2-Ethyl-5-methylpyrazine | 121 | 22.734 |
| Nonanal | 57 | 22.997 |
| 2-Ethyl-3-methylpyrazine | 122 | 23.319 |
| 2-Propylpyrazine | 94 | 23.886 |
| 1,3-Di-tert-butylbenzene | 175 | 24.441 |
| 2,3-Dimethyl-5-ethylpyrazine | 135 | 24.568 |
| 2,6-Diethylpyrazine | 135 | 24.568 |
| 2-Vinylpyrazine | 106 | 24.788 |
| 3-Ethyl-2,5-dimethylpyrazine | 135 | 25.046 |
| 1-Phenyl-1-butene | 117 | 25.199 |
| 2,3-Diethylpyrazine | 136 | 25.445 |
| 2-Ethyl-3,5-dimethylpyrazine | 135 | 25.703 |
| 2,5-Diethylpyrazine | 121 | 25.860 |
| 2-Methyl-6-propylpyrazine | 108 | 25.864 |
| Furfural | 96 | 26.126 |
| 1-Acetoxy-2-propanone | 43 | 26.308 |
| Furfuryl methyl sulfide | 81 | 26.927 |
| 2-Methyl-6-vinylpyrazine | 120 | 26.948 |
| 3,4,4-trimethyl-2-cyclopenten-1-one | 109 | 27.033 |
| 2,3-Diethyl-5-methylpyrazine | 149 | 27.062 |
| 2-Isobutyl-3-methylpyrazine | 108 | 27.274 |
| 2-Acetylfuran | 95 | 27.727 |
| 2,3,5-Trimethyl-6-ethylpyrazine | 149 | 27.880 |
| 3-Methyl-2-cyclopenten-1-one | 96 | 28.053 |
| Benzaldehyde | 106 | 28.350 |
| 6-Undecanone | 99 | 28.578 |
| 2,3-Dimethyl-2-cyclopenten-1-one | 67 | 28.892 |
| 1-Acetoxy-2-butanone | 43 | 29.116 |
| Furfuryl acetate | 81 | 29.121 |
| Linalool | 93 | 29.680 |
| 5-Methylfurfural | 110 | 30.501 |
| Methyl 2-furoate | 95 | 30.679 |
| 2-Isopropenylpyrazine | 119 | 31.200 |
| 2-Acetylpyridine | 79 | 31.458 |
| Furfuryl propionate | 81 | 31.505 |
| 1-(2-Furanyl)-2-butanone | 81 | 31.505 |
| 1-Ethyl-1H-pyrrole-2-carboxyaldehyde | 123 | 31.742 |
| 5-Methyl-6,7-dihydrocyclopentapyrazine | 119 | 31.992 |
| 2-Acetyl-5-methylfuran | 109 | 32.204 |
| 2-Formyl-1-methylpyrrole | 109 | 32.204 |
| Butyrolactone | 42 | 32.487 |
| 5-Ethyl-2-furaldehyde | 124 | 33.080 |
| 4-(Furan-2-yl)butan-2-one | 81 | 33.224 |
| Acetophenone | 105 | 33.317 |
| 2-Acetyl-N-methylpyrrole | 108 | 33.521 |
| Furfuryl alcohol | 98 | 33.944 |
| Isovaleric acid | 60 | 34.410 |
| 1-(5-Methyl-2-furanyl)-1-propanone | 109 | 34.558 |
| 2-Acetyl-6-methylpyrazine | 136 | 34.893 |
| 2-Thiophenecarboxaldehyde | 112 | 35.024 |
| alpha-Terpineol | 59 | 35.232 |
| 5,6,7,8-Tetrahydroquinoxaline | 134 | 35.469 |
| 2-Acetylthiophene | 111 | 37.709 |
| 3-Acetylthiophene | 111 | 37.951 |
| 1-Furfurylpyrrole | 81 | 39.924 |
| 2-Naphthalenol | 115 | 40.716 |
| 3-(2-Furanyl)-2-propenal | 122 | 40.962 |
| Guaiacol | 109 | 40.991 |
| 2-Methyl-3(2-furyl)acrolein | 79 | 41.495 |
| Furfural acetone | 121 | 42.520 |
| Phenylethyl alcohol | 91 | 42.774 |
| 2-Phenyl-2-butenal | 115 | 43.436 |
| 2-Acetyl-1H-pyrrole | 94 | 44.693 |
| Difurfuryl ether | 81 | 45.193 |
| Phenol | 94 | 45.925 |
| 2-Formylpyrrole | 95 | 46.395 |
| 4-Ethylguaiacol | 137 | 46.607 |
| 3,4-Dimethoxystyrene | 164 | 46.980 |
| N-Methyl-2-formylpyrrole | 109 | 48.983 |
| 6-Amyl-2-pyrone | 95 | 51.100 |
| 4-Vinylguaiacol | 150 | 51.880 |
| alpha-Furfuryliden-alpha-furylmethylamine | 81 | 53.142 |
| 4-tert-Butylphenol | 135 | 54.522 |
| 2,4-Di-tert-butylphenol | 191 | 55.289 |
| Indole | 117 | 57.881 |
| 3-Methylindole | 130 | 58.643 |
| 3-Ethyl-1H-indole | 130 | 59.855 |

TABLE 8
Average peak areas for compounds identified in sample treatments

| | Average Peak Areas | | | | |
|---|---|---|---|---|---|
| | Retention | | Hydrolyzed | | |
| | Time | Medium | Medium | Dark | Hydrolyzed |
| Compound | (min) | Roast | Roast | Roast | Dark Roast |
| Isobutyraldehyde* | 3.178 | 261554 | 287477 | 151536 | 198365 |
| Methyl acetate | 3.313 | 336323 | 258689 | 164039 | 235340 |
| 2-Methylfuran | 3.766 | 832969 | 1041094 | 598209 | 828445 |
| Ethyl Acetate | 4.220 | < | 55195 | < | 45153 |
| 2-Butanone | 4.220 | 1077134 | 1122190 | 965812 | 919346 |
| 2-Methylbutanal | 4.423 | 1516912 | 2046806 | 892541 | 1757085 |
| 3-Methylbutanal | 4.512 | 1322230 | 1637075 | 953298 | 1517115 |
| 2,5-Dimethylfuran | 5.283 | 186867 | 286078 | 112366 | 244895 |
| 2-Pentanone | 5.901 | 398574 | 498626 | 446971 | 406739 |
| 2,3-Butanedione | 6.019 | 706396 | 312028 | 341344 | 328684 |
| Toluene | 7.760 | 111766 | 215180 | 80889 | 242444 |
| 3-Hexanone | 8.264 | 127293 | 167640 | 130829 | 176901 |
| 2,3-Pentadione | 8.747 | 757625 | 592937 | 350135 | 495802 |
| 2-Methyl-1-penten-3-one | 8.814 | < | 51783 | < | < |
| Dimethyl disulfide | 8.979 | 149405 | 185173 | 57582 | 195862 |
| 2-Vinylfuran | 9.157 | 92723 | 128892 | 54791 | 134657 |
| Hexanal | 9.390 | 252084 | 200430 | 198407 | 213346 |
| 2,4-Dimethyloxazole | 9.835 | 67621 | 144494 | 53554 | 149584 |
| 2-Methylthiophene | 9.839 | < | 85517 | < | 95006 |
| 2-Methyl-2-butenal | 9.860 | 130528 | 155266 | 88560 | 147449 |
| trans-3-Penten-2-one | 11.262 | 163743 | 164528 | 157449 | 135740 |
| 2,3-Hexanedione | 11.558 | 245025 | 292971 | 234186 | 261115 |
| 3,5-Dimethylisoxazole | 11.681 | 175752 | 250458 | 148202 | 234859 |
| N-Methylpyrrole | 11.796 | 1446406 | 1113673 | 852249 | 755044 |
| 3,4-Hexanedione | 11.935 | 83221 | 80211 | 52387 | 83315 |
| 4,5-Dimethyloxazole | 12.185 | 220174 | 285179 | 181908 | 264862 |
| Pyridine | 13.513 | 4656550 | 4129916 | 4168585 | 3836762 |
| N-Ethylpyrrole | 13.612 | 408658 | 504557 | 294863 | 414506 |
| 2,4,5-Trimethyloxazole | 14.133 | 279992 | 365401 | 188879 | 356818 |
| 3-Methyl-1-butanol | 14.824 | < | 68792 | 86387 | 59370 |
| Pyrazine | 14.898 | 4322033 | 2980388 | 3261847 | 2588444 |
| 2-Methylpyridine | 15.048 | 297870 | 435243 | 288351 | 478480 |
| 2-Methylthiazole | 16.043 | 100523 | 214915 | 61263 | 205486 |
| 2-Furfuryl methyl ether | 16.276 | 199404 | 183568 | 107505 | 196325 |
| Isoamyl cyanide | 16.403 | 92062 | 355038 | 141658 | 338848 |
| Styrene | 16.915 | 146035 | 115622 | 114654 | 108473 |
| 2-Methylpyrazine | 17.309 | 27247830 | 24387980 | 18553296 | 22986580 |
| 4-Methylthiazole | 17.970 | 244355 | 592821 | 172947 | 623394 |
| 2,4-Dimethylthiazole | 18.050 | 93148 | 343265 | < | 416058 |
| 3-Methylpyridine | 18.440 | 517617 | 596390 | 573005 | 593923 |
| Acetol | 18.986 | 376670 | 219682 | 193271 | 214020 |
| 2,5-Dimethylthiazole | 19.494 | 50551 | 166509 | < | 192455 |
| 2,5-Dimethylpyrazine | 19.789 | 8708438 | 9011280 | 4639049 | 9517008 |
| 2-Heptanol | 19.850 | < | 73258 | < | 73766 |
| 2,6-Dimethylpyrazine | 20.079 | 10205007 | 10194712 | 6063985 | 11403819 |
| Ethylpyrazine | 20.299 | 12793850 | 10468469 | 7489687 | 10606836 |
| 2,3-Dimethylpyrazine | 20.837 | 4657224 | 3779032 | 2936762 | 3706410 |
| 4,5-Dimethylthiazole | 21.057 | < | 127481 | < | 146117 |
| 2-Methyl-2- | 21.786 | 360039 | 476738 | 467166 | 424388 |
| cyclopenten-1-one | | | | | |
| 3-Ethylpyridine | 22.218 | 223096 | 280853 | 263246 | 309043 |
| 2-Ethyl-6- | 22.764 | 5357025 | 5874602 | 2678040 | 6346643 |
| methylpyrazine | | | | | |
| 2-Ethyl-5- | 22.764 | 5357025 | 5874602 | 2678040 | 6346643 |
| methylpyrazine | | | | | |
| Nonanal | 23.014 | 50930 | 56241 | 57096 | 55462 |
| 2-Ethyl-3- | 23.344 | 6838912 | 6464695 | 3770894 | 6833786 |
| methylpyrazine | | | | | |
| 2-Propylpyrazine | 23.907 | 1143462 | 1058765 | 869333 | 1047206 |
| 1,3-Di-tert-butylbenzene | 24.403 | < | 80963 | < | 60657 |
| 2,3-Dimethyl-5- | 24.585 | 1996728 | 1489152 | 1113587 | 1594740 |
| ethylpyrazine | | | | | |
| 2,6-Diethylpyrazine | 24.585 | 1996728 | 1489152 | 1113587 | 1594740 |
| 2-Vinylpyrazine | 24.805 | 1762839 | 1244425 | 900524 | 1204870 |
| 3-Ethyl-2,5- | 25.068 | 3478617 | 4120311 | 1470611 | 4626168 |
| dimethylpyrazine | | | | | |
| 1-Phenyl-1-butene | 25.220 | 108692 | 111653 | 84769 | 84944 |
| 2,3-Diethylpyrazine | 25.461 | 227706 | 179454 | 112053 | 177469 |
| 2-Ethyl-3,5- | 25.728 | 2334572 | 2443914 | 1116688 | 2617164 |
| dimethylpyrazine | | | | | |
| 2,5-Diethylpyrazine | 25.881 | 151747 | 167340 | 106685 | 187680 |
| 2-Methyl-6- | 25.881 | 697220 | 710040 | 429610 | 790314 |
| propylpyrazine | | | | | |
| Furfural | 26.156 | 14436274 | 11273103 | 6050991 | 10116207 |
| 1-Acetoxy-2-propanone | 26.325 | 1740103 | 1598893 | 1003358 | 1634120 |
| Furfuryl methyl sulfide | 26.944 | 60726 | 215075 | 82026 | 159234 |
| 2-Methyl-6- | 26.956 | 1479936 | 951302 | 533058 | 985003 |
| vinylpyrazine | | | | | |
| 3,4,4-trimethyl-2- | 27.045 | 215201 | 241991 | 187834 | 237800 |
| cyclopenten-1-one | | | | | |
| 2,3-Diethyl-5- | 27.083 | 1020258 | 1010016 | 428370 | 1135544 |
| methylpyrazine | | | | | |
| 2-Acetylfuran | 27.744 | 2902299 | 3478637 | 2932847 | 3478681 |
| 2,3,5-Trimethyl-6- | 27.897 | 430680 | 468627 | 211049 | 512973 |
| ethylpyrazine | | | | | |
| 3-Methyl-2- | 28.058 | 64225 | 81356 | 73306 | 82434 |
| cyclopenten-1-one | | | | | |
| Benzaldehyde | 28.362 | 1955381 | 2444614 | 1994996 | 2180571 |
| 2,3-Dimethyl-2- | 28.909 | 240739 | 308464 | 275101 | 304953 |
| cyclopenten-1-one | | | | | |
| Furfuryl acetate | 29.129 | 964504 | 1823181 | 1128832 | 2118332 |
| 5-Methylfurfural | 30.539 | 13892874 | 10670927 | 5533945 | 11616032 |
| Methyl 2-furoate | 30.692 | 2456997 | 1348249 | 1421881 | 1534688 |
| 2-Isopropenylpyrazine | 31.217 | 719414 | 826934 | 503270 | 903055 |
| 2-Acetylpyridine | 31.479 | 379225 | 353228 | 298684 | 375748 |
| Furfuryl propionate | 31.522 | 91889 | 145485 | 100722 | 164493 |
| 1-(2-Furanyl)-2- | 31.522 | 91889 | 145485 | 100722 | 164493 |
| butanone | | | | | |
| 1-Ethyl-1H-pyrrole-2- | 31.755 | 475597 | 537727 | 289187 | 629380 |
| carboxyaldehyde | | | | | |
| 5-Methyl-6,7- | 32.005 | 899424 | 1140251 | 632305 | 1271961 |
| dihydrocyclopentapyrazine | | | | | |
| 2-Formyl-1- | 32.216 | 1010542 | 996143 | 588274 | 1134425 |
| methylpyrrole | | | | | |
| Butyrolactone | 32.500 | 265811 | 434336 | 356481 | 325631 |
| 4-(Furan-2-yl)butan-2- | 33.237 | 244493 | 323739 | 237331 | 293382 |
| one | | | | | |
| Acetophenone | 33.330 | 299612 | 351019 | 3593684 | 289610 |
| 2-Acetyl-N- | 33.538 | 320907 | 329502 | 228432 | 388108 |
| methylpyrrole | | | | | |
| Furfuryl alcohol | 33.957 | 4690447 | 5634640 | 5039218 | 4610726 |
| 1-(5-Methyl-2-furanyl)- | 34.584 | 352526 | 350561 | 216908 | 423301 |
| 1-propanone | | | | | |
| 2-Acetyl-6- | 34.923 | 81463 | 137075 | < | 171504 |
| methylpyrazine | | | | | |
| 2- | 35.033 | 286239 | 345528 | 137174 | 355181 |
| Thiophenecarboxaldehyde | | | | | |
| 5,6,7,8- | 35.486 | 306873 | 328172 | 246699 | 334339 |
| Tetrahydroquinoxaline | | | | | |
| 2-Acetylthiophene | 37.731 | 200070 | 196030 | 131381 | 205184 |
| 3-Acetylthiophene | 37.968 | 248000 | 326017 | 169156 | 340020 |
| 1-Furfurylpyrrole | 39.937 | 1924706 | 3349061 | 1571885 | 2931935 |
| 2-Naphthalenol | 40.733 | 88997 | 52844 | 69000 | < |
| Guaiacol | 41.009 | 333844 | 301371 | 3776697 | 350493 |
| 2-Methyl-3(2- | 41.504 | 79068 | 92836 | 55328 | 103559 |
| furyl)acrolein | | | | | |
| Furfural acetone | 42.525 | 70028 | 93687 | 66062 | 104719 |
| 2-Phenyl-2-butenal | 43.338 | 63258 | < | < | < |
| 2-Acetyl-1H-pyrrole | 44.706 | 793517 | 767686 | 524319 | 918488 |
| Di furfuryl ether | 45.205 | 126981 | 372208 | 392665 | 260503 |
| Phenol | 45.938 | 3262778 | 2699618 | 4678876 | 2708003 |
| 2-Formylpyrrole | 46.404 | 1123482 | 801629 | 466008 | 882864 |
| 4-Ethylguaiacol | 46.607 | < | < | 2611330 | < |
| N-Methyl-2- | 48.992 | 190396 | 132733 | 89714 | 167585 |
| formylpyrrole | | | | | |
| alpha-Furfuryliden- | 53.151 | 565458 | 775645 | 321949 | 997580 |
| alpha- | | | | | |
| furylmethylamine | | | | | |
| 2,4-Di-tert-butylphenol | 55.306 | 68400 | 74248 | 91173 | 98464 |
| Indole | 57.890 | 759958 | 847891 | 726374 | 783568 |
| 3-Methylindole | 58.652 | 162338 | 160082 | 117118 | 161534 |
| 3-Ethyl-1H-indole | 59.859 | 241965 | 177155 | 200100 | 199634 |

*bold indicates reaction products of Maillard or caramelization with demonstrated increases in concentration with hydrolysis pre-treatment.
< represents less than peak area threshold of 50,000 counts.

Another way to visualize and analyze these data is with a heatmap, as shown in FIG. 6. A heatmap can more readily allow for comparison of the concentrations of compounds in similar samples to indicate which compounds are more prevalent in samples. Typically, a dark gray color indicates compounds with larger peak areas and a light gray color indicates compounds with smaller peak areas, and the peak areas are directly correlated to concentration. Euclidian distance measuring and Ward clustering also were used to statistically group the samples in similarity and difference, as indicated by the branching at the top and to the left of FIG. 6.

As shown in FIG. 6, the acid hydrolyzed dark and medium roast chickpea samples had higher amounts of the identified compounds, with the compounds more associated with browning reactions (caramelization, Maillard browning, and/or Strecker degradation) toward the middle and bottom of the figure. The acid hydrolyzed dark and medium roast samples also were analytically closer to each other than to the other untreated roast samples, as indicated by the branched clustering at the top of FIG. 6. This was considered to be significant, because it indicated that the increased volatile compounds caused by the acid hydrolysis treatment was more impactful than the roast itself on the untreated samples. In other words, the dark roast chickpeas with the pH adjustment (acid hydrolysis) treatment were closer analytically to the medium roast chickpeas with the pH adjustment rather than the dark roast control. Thus, the pre-treatment significantly increased and enhanced the roastability of the chickpeas.

### Example 9—Viscosity of Hydrolyzed and Unhydrolyzed Chickpea Extracts

As described below, the viscometer tests indicated a significant difference in the viscosity between the untreated and treated chickpeas, with the untreated chickpeas showing greater viscosity than the acid-treated counterparts. The viscous extracts that resulted from untreated chickpeas indicate the presence of insoluble starches and/or proteins that are not dissolved in solution and caused gelling in the extracts.

Extracts that were prepared with both acid-treated and non-treated roasted chickpeas were analyzed using two different viscometers: an Ubbelohde viscometer and a Brookefield HA viscometer.

### Viscometer Preparation

The viscometer was cleaned and placed in a temperature-controlled bath to maintain a constant temperature. The liquid sample for which viscosity was to be measured was loaded into the capillary tube to ensure the absence of air bubbles. The liquid flowed through the narrow capillary due to gravity, and the time taken for it to flow between two marked points on the tube was measured. Multiple measurements were taken to calculate an average flow time, which was then used in conjunction with calibration constants to determine the viscosity of the liquid. The viscometers were calibrated using standard liquids with known viscosities to establish a relationship between flow time and viscosity.

### Extract Preparation and Testing

To replicate coffee with legumes in a concentrated format, it was desirable for the extract to concentrate while retaining a relatively low viscosity. A high viscosity extract, when spray dried and concentrated, can result in scalding of the evaporator and clogging of the atomizer nozzle during the spray drying process. Without being bound by theory, it is believed that when proteins are subjected to heat, the heat energy disrupts the native structure of the proteins through denaturation, which involves the unfolding or alteration of their three-dimensional structure, including their secondary and tertiary structures. Heat causes the protein molecules to gain kinetic energy, leading to the breaking of weak bonds that maintain the protein structure. As these bonds break, the protein unfolds, exposing its hydrophobic and hydrophilic regions. The unfolded proteins can then interact with each other through various types of bonding, such as hydrogen bonds, hydrophobic interactions, and disulfide linkages.

These interactions can result in the formation of a three-dimensional network or gel-like structures. After gel formation, cooling the gel allows the protein molecules to solidify and set in the gel structure. The set gel retains its texture and shape even after cooling and may have useful applications.

For food industry applications, gelling or the formation of gel-like structures, is undesirable. To test the gelling of the untreated roasted chickpea extract versus the treated roasted chickpea extract, viscosity was measured (TABLE 9). The untreated chickpea extract was not readily able to be concentrated via evaporation, as the proteins gelled and the remaining product no longer functioned as a liquid but formed a solid mass. The result was a product that could not be used in coffee-like applications, as it was not able to flow through an evaporator for further concentration. The chickpea extracts prepared from untreated chickpeas, due to their viscous, gelled state, could not be spray dried because the product could not be pumped into the spray dryer, and it also clogged the atomizer nozzle of the spray dryer.

In contrast, acid hydrolysis of chickpeas to break down proteins prior to roasting, reduced or prevented the proteins from gelling once heat was applied to evaporate the water. The treated, roasted chickpeas were successfully further ground and extracted, reduced to form concentrates, and dried into soluble powders.

Extracts made from hydrolyzed or unhydrolyzed chickpeas were concentrated using a rising film evaporator, and the Brix and viscosity were then measured in order to determine the extracts' ability to be concentrated and spray dried. For hydrolysis, ten kilos of chickpeas were hydrolyzed by preparing a solution of water and 65% phosphoric acid, which was heated to 85° C. Chickpeas were added and gently stirred so all chickpeas were in contact with the acid solution for 10-60 minutes (and in some runs, 45 minutes). After treatment with the acid solution, the slurry was drained, and the chickpeas were placed in a gas-powered drum roaster. The legumes were roasted to a temperature between about 185° C. and 250° C. A second set of chickpeas were roasted raw (unhydrolyzed chickpeas).

Both hydrolyzed and unhydrolyzed chickpeas were ground to a particle size of about 0.250 mm to about 5 mm. The chickpeas were separately extracted as follows. The ground roasted chickpeas were extracted in a recirculation pot in which the grounds were placed on a false bottom. The extraction was conducted at 85° C. for ten minutes. As the water percolated over the bed of ground chickpeas, it was pumped over the top. When analyzing yields, the volume of water going in versus the volume of extract that came out were taken into account. The two chickpea extracts were then passed through a rising film evaporator to concentrate the extracts. The rising film evaporator settings were as follows: product temperature fluctuated between 71-80° C., the vacuum was fluctuated from 0.6 to 0.7 bar, and the capacity of the evaporator was 8 L of water evaporated per hour. Once a concentrate was created from each batch, Brix and viscosity were measured.

Due to the large difference in viscosity between the hydrolyzed and unhydrolyzed extracts, two methods of viscosity measurements were utilized to confirm the accuracy of the readings. The concentrates made with hydrolyzed chickpeas were measured with an Ubbelohde Viscometer, while the concentrates made with unhydrolyzed chickpeas were measured with a Brookefield viscometer because they gelled to a point at which they did not function as Newtonian liquids and could not flow through the Ubbelohde Viscometer. The results of these studies are provided in TABLE 9.

TABLE 9
Brix and viscosity of treated and untreated chickpea concentrate

| | Final Brix | Viscosity (mPa*s) |
|---|---|---|
| Untreated Chickpeas | 14.5 | 36.35 |
| Acid Treated Chickpeas | 24.5 | 6.46 |

As shown in TABLE 9, even though the Brix of the untreated roasted chickpea concentrate was lower (which would inherently yield a lower viscosity than that of the acid treated concentrate), the viscosity was measured to be much higher. The higher viscosity also was a clear sign of protein gelling. Both extracts had been processed in the same manner, but due to gelling of the unhydrolyzed chickpea extract during the concentration process, the viscosity of the untreated concentrate was so high that it functioned as a solid rather than as a liquid.

The viscosity testing of concentrated extracts produced from roasted treated and untreated chickpeas revealed that hydrolyzing fibrous-proteinaceous legumes before roasting generated a product that was more suitable for downstream processing such as extract concentrating and spray drying. Thus, acid treatment of fibrous, proteinaceous ingredients allowed these substrates to be useful in applications (e.g., in products such as a coffee concentrate replacements based on hydrolyzed roasted chickpeas) that were not possible without such treatment.

### Example 10—Sedimentation and Quantification of Sediment Potential

### Quantification of Sediment by Centrifugation

The sedimentation potential of particles in a liquid was measured in a centrifuge, in which a liquid sample was subjected to high centrifugal forces to observe and quantify the sedimentation behavior of suspended particles. The centrifugal force pushes particles away from the center of rotation, leading to their separation based on their mass and density differences.

### Extract Preparation and Testing

Extracts made from hydrolyzed and unhydrolyzed chickpeas were generated and then concentrated using a rising film evaporator. Ten kilos of chickpeas were hydrolyzed by preparing a solution of water and 65% phosphoric and heated to 85° C. The chickpeas were added and gently stirred so all chickpeas were in contact with the acid solution for 15-60 minutes. After this time, the slurry was drained, and the chickpeas were placed in a gas-powered drum roaster. The legumes were roasted to a temperature of about 185° C. to 240° C.

A second set of chickpeas were roasted raw (unhydrolyzed). The hydrolyzed and unhydrolyzed chickpeas were ground to a particle size of about 0.250 mm to about 5 mm. The chickpeas from each batch were separately extracted as follows: the ground roasted chickpeas were extracted in a recirculation pot in which the grounds were placed on a false bottom. The extraction was conducted at 85° C. for ten minutes. As the water percolated over the bed of ground chickpeas, it was pumped over the top. Four, 50 g samples were gathered from each extract and placed in an Allegra X-22R Centrifuge, and the samples were spun at 4500 RPM for 10 minutes. The supernatant from each sample was decanted and separated from the pellet of solids at the bottom of the test tube. The weights of the supernatant and the pellet were measured to determine the amount of sedimentation present in each sample.

TABLE 10
Sediment in extracts from treated and untreated roasted chickpeas

| | % | | Time | Liquid | Liquid | Solids | % |
|---|---|---|---|---|---|---|---|
| Roast | Chickpeas | RPM | (min) | Weight In | Weight Out | Weight | Insoluble |
| Acid Treated | 8% | 4500 | 10 | 50 | 49.5625 | 0.24 | 0.48% |
| Chickpeas | | | | | | | |
| Non-Treated | 8% | 4500 | 10 | 50 | 49.33 | 0.38 | 0.76% |
| Chickpeas | | | | | | | |

As shown in TABLE 10, the extract produced from roasted, hydrolyzed chickpeas produced 63% less sediment than the extract produced from roasted non-hydrolyzed chickpeas. Thus, the extract produced from hydrolyzed chickpeas yielded a more desirable product more suited to its intended purpose as a beverage.

### Example 11—Chickpea Coffee Replacement Beverages Prepared Using Acid Treatment Followed by Enzymatic Treatment

The following steps were used to generate chickpea coffee beverage replicas, using either sulfuric acid pre-treatment, phosphoric acid pre-treatment, or hydrochloric acid pre-treatment of the chickpeas, followed by treatment with an enzymatic solution. In addition to acid treatment, chickpeas were treated enzymatically with a solution containing one or more enzymes such as carbohydrases, proteases, amylase, pectinase, cellulase, hemicellulase, xylanase, ligninase, and/or tannase in aqueous solution to assist with breakdown of the fibrous material of chickpea proteins and starches without causing liquefaction that may disintegrate the physical integrity of the chickpea from a solid to a liquid form.

### Sulfuric Acid Treated Chickpeas

1) A solution containing water and 0.1-1% w/w of a 99% sulfuric acid solution was prepared and heated to 60-90° C.
2) Chickpeas were added to the sulfuric acid solution to generate a 50% chickpeas, 50% sulfuric acid solution mixture, and the mixture was gently stirred so all legumes were in contact with the acid solution. Stirring was continued for 15-60 minutes.
3) After 15-60 minutes, the slurry was drained, rinsed, then treated with one or more enzymatic solutions, each solution containing one or more enzymes including a protease such as bromelain, alkaline proteases, papain, or actinidin, carbohydrase such as, amylase, α-amylase, β-amylase, lactase, sucrase, isomaltase, pectinase, cellulase, hemicellulase, xylanase, and/or tannase in aqueous solution with agitation for 30 to 120 minutes. The enzymatic solution contained about 0.1% to about 1% enzyme at a weight ratio of about 100:1 plant material to enzyme. A double enzymatic treatment consisted of a first enzymatic treatment with an enzymatic solution of α-amylase and/or β-amylase (where α-amylase hydrolyzes the internal α-1,4-glycosidic bonds within starch and glycogen, resulting in maltose, maltotriose, and dextrins and β-amylase acts on the non-reducing ends of starch and glycogen, breaking the terminal α-1,4-glycosidic bond to produce maltose), then followed by a second enzymatic treatment with an enzymatic solution containing lactase, sucrase, and/or isomaltase to assist with breaking down products produced by α-amylase and/or β-amylase. Optionally, the chickpeas are treated with an enzymatic solution containing one or more carbohydrases and/or proteases.
4) The chickpeas were drained of the solution and were roasted to a bean temperature of about 185-225° C. Optionally, after roasting but before grinding, the chickpeas were enzymatically treated with one or more enzymatic solutions containing carbohydrases and/or proteases.
5) The pre-treated and roasted chickpeas were ground to generate particles from about 0.250 mm to about 5 mm in size. Optionally, after grinding, the chickpeas were enzymatically treated with one or more enzymatic solutions containing carbohydrases and/or proteases.
6) Optionally, if the final finished product that is desired is a beverage or liquid concentrate, the ground particles were extracted with 60-85° C. water via a recirculating pot for 5-45 minutes at 4-36% w/w grounds to water.
7) The extract was cooled to 10° C. and filtered through a 25 micron filter paper.
8) The extract was diluted, and caffeine, one or more acids, and/or one or more flavors were added to yield a final beverage for use as a coffee replacement.
9) Optionally, before the acid treatment of step 1, the chickpeas were treated with an enzymatic solution containing one or more cellulases, ligninases, or hemicellulases.

### Hydrochloric Acid Treated Chickpeas

1) A solution containing water and 0.1-0.6% w/w of a 37% hydrochloric acid solution was prepared and heated to 60-90° C.
2) Chickpeas were added to the hydrochloric acid solution to generate a 50% chickpeas, 50% hydrochloric acid solution mixture, and the mixture was gently stirred so all legumes were in contact with the acid solution. Stirring was continued for 15-60 minutes.
3) After 15-60 minutes, the slurry was drained, rinsed, then treated with one or more enzymatic solutions, each solution containing one or more enzymes including a protease such as bromelain, alkaline proteases, papain, or actinidin, carbohydrase such as, amylase, α-amylase, β-amylase, lactase, sucrase, isomaltase, pectinase, cellulase, hemicellulase, xylanase, and/or tannase in aqueous solution with agitation for 30 to 120 minutes. The enzymatic solution contained about 0.1% to about 1% enzyme at a weight ratio of about 100:1 plant material to enzyme. A double enzymatic treatment consisted of a first enzymatic treatment with an enzymatic solution of α-amylase and/or β-amylase (where α-amylase hydrolyzes the internal α-1,4-glycosidic bonds within starch and glycogen, resulting in maltose, maltotriose, and dextrins and β-amylase acts on the non-reducing ends of starch and glycogen, breaking the terminal α-1,4-glycosidic bond to produce maltose), then followed by a second enzymatic treatment with an enzymatic solution containing lactase, sucrase, and/or isomaltase to assist with breaking down products produced by α-amylase and/or β-amylase. Optionally, the chickpeas were treated with an enzymatic solution containing one or more carbohydrases and/or proteases.
4) The chickpeas were drained of the enzymatic solutions and were roasted to a temperature of about 185-225° C. Optionally, after roasting but before grinding, the chickpeas were enzymatically treated with one or more enzymatic solutions containing carbohydrases and/or proteases.
5) The pre-treated and roasted chickpeas were ground to generate particles from about 0.250 mm to about 5 mm in size. Optionally, after grinding, the chickpeas were enzymatically treated with one or more enzymatic solutions containing carbohydrases and/or proteases.
6) Optionally, if the final finished product that is desired is a beverage or liquid concentrate, the ground particles were extracted with 60-85° C. water via a recirculating pot for 5-45 minutes at 4-36% w/w grounds to water.
7) The extract was cooled to 10° C. and filtered through a 25 micron filter paper.
8) The extract was diluted, and caffeine, one or more acids, and/or one or more flavors were added to yield a final beverage for use as a coffee replacement.
9) Optionally, before the acid treatment of step 1, the chickpeas were treated with an enzymatic solution containing one or more enzymes including one or more cellulases, ligninases, or hemicellulases. The enzymes assist with breakdown of the fibers and protein of the chickpeas and other legumes. For example, enzymes were utilized at 0.1-1% at 50-65° C. for 30 minutes after the pH adjustment process to increase breakdown while keeping the legumes whole for further processing.

### Phosphoric Acid Treated Chickpeas

1) A solution containing water and 0.1-1% w/w of an 85% phosphoric acid solution is prepared and heated to 60-90° C.
2) Chickpeas are added to the phosphoric acid solution to generate a 50% chickpeas, 50% phosphoric acid solution mixture, and the mixture is gently stirred so all legumes are in contact with the acid solution. Stirring is continued for 15-60 minutes.
3) After 15-60 minutes, the slurry is drained, rinsed, then treated with one or more enzymatic solutions, each solution containing one or more enzymes including a protease such as bromelain, alkaline proteases, papain, or actinidin, carbohydrase such as, amylase, α-amylase, β-amylase, lactase, sucrase, isomaltase, pectinase, cellulase, hemicellulase, xylanase, and/or tannase in aqueous solution with agitation for 30 to 120 minutes. The enzymatic solution contains about 0.1% to about 1% enzyme at a weight ratio of about 100:1 plant material to enzyme. A double enzymatic treatment is optionally performed. A first enzymatic treatment is performed with an enzymatic solution of α-amylase and/or β-amylase (where α-amylase hydrolyzes the internal α-1,4-glycosidic bonds within starch and glycogen, resulting in maltose, maltotriose, and dextrins and β-amylase acts on the non-reducing ends of starch and glycogen, breaking the terminal «-1,4-glycosidic bond to produce maltose). After treatment, the solution is drained and the sample is subject to a second enzymatic treatment with an enzymatic solution containing lactase, sucrase, and/or isomaltase to assist with breaking down products produced by α-amylase and/or β-amylase. The chickpeas are treated with an enzymatic solution containing one or more carbohydrases and/or proteases in addition to, or instead of one of the first or second enzymatic treatment.
4) The chickpeas are drained of the enzymatic solutions and are roasted to a bean temperature of about 185-225° C. Optionally, after roasting but before grinding, the chickpeas are enzymatically treated with one or more enzymatic solutions containing carbohydrases and/or proteases.
5) The pre-treated and roasted chickpeas are ground to generate particles from about 0.250 mm to about 5 mm in size. Optionally, after grinding, the chickpeas are enzymatically treated with one or more enzymatic solutions containing carbohydrases and/or proteases.
6) Optionally, if the final finished product that is desired is a beverage or liquid concentrate, the ground particles are extracted with 60-85° C. water via a recirculating pot for 5-45 minutes at 4-36% w/w grounds to water.
7) The extract is cooled to 10° C. and filtered through a 25 micron filter paper.
8) The extract is diluted, and caffeine, one or more acids, and/or one or more flavors are added to yield a final beverage for use as a coffee replacement.
9) Optionally, before the acid treatment of step 1, the chickpeas are treated with an enzymatic solution containing one or more enzymes including one or more cellulases, ligninases, or hemicellulases at a concentration of 0.1-1% at 50-65° C. for 30 minutes after the pH adjustment process to increase breakdown while keeping the legumes whole (and not liquefied) for further processing.

### Example 12—Hydrolysis of Legumes Under Pressure-Chickpeas

Hydrolysis of starches and denaturing of proteins is vastly more efficient under pressure. Firstly, an increase in pressure augments the rate of the acid hydrolysis reaction. The heightened pressure facilitates more frequent molecular collisions and interactions between the starch molecules and the acid, thereby accelerating the breakdown of starch into simpler sugars. When higher pressure is combined with increased temperature, the effects on starch hydrolysis are amplified. Combining acid and pressure can have a synergistic effect on protein denaturation. For instance, proteins subjected to both acidic conditions and high pressure may experience denaturation more rapidly or to a greater extent than when exposed to either factor alone. The acid can weaken the protein's structure, making it more susceptible to pressure-induced alterations.

In order to hydrolyze chickpeas, acid and water are applied at varying temperatures, times, and pressures. A solution is made of water, acid, and legumes. Varying amounts of pressure between 1-10 bars is applied. The chickpeas are then roasted to a bean temperature of 215° C. in a drum roaster. The resulting roasted chickpeas are then extracted in a recirculating pot. The extract is cooled. Analysis of the measured NTUs and Brix can identify the conditions for pressure, temperature, and time when hydrolyzing legumes. Measurements of Brix and NTU are collected to determine how pressure affects the hydrolysis of chickpeas. Based on research and observations, the higher the pressure, the more efficient the hydrolysis, with a lowering of insolubles, represented with lowered NTUs, and an increase in solubles, represented by an increase in brix. A point of saturation, where the increase in pressure does not have a linear increase in brix or a linear decrease in NTUs, identifies the most efficient pressure for hydrolysis of chickpeas.

The next parameter tested is temperature. The addition of pressure enables the use of lower temperatures during hydrolysis. In these experiments, the amount of acid, type of acid the same, and time are kept the same, but the hydrolysis reaction is conducted at different temperatures and pressures. The chickpeas are roasted to a bean temperature of about 165-250° C. in a drum roaster. The roasted chickpeas are then extracted in a recirculating pot. Upon cooling of the extract, degrees brix and NTUs are measured. Analysis of the measured NTUs and Brix can identify the conditions for pressure, temperature, and time when hydrolyzing legumes.

Measurements of Brix and NTU measurements are collected to determine how pressure and temperature affect the hydrolysis of chickpeas. Based on research and observations, hydrolysis is efficient at lower temperatures when under pressure. Increase in efficiency of hydrolysis is represented by the lowering of NTUs and raising of Brix at lower temperatures. A point of saturation, where the increase in temperature does not have a linear increase in brix or a linear decrease in NTUs, identifies the most efficient pressure for hydrolysis of chickpeas.

The next test parameter is time. The addition of pressure enables the use of less time for hydrolysis. In these experiments, the amount of acid, type of acid, and temperature are kept the same, but the hydrolysis reaction is conducted at different times and pressures. The chickpeas are roasted to a bean temperature of 215° C. in a drum roaster. The roasted chickpeas are then extracted in a recirculating pot. The extract is cooled and degrees brix and NTUs measured. The NTUs and brix are measured in order to determine the most efficient combination of pressure, temperature, and time when hydrolyzing legumes. Based on research and observations, hydrolysis of chickpeas needs less time to be efficient under pressure. An increase in efficiency of hydrolysis is represented by the lowering of NTUs and raising of Brix in less time. A point of saturation where the increase in time does have a linear increase in brix or a linear decrease in NTUs, indicates the most efficient pressure and time for hydrolysis of legumes.

### Example 13—Preparation of Coffee Grounds from Hydrolyzed Chickpeas

The following steps were used to prepare four types of coffee grounds from chickpeas hydrolyzed with phosphoric acid.
1) A solution containing water and 0.1-0.6% w/w of a 65% phosphoric acid solution was prepared and heated to 85° C.
2) Chickpeas were added to the phosphoric acid solution to generate a 50% chickpea, 50% acid solution mixture, which was gently stirred so that all chickpeas were in contact with the acid solution. Stirring was continued for 15-60 minutes.
3) After 15-60 minutes, the slurry was drained, and the chickpeas were placed in an electric coffee roaster.
4) The chickpeas were roasted to 185-225° C. resulting in roasted chickpeas with retention of individual structure suitable for grinding in the next step.
5) The pre-treated (e.g., acid-treated) and roasted chickpeas were ground to produce four types of grounds: espresso, capsules or pods (e.g., single-serve coffee formats produced by Nespresso® or Keurig®, respectively), filter-type coffee (e.g., grounds for conventional paper-filtered drip coffee machines), and cold brew (e.g., coffee brewed by steeping coarser ground coffee beans water at room temperature or cooler temperatures for an extended period, typically between 12 to 24 hours, otherwise known as cold water extraction or cold pressing).

TABLE 11
Particle size for various chickpea coffee-like grounds

| | Particle size range |
|---|---|
| Coffee format | (hydrolyzed & roasted chickpea) |
| Espresso-type grounds | 200 to 450 microns |
| Capsules or pod grounds | 200 to 700 microns |
| Filter-type grounds | 500 microns to 1 mm |
| Cold brew grounds | 700 microns to 1.5 mm |

The pre-treated and roasted chickpeas were ground using one or more grinders, such as but not limited to disc grinders, roll grinders, burr grinder, blade grinders, and hammer mills. The grinding process of the chickpeas was executed to achieve specific particle sizes conducive to different brewing techniques. As shown in TABLE 11, grounds with particle sizes suitable for four different coffee formats were prepared with conventional coffee bean grinding equipment. For a coarser ground suitable for cold brew coffee, for example, grinders were utilized that produce consistent, relatively larger particles. Suitable grinders include burr grinders, which use two revolving abrasive surfaces (burrs) to grind the coffee beans. They are known for their consistency and ability to produce uniform grind sizes especially suitable for producing grounds for filter-type coffee. Burr grinders come in two main types. Flat burr grinders have two flat burrs that face each other and conical burr grinders have a cone-shaped burr that sits inside a ring-shaped burr. A disc grinder for industrial coffee grinding is a type of grinder that uses flat, circular discs to grind coffee beans to produce a consistent coarser ground size suitable for cold brews. A roll grinder was employed to produce a fine, homogeneous particle size distribution applicable for espresso and capsule/pod formats.
6) The coffee-like grounds were packaged into containers suitable for each format (e.g., 5-20 grams per single-serve coffee capsule or coffee pod).

Sensory testing was conducted for the coffee-substitutes (espresso, cold brew, capsule/pod, and filter-type) made. The results of sensory testing for a cold brew made from coffee-substitute grounds according to this example are provided below in Example 14.

### Example 14—Sensory Testing of Cold Brew Chickpea Coffee

### Methodology

Chickpea cold brew coffee that was made with hydrolyzed and unhydrolyzed chickpeas were prepared. A commercial brand of cold brew traditional coffee was purchased. Samples were analyzed for aroma, flavor, and mouthfeel by members of the Sensory Spectrum Food & Beverage Panel, trained and experienced in each type of evaluation. Samples were prepared by trained Sensory Spectrum staff and presented using agreed timing. (Location: Sensory Spectrum, New Providence, NJ; Number of Evaluators: 8-9; Evaluation Date: Oct. 25-26, 2023).

The strength of each attribute was rated on the 15-point Spectrum Scale, where 0=none and 15=very strong. This scale incorporates the ability to use tenths of a point and therefore has the potential of 150 scale differentiations. The scale may be expanded beyond 15 points to include extreme ratings if necessary. The panelists evaluated each sample using the following procedure: Each panelist received one 5-ounce cup of cold brew served at refrigerated temperature, or one 3-ounce ceramic cup of coffee served hot. Samples were blinded with a 3-digit code. All samples were expectorated.

### Results

Panelists evaluated the flavor, basic tastes (sweet, sour, salt, bitter), and feeling factor (mouthfeel) of a 1) traditional, commercial black and unsweetened cold brew coffee, 2) an unhydrolyzed medium roast chickpea cold brew coffee and 3) a hydrolyzed medium roast chickpea cold brew coffee across thirty-two (32) evaluative categories, including a dark roast score, a “coffee impact” score, and a “total impact” score. In a sensory taste test, a “coffee impact” score is a comprehensive evaluation of a coffee's sensory attributes, such as aroma, flavor, acidity, body, and aftertaste. This score is typically derived from a standardized cupping protocol, like the one used by the Specialty Coffee Association (SCA). Each attribute is rated on a scale, and the scores are combined to give an overall impact score, reflecting the coffee's quality and consumer appeal. A sensory taste test total impact score is a comprehensive measure used to evaluate the overall sensory experience of a food or beverage. This score typically combines various sensory attributes such as taste, aroma, texture, and appearance, assessed by a panel of trained tasters or consumers. Each attribute is rated, and the scores are aggregated to provide an overall impact score, reflecting the product's sensory quality and consumer acceptance.

TABLE 12 is a sensory evaluation scorecard or sensory data sheet. This table includes columns for various sensory attributes (flavor, basic tastes, and feeling factors (mouthfeel)) and rows for each sample being tested. Panelists recorded their scores for each attribute, and these scores were then analyzed to determine the overall sensory profile of the chickpea cold brew coffee products and a traditional commercial brand of cold brew coffee product. The “coffee impact” score of the hydrolyzed chickpea coffee was identical to that of the commercial traditional cold brew coffee (both attaining a score of 5.5). The hydrolyzed chickpea coffee also shared the same flavor scores as the commercial traditional cold brew coffee for “dark roast,” “woody,” “green (vegetative)”, and “sweet aromatics,” “caramelized” and many other flavor notes for a total of 17 out of 26 flavor notes, 3 out of 4 basic tastes, and 0 out of 2 for mouthfeel. The unhydrolyzed chickpea coffee shared the same flavor scores for 14 out of 26 flavor notes, only 1 out of 4 basic tastes, and 0 out of 2 for mouthfeel. In addition, the unhydrolyzed chickpea coffee scored less for coffee impact and also scored higher for burnt/charred flavor and much higher for bitter taste.

TABLE 12
Sensory evaluation scorecard for chickpea (hydrolyzed,
unhydrolyzed) “coffee” versus commercial
cold brew traditional coffee (black, unsweetened)

| | | | La Colombe Cold |
|---|---|---|---|
| | Unhydrolyzed | Hydrolyzed | Brew Black & |
| | Medium Roast | Medium Roast | Unsweetened |
| Flavor | “Coffee” | “Coffee” | Coffee |
| Total impact | 7.0 | 7.0 | 6.5 |
| Coffee Impact | 4.5 | 5.5 | 5.5 |
| Dark Roast | 1.5 | 1.0 | 1.0 |
| Chocolate | 0.0 | 2.5 | 1.0 |
| Nutty | 1.0 | 0.0 | 1.0 |
| Woody | 1.5 | 1.0 | 1.0 |
| Dried fruit/Prune | 0.0 | 0.0 | 1.0 |
| Winey/Berry | 0.0 | 1.0 | 0.0 |
| Green (Fresh) | 0.0 | 0.0 | 0.5 |
| Green (Vegetative) | 0.5 | 0.0 | 0.0 |
| Cereal/Grainy | 1.5 | 0.0 | 0.0 |
| Tea/Tobacco | 0.0 | 1.5 | 0.0 |
| Sweet Aromatics | 0.0 | 0.0 | 0.0 |
| Caramelized | 0.0 | 0.0 | 0.0 |
| Refiner's | 0.0 | 0.0 | 0.0 |
| Brown Spice | 0.0 | 0.0 | 0.0 |
| Meaty/Brothy | 0.0 | 0.0 | 0.0 |
| Papery (white) | 1.0 | 0.0 | 0.0 |
| Cardboardy | 0.0 | 0.0 | 1.0 |
| Earthy/Wet Soil | 0.0 | 0.0 | 0.0 |
| Fermented Silage | 0.0 | 0.0 | 0.0 |
| Ashy | 0.0 | 0.0 | 0.0 |
| Burnt/Charred | 1.5 | 0.0 | 0.0 |
| Rubber/Skunky | 0.0 | 0.0 | 0.0 |
| Vinyl | 0.0 | 0.0 | 0.0 |
| Phenol | 0.0 | 0.0 | 0.0 |

BASIC TASTES

| | | | |
|---|---|---|---|
| Sweet | 2.0 | 2.0 | 1.5 |
| Sour | 2.5 | 3.0 | 3.0 |
| Salt | 0.0 | 0.0 | 0.0 |
| Bitter | 6.0 | 4.5 | 4.5 |

FEELING FACTORS/MOUTHFEEL

| | | | |
|---|---|---|---|
| Astringent | 3.3 | 3.0 | 3.0 |
| Balance/Blend | 5.0 | 6.5 | 7.5 |

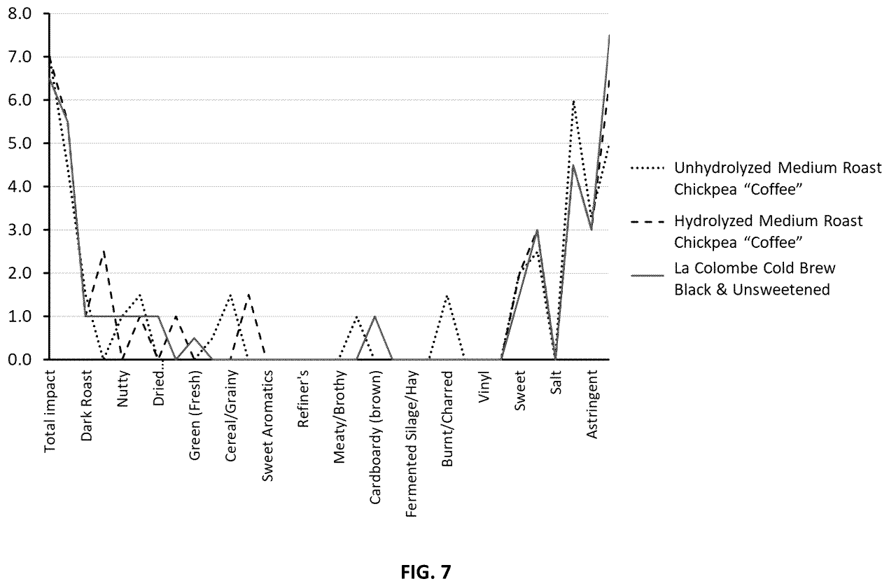

FIG. 7 is a graphical comparison of some of the sensory panel ratings of the flavor profile of the same two chickpea coffees and one traditional cold brew coffee products: 1) traditional, commercial black and unsweetened cold brew coffee, 2) an unhydrolyzed medium roast chickpea cold brew coffee and 3) a hydrolyzed medium roast chickpea cold brew coffee across fifteen (15) flavor categories, and also provided a “total impact” score.

Both the unhydrolyzed and hydrolyzed versions of the chickpea cold brew coffees generally tracked the flavor profile of the traditional, commercial cold brew coffee, as perceived by sensory panelists. This result indicated that even without hydrolysis, the chickpea brew was perceived to be recognized as having the general flavor of coffee. However, the unhydrolyzed chickpea coffee had “off-notes” not shared by either the traditional cold brew or the hydrolyzed chickpea brew, such as burnt/charred, meaty, and salty flavor notes. In contrast, the hydrolyzed chickpea coffee tracked very closely with the flavor profile of the commercial cold brew coffee, as perceived by the sensory panelists. The hydrolyzed chickpea brew was perceived to have slightly higher “dark roast,” “green (fresh)” and “cereal/grainy” notes but these deviations from the corresponding scores for traditional cold brew coffee were not appreciable.

These sensory testing results provided useful information about the flavor discrepancies or “gaps” between traditional cold brew coffee and the hydrolyzed and unhydrolyzed coffees for manipulating the processing conditions of the chickpea-based coffees (e.g., pH, temperatures, pressure, time) to achieve flavor parity with traditional coffee products.

### Example 15—Soluble “Instant Coffee” Particles from Hydrolyzed Chickpeas

The following steps were used to obtain soluble “instant” coffee-like granules, pellets, or powder from acid-hydrolyzed and roasted chickpeas.
1) A solution containing water and 0.1-1% w/w of a 65% phosphoric acid solution was prepared and heated to about 85° C.
2) Chickpeas were added to the phosphoric acid solution to generate a 50% chickpea, 50% acid solution mixture, which was gently stirred so that all chickpeas were in contact with the acid solution. Stirring was continued for 15-60 minutes.
3) After 15-60 minutes, the slurry was drained, and the chickpeas were placed in an electric coffee roaster.
4) The chickpeas were roasted to 185-225° C. resulting in roasted chickpeas with retention of individual structure suitable for grinding in the next step.
5) The pre-treated (e.g., acid-treated) and roasted chickpeas were ground to a particle size from about 0.250 mm to about 5 mm.
6) The ground particles were extracted with 60-175° C. water via a recirculating pot for 5-45 minutes at 4-36% w/w grounds to water to extract soluble coffee-like solids from the ground chickpea particles. Water is the solvent of choice for extraction since it is a safe and accessible solvent that can dissolve many of the soluble compounds in coffee. In addition to water, organic solvents such as ethanol or ethyl acetate (a compound found in fruits) is also contemplated. Extraction was continued until the solution obtained was about 15-25% w/w soluble coffee solids.
7) The extract was optionally cooled to 10° C. and filtered through a 25 micron filter paper to remove any insoluble sediments (filtering is also optional but preferred to remove any undissolved particulates). It was found that cooling the extract was useful for several reasons: 1) cooling the extract helped prevent the formation of off-notes or undesirable flavors that can occur if the extract remains at high temperatures for too long. This ensures that the final product retains its intended flavor profile; 2) high temperatures can cause the loss of volatile aromatic compounds, which are crucial for the coffee's aroma and cooling can limit this loss; 3) cooling the extract stabilizes it, preventing further chemical reactions that could degrade the quality of the coffee; 4) in further processing of the extract such as freeze-drying or spray-drying, cooling the extract helps ensure that the extract is at the optimal temperature for these subsequent stages.
8) The extract was concentrated to increase the solid content, by evaporation (e.g., using a falling film evaporator, rising film evaporator, forced circulation evaporator, plate evaporator, or flash evaporator), by freezing and/or by thawing (i.e., freeze concentration involves freezing the coffee extract, partially thawing, and then removing ice crystals to increase the concentration of soluble solids.
9) The concentrate was dried by spray or freeze drying. In spray drying, the concentrated coffee extract (“concentrate”) was sprayed into a tower with hot air (around 250° C.). The hot air rapidly evaporates the water, leaving behind fine particles in the form of fine soluble granules or soluble powder (e.g., “powder concentrate”). If larger soluble granules or soluble pellets were desired, the fine particles/powder collected at the bottom of the tower were agglomerated to form larger, more soluble granules or pellets. For agglomeration, the fine coffee powder was subjected to the agglomeration process to form larger, more soluble granules or pellets. This process typically involves rewetting the dry particles with water or steam, bringing the wetted particles in contact with one another, often in a fluidized bed or a rotating drum, then drying the newly formed granules or pellets to remove any excess moisture and to ensure they are stable and free-flowing.

### Example 16—Increased Sugars in Chickpeas Treated with Phosphoric Acid

It has been previously taught that reducing sugars play a crucial role in the development of aroma and flavor in roasted coffee beans through Maillard reactions where, for example, the amino group of free amino acids and the carbonyl group of the reducing sugars form a complex mixture of compounds. In addition to the Maillard reaction, caramelization also occurs during roasting. This process involves the thermal decomposition of sugars, leading to the formation of caramel-like flavors and contributing to the color and sweetness of the coffee. The influence of pH on the formation of reducing sugars and other simple sugars in roasted chickpeas treated with phosphoric acid was determined. Batches of chickpeas were acid-hydrolyzed to different PH levels.

The following steps were used for phosphoric acid hydrolysis of chickpea batches treated to a pH of 4.5, 5.0, 5.5, 6.0, 6.5, or 7.0.
1) A solution containing water and a phosphoric acid solution was prepared and heated to 85° C.
2) Chickpeas were added to the phosphoric acid solution to generate a 50% chickpea, 50% acid solution mixture, which was gently stirred so that all chickpeas were in contact with the acid solution. Gentle stirring was continued for 15-60 minutes so all legumes were in contact with the acid solution. Stirring continued for 15-60 minutes.
3) After 15-60 minutes, the slurry was drained, and the chickpeas were placed in an electric coffee roaster.
4) The chickpeas were roasted to 185-225° C. resulting in roasted chickpeas with retention of individual structure suitable for grinding in the next step.
5) The acid-treated and roasted chickpeas were ground to a particle size from about 0.250 mm to about 5 mm.
6) The ground particles were extracted with 60-85° C. water via a recirculating pot for 5-45 minutes at 4-36% w/w grounds to water.
7) The extract was cooled to 10° C. and filtered through a 25 micron filter paper. The above method was used to hydrolyze various batches of chickpeas with phosphoric acid to produce batches having one of the following pHs: 4.5, 5.0, 5.5, 6.0, 6.5, and 7.0.

### HPLC Methodology

The total sugar content of chickpeas that were treated with phosphoric acid to varying pH levels and roasted were measured analytically through HPLC (High-Performance Liquid Chromatography). To prepare each hydrolyzed and roasted chickpea sample for HPLC analysis, each sample solution was kept at room temperature for 30 minutes. Sugars were extracted for multiple experimental runs; thereafter, the appropriate dilution was quantitated using HPLC. The moisture content was taken into account to transform results into dry basis % w/w amount of sugar in each sample. The total sugar was seen to increase consistently as the pH of the chickpea treatment decreased.

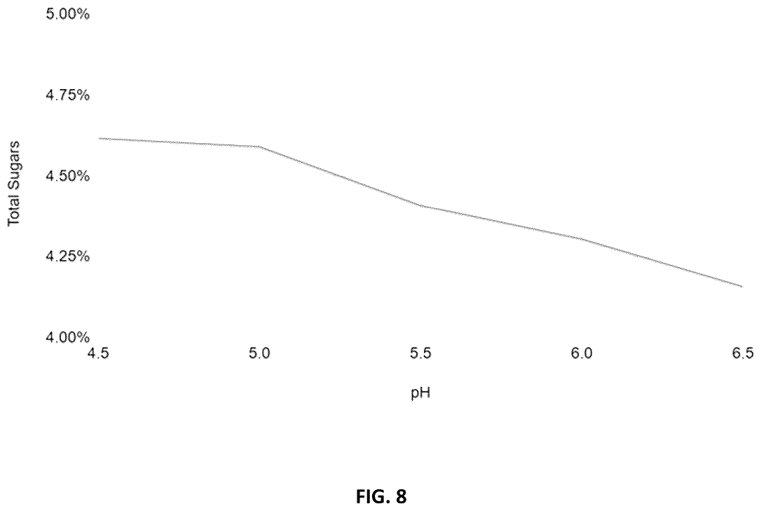

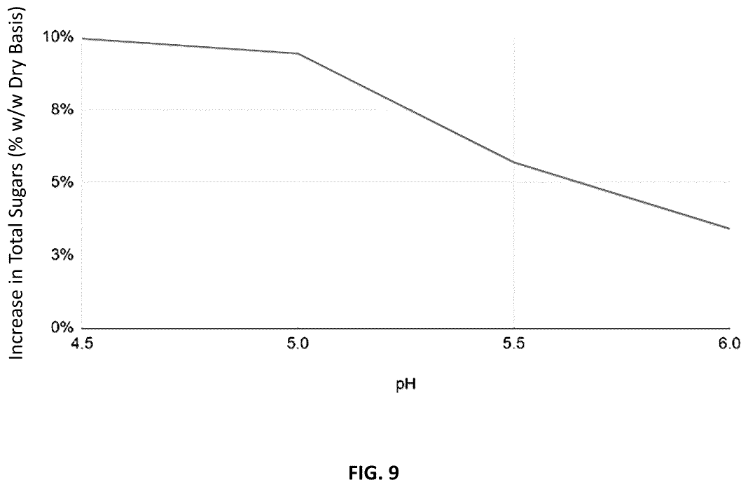

Untreated chickpeas typically have a neutral or slightly acidic pH of about 6.6-6.9. Chickpeas were treated with phosphoric acid to a pH of between about 4 and 6.5. In particular, as shown in TABLE 13, it was determined through LC-MS analysis of non-volatile compounds that phosphoric acid hydrolysis resulted in up to a 10% increase in total sugars in hydrolyzed chickpeas compared to unhydrolyzed chickpeas. The highest increase in total sugars was observed when chickpeas were hydrolyzed to a pH of 4.5, and the second highest when hydrolyzed to a pH of 5. The total sugars as a function of pH for the hydrolyzed chickpeas are graphically represented in FIG. 8. The percentage total sugars increase on a dry basis % w/w of hydrolyzed chickpeas as compared to unhydrolyzed chickpeas across a range of pHs between 4.5 and 6.0 is shown graphically in FIG. 9.

TABLE 13
Total sugars in phosphoric acid hydrolyzed
chickpeas at different pHs

| | | Total | Increase in Total Sugars |
|---|---|---|---|
| | pH | Sugars | in a dry basis % w/w |
| Treated Chickpeas | 4.5 | 4.62% | 10% |
| Treated Chickpeas | 5 | 4.59% | 9% |
| Treated Chickpeas | 5.5 | 4.41% | 6% |
| Treated Chickpeas | 6 | 4.30% | 3% |
| Untreated Chickpeas | 6.5 | 4.16% | 0% |

TABLE 14 shows that several reducing sugars, such as fructose, glucose, maltose, lactose, as well as the caramelizing disaccharide, sucrose, could be increased by acid-hydrolyzing the chickpeas to a relatively low pH of about 4.5. This experiment demonstrates that the formation of reducing and other sugars in chickpeas could be manipulated by adjusting the acid hydrolysis conditions.

TABLE 14
Sugars in chickpeas hydrolyzed with
phosphoric acid at different pH

| | | | | | | Total |
|---|---|---|---|---|---|---|
| pH | Fructose | Glucose | Sucrose | Maltose | Lactose | Sugar |
| 4.5 | 0.43% | <0.01% | 4.20% | <0.01% | <0.01% | 4.62% |
| 5 | 0.45% | <0.01% | 4.15% | <0.01% | <0.01% | 4.59% |
| 5.5 | 0.43% | <0.01% | 3.98% | <0.01% | <0.01% | 4.41% |
| 6 | 0.47% | <0.01% | 3.84% | <0.01% | <0.01% | 4.30% |
| 6.5 | 0.28% | <0.01% | 3.88% | <0.01% | <0.01% | 4.16% |

Although results are not shown, it was found that hydrolysis of the chickpeas to a pH below 4 resulted in undesirable aromas and off-notes, where chickpeas developed an unpleasant metallic or acidic taste. Further, the chickpeas lost their physical integrity and started to liquefy at a pH of below about 4. When alkali hydrolysis was performed instead of acid hydrolysis and the pH of the chickpea was raised to between about 8 to 9 and above, strong sulfurous odors were observed. Thus, it was determined that the pH range of 4 to about 7 was ideal for increasing the total sugars in hydrolyzed chickpeas. Further HPLC and GC-MS analyses was conducted for chickpeas that were hydrolyzed to a pH in this range, which was also discovered to be the pH range conducive to the creation of desirable organoleptic characteristics. It was also found that, among the various acids utilized for acid hydrolysis, phosphoric acid was particularly suited for acid hydrolysis of chickpeas to increase total sugar levels. Phosphoric acid was less corrosive on steel reaction vessels than either hydrochloric acid and sulfuric acid, and hydrolysis of chickpeas with phosphoric acid resulted in treated chickpeas that, when roasted, also possessed desirable organoleptic qualities and important volatile compound classes that are commonly associated with the aroma and flavor of roasted coffee beans, as discussed below.

### Example 17: Acid Hydrolysis of Chickpeas to Different pH Levels

The Maillard reaction and Strecker degradation during roasting of coffee beans produce volatile organic compounds and derivatives, which are responsible for the aromatic profile of coffee. These compounds include various aromatic molecules that give coffee its distinct and appealing smell. In fact, it has been shown that of the 800 to 1000 volatile compounds recorded in coffee, only about 20-30 influence the aroma of coffee. (See Laukalēja, Ilze & Koppel, Kadri. (2021). Aroma active compound perception in differently roasted and brewed coffees by gas chromatography—olfactometry. Journal of Sensory Studies. 36. 10.1111/joss.12708). Furans, pyrazines, and ketones are considered the most significant volatile organic compound (VOC) classes that contribute to coffee aroma (see Petisca, Catarina & Pérez-Palacios, Trinidad & Farah, Adriana & Pinho, Olívia & Ferreira, Isabel. (2013). Furans and other volatile compounds in ground roasted and espresso coffee using headspace solid-phase microextraction: Effect of roasting speed. Food and Bioproducts Processing, 91, 233-241).

Other VOC classes important for coffee aroma are pyridines, aldehydes, furanones, alcohols, acids, pyrroles, esters, sulfur compounds, and pyridines. (See Angeloni S, Mustafa A M, Abouelenein D, Alessandroni L, Acquaticci L, Nzekoue F K, Petrelli R, Sagratini G, Vittori S, Torregiani E, et al. Characterization of the Aroma Profile and Main Key Odorants of Espresso Coffee. Molecules. 2021; 26 (13): 3856. doi.org/10.3390/molecules26133856).

GC-MS analysis was conducted to determine if some of the volatile organic compounds that are considered to be key contributors to aroma and flavor in traditional coffee could be identified in roasted chickpea samples that were hydrolyzed with phosphoric acid. In addition, analyses were conducted to see if changing the pH of the hydrolyzed chickpeas would result in a change in the concentration of these volatile organic compounds. Hydrolyzed and unhydrolyzed solid chickpea samples from medium and dark roast chickpeas were analyzed by GC-MS to compare volatile compound profiles. It was observed that roasted chickpeas pre-treated with acid hydrolysis to a range of pH between 4 and 7 evidenced appreciable differences in the concentrations of certain volatile compound classes.

### GC-MS Analysis

Hydrolyzed, roasted, and ground (HRG) chickpeas samples treated at different pH levels were analyzed by gas chromatography mass spectrometry (GC-MS) to compare volatile compound profiles.

### Sample Preparation

Dynamic headspace (DHS) with Tenax-TA sorbent tubes (Gerstel GmbH, Germany) were used to extract VOCs from chickpea samples for GC-MS analysis. Samples were prepared by weighing 500 mg (+10 mg) of HRG chickpeas in 20 mL glass headspace vials. Five μL of an internal standard solution containing 2-methyl-3-heptanone (50 μg/mL) in methanol was added to each samples with a 10 μL glass gas-tight syringe. Samples were analyzed by GC-MS in triplicate.

### GC-MS

The GC-MS system consisted of an Agilent 8890 GC with a 7000D triple quadrupole MS (Agilent Technologies, USA). The GC-MS was equipped with a Gerstel MultiPurpose Sampler Robotic Pro (MPS), a DHS module, a Thermal Desorption Unit 2 (TDU), a Cooled Injection System 4C (CIS), a C506 controller with liquid nitrogen cooling for CIS, a Universal Peltier Cooling (UPC) for TDU, a EPC pneumatic module for CIS use with Agilent 8890, and a Automatic Tube Exchange (ATEX) option for MPS (Gerstel GmbH, Germany). A Stabilwax-MS (30 meter, 0.25 mmID, 0.25 μM film thickness) GC column was used (Restek, USA). The CIS was equipped with a deactivated, notched, glassbead liner (Gerstel GmbH, Germany). The Agilent GC-MS was controlled by MassHunter GCMS Acquisition software (Agilent Technologies, USA). The Gerstel components were controlled by Maestro software (Gerstel GmbH, Germany).

For DHS extraction the sample headspace vial was transferred to the DHS incubator and preincubated at 60° C. for 1 minute. After preincubation the Tenax-TA sorbent in a TDU tube (trap) was positioned over the headspace vial and pierced with the DHS needle for the trapping phase. During the trapping phase the sample headspace was purged with 1000 mL of nitrogen gas at 50 mL/min flow rate and agitated for 60 seconds on and 1 second off at 250 rpm. The incubation temperature was 60° C., the trap temperature was 30° C., and the transfer heater was set to 75° C.

After DHS extraction the Tenax-TA sorbent sample was desorbed in the TDU with an initial temperature of 40° C., delay time of 0.5 min, after which the temperature was ramped at 720° C./min to 280° C. and held for 3 min. The TDU transfer temperature was fixed at 280° C. and the desorption mode in the TDU was splitless. Desorbed compounds were trapped in the CIS at an initial temperature of −120° C. with a 0.2 min equilibration time, after which the temperature was ramped at 12° C./s to 275° C., and held for 3 min. The inlet pneumatics were operated in solvent vent mode with a pressure of 13.356 psi, a purge flow to split vent of 20 mL/min at 0.01 min, and a vent flow of 50 mL/min. Helium was used as a carrier gas at a flow rate of 1 mL/min. The GC oven was set to an initial temperature of 40° C. with a 5 min hold time after which the temperature was ramped to 250° C. at a rate of 8° C./min and held for 3.75 min for a total run time of 35 min. The collision cell used helium as a quench gas with 2.25 mL/min flow rate and nitrogen as collision gas at 1.5 mL/min flow rate. The MS transfer line was set to 250° C., the source temperature was 230° C., and the quadrupoles set to 150° C. The ion source was operated in electron impact (EI) mode at 70 eV. A 2.8 min solvent delay was used. The MS was operated in scan mode with a scan time of 245 ms and a scan range of 35-350 amu.

### Identification of Volatile Compounds

Compounds were identified by comparison of their retention time and mass spectra with an in-house library generated by analysis of reference standards. Compounds where no reference was available were identified by comparison of RI and mass spectra with available databases. An alkane mix containing C8-C20 linear alkanes at 40 μg/mL in hexane (Sigma, USA) was spiked (3 μL) into 20 mL headspace vial and analyzed in the same manner as HRG chickpea samples to calculate RI. The NIST mass spectral database (Version 2.4, build Mar. 24, 2020) was used to search mass spectra and polar RI values. In addition, Flavornet (flavornet.org/index.html) and the Leibniz-LSB@TUM Odorant Database (leibniz-lsb.de/en/databases/leibniz-lsbtum-odorant-database/start/) were searched for RI values.

### Data Analysis

TABLE 15 lists the volatile compounds that were identified in sample roasted chickpeas that were acid-hydrolyzed with phosphoric acid, the ion used for peak integration, and the retention time. Many of these compounds identified in the chickpeas included the ones previously described as key odorants of traditional coffee, including pyrazines, ketones, furans, pyrroles, sulfur compounds, aldehydes, diones, and esters.

TABLE 15
Identified compounds, ion used for peak
integration, and retention time.

| | | Retention |
|---|---|---|
| | Ion | Time |
| Compound | (m/z) | (min) |
| Isobutyraldehyde | 43.1 | 3.132 |
| 2,4-Dimethyl-1-heptene | 43.1 | 3.585 |
| 3-Methylfuran | 82.0 | 3.623 |
| 2-Butanone | 43.0 | 4.030 |
| 2-Methylbutanal | 57.0 | 4.178 |
| 3-Methylbutanal | 44.1 | 4.254 |
| 2,5-Dimethylfuran | 96.0 | 4.885 |
| 2-Pentanone | 43.1 | 5.469 |
| 2,3-Butanedione | 43.0 | 5.558 |
| Toluene | 91.0 | 6.833 |
| 2,3-Pentanedione | 43.1 | 7.515 |
| Dimethyl disulfide | 93.9 | 7.684 |
| 2-Vinylfuran | 94.0 | 7.811 |
| Hexanal | 44.0 | 7.947 |
| 2,4-Dimethyloxazole | 97.0 | 8.231 |
| p-Xylene | 91.0 | 9.289 |
| N-Methylpyrrole | 81.0 | 9.383 |
| 2-Methyl-3-heptanone | 57.1 | 9.929 |
| 1-Ethyl-1H-pyrrole | 80.0 | 10.327 |
| Pyridine | 79.0 | 10.382 |
| Pyrazine | 80.0 | 11.034 |
| 2-Methylpyridine | 93.0 | 11.157 |
| 2-Pentylfuran | 81.0 | 11.352 |
| Methyl pyruvate | 43.1 | 11.423 |
| Dihydro-2-methyl-3-furanone | 43.1 | 11.898 |
| Styrene | 104.0 | 11.932 |
| 2-Methylpyrazine | 94.0 | 12.161 |
| Acetoin | 43.1 | 12.563 |
| Hydroxyacetone | 43.1 | 12.914 |
| 2,5-Dimethylpyrazine | 108.0 | 13.258 |
| 2,6-Dimethylpyrazine | 108.0 | 13.363 |
| Ethylpyrazine | 107.0 | 13.461 |
| 1-Hexanol | 56.0 | 13.545 |
| 2,3-Dimethylpyrazine | 108.0 | 13.715 |
| 2-Ethyl-6-methylpyrazine | 121.0 | 14.371 |
| 2-Ethyl-5-methylpyrazine | 121.0 | 14.486 |
| Trimethylpyrazine | 122.0 | 14.727 |
| Pentylbenzene | 91.0 | 14.824 |
| 1,3-bis(1,1-Dimethylethyl)benzene | 175.0 | 14.841 |
| 2-Propylpyrazine | 94.0 | 14.956 |
| 2,6-Diethylpyrazine | 135.0 | 15.201 |
| 3-Ethyl-2,5-dimethylpyrazine | 135.0 | 15.201 |
| 2-Furfurylthiol | 81.0 | 15.286 |
| 2-Ethyl-3,5-dimethylpyrazine | 135.0 | 15.405 |
| Acetic acid | 43.1 | 15.489 |
| Acetoxyacetone | 86.1 | 15.815 |
| Furfural | 96.0 | 15.858 |
| 2,3-Diethyl-5-methylpyrazine | 150.0 | 16.159 |
| Furfuryl formate | 81.0 | 16.328 |
| 2-Acetylfuran | 95.0 | 16.510 |
| Pyrrole | 67.0 | 16.628 |
| Benzaldehyde | 105.9 | 16.815 |
| Furfuryl acetate | 81.0 | 16.929 |
| 2-Methylpyrrole | 80.0 | 17.221 |
| 3-Methylpyrrole | 80.0 | 17.488 |
| 5-Methylfurfural | 110.0 | 17.607 |
| 4-Cyclopentene-1,3-dione | 96.0 | 17.627 |
| 5-Methyl-6,7-dihydrocyclopentapyrazine | 119.0 | 18.246 |
| Benzeneacetaldehyde | 91.0 | 18.453 |
| Butyrolactone | 42.1 | 18.522 |
| Furfuryl alcohol | 98.0 | 18.809 |
| 6,7-Dihydro-2,5-dimethyl-5H-cyclopentapyrazine | 133.0 | 19.005 |
| 2-Furfuryl-5-methylfuran | 162.0 | 19.051 |
| 5-Methyl-2-furfuryl alcohol | 95.0 | 19.499 |
| 5-Methyl-2-(5-methyl-2-furfuryl)furan | 176.0 | 20.055 |
| 2(5H)-Furanone | 55.1 | 20.343 |
| 1-Furfurylpyrrole | 81.0 | 21.177 |
| Maltol | 126.0 | 22.849 |
| 2-Acetyl-1H-pyrrole | 94.0 | 23.061 |
| Levoglucosenone | 68.0 | 23.337 |
| Phenol | 94.0 | 23.426 |
| 2-Formylpyrrole | 95.0 | 23.756 |
| α-Furfuryliden-α-furylmethylamine | 81.0 | 26.356 |
| 3-Hydroxy-2,3-dihydromaltol | 43.1 | 26.401 |

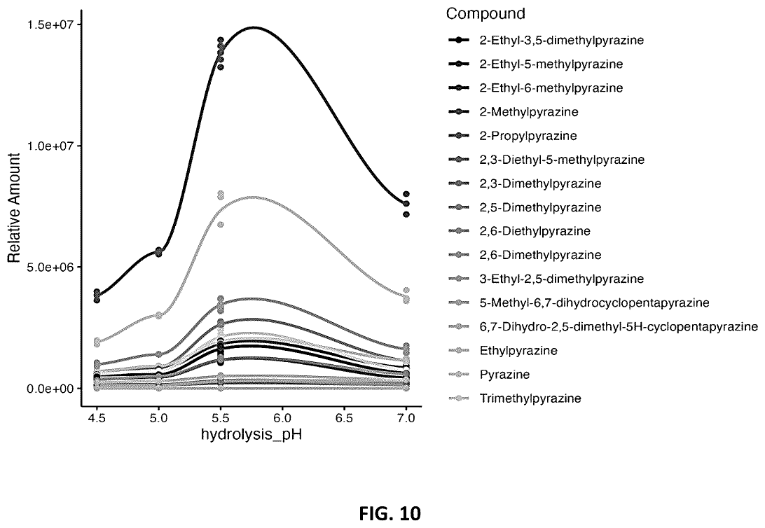

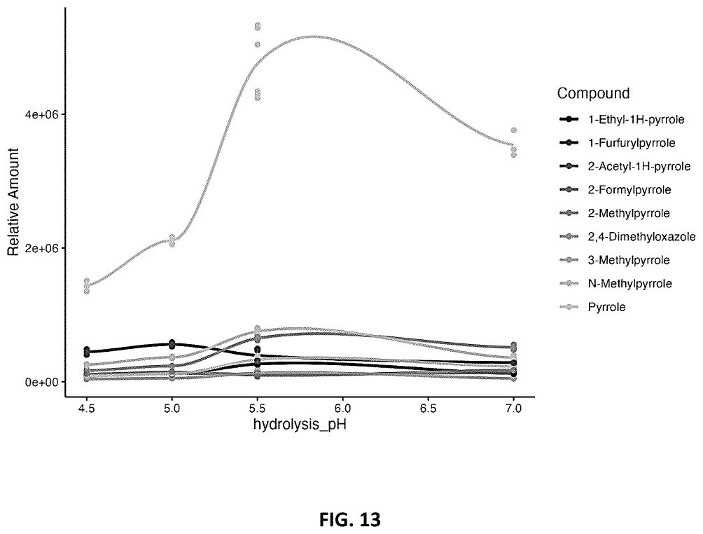

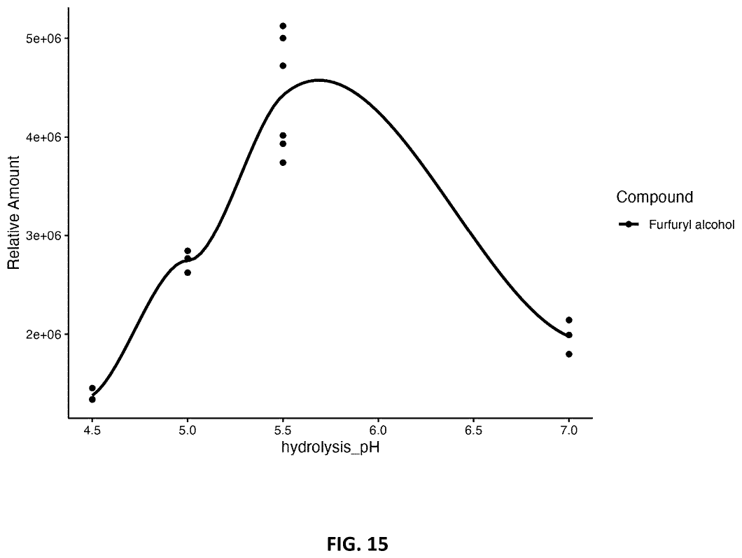

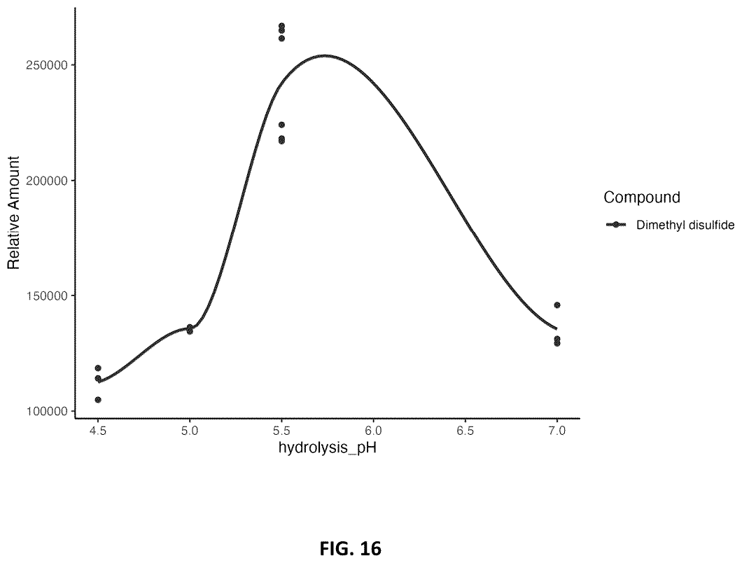

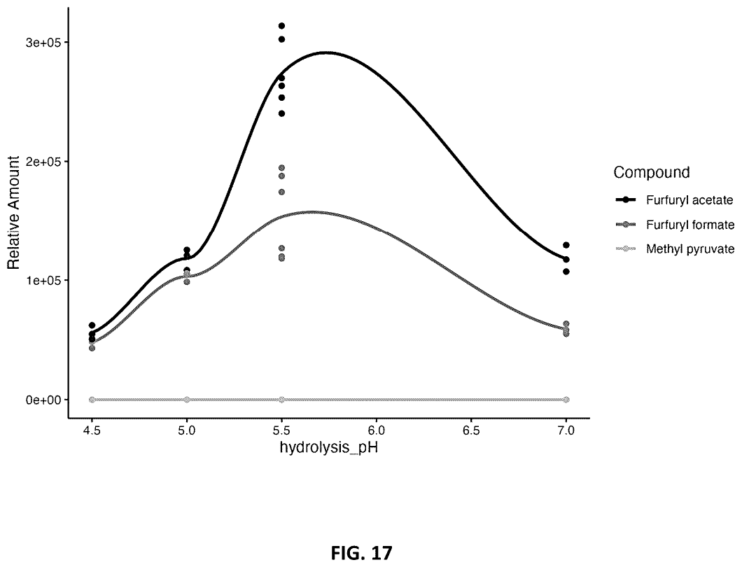

The effect of modifying hydrolysis conditions (e.g. pH) for roasted and acid-hydrolyzed chickpeas was determined. Specifically, hydrolyzed, roasted, and ground (HRG) chickpeas samples treated at different pH levels were analyzed by GC-MS to compare volatile compound profiles and to determine how the concentrations of certain key VOC classes changed as a function of increasing pH. The resulting chromatograms show the concentration of volatile compounds as a function of pH (between 4.5 to 7) FIGS. 10-19 indicate that the pH of chickpea hydrolysis is a key factor in controlling the production of volatile compounds that are responsible for the characteristic aroma of traditional coffee.

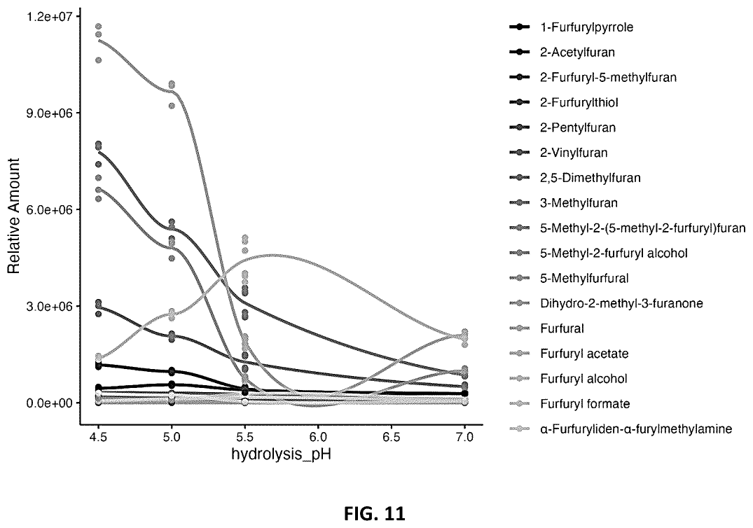

Referring to FIGS. 10 and 11, respectively, when looking at two main classes of flavor-active Maillard reaction products, pyrazines and furans, some overarching trends become evident. Furans, especially the compounds 5-methylfurfural and furfural are known to be responsible for the sweet aromas of many roasted products such as coffee or chocolate. As shown in FIG. 11, the production of these furan compounds is favored at lower pH, e.g., about 4.5 to about 5, suggesting that hydrolysis at low pH values can be used to promote more caramel or sweet forward aroma profiles in roasted chickpeas.

Conversely, as shown in FIG. 10, pyrazine production is favored under less extreme acid hydrolysis. More specifically, the concentration of these compounds tends to be highest when hydrolysis is performed at pH 5.5-6.5. Pyrazines produced in this range include 2,5-dimethylpyrazine, which contributes to the nutty and chocolatey notes to the products of interest and 2,3-dimethylpyrazine, which helps to bring the roasted character to foods like coffee or chocolate. Taken together, FIGS. 10 and 11 show that modifying hydrolysis conditions can target the production of distinct classes of flavor-active Maillard reaction productions, directly leading to tailor-made flavor profiles, such that plant products (legumes) that do not normally possess coffee-like aroma or flavor, can be chemically encouraged through acid hydrolysis, to produce “coffee-like” compounds.

Batches of chickpeas were able to be hydrolyzed at different pHs, each set to optimize the specific VOC family that is desired. For example, one batch of chickpeas was acid-hydrolyzed to a pH of 4.5 to encourage the formation of furans, which FIG. 11 shows is the pH where the concentration of furans is highest. A second batch of chickpeas was acid-hydrolyzed to a pH of 6.5 to encourage the formation of pyrazines, which FIG. 10 shows is the pH where the concentration of pyrazines is highest. The extracts of the two batches can be combined in a desired ratio, such as 50%/50% w/w, to produce an extract mixture that has a higher concentration of both furans and pyrazines. Such mixtures can comprise a first, second, third or even more extracts to create an extract mixture that has the desired concentrations of compounds to manipulate or balance the nutty, chocolatey, smoky, or other aroma notes such that the organoleptic characteristics more closely resemble that of a target food product such as coffee, chocolate, or a nut butter. Such combination mixtures can also be made once the extract has been concentrated or after they have been dried into a soluble granule, pellet, or powder. Undesirable “off-notes” can be similarly reduced by adjusting the pH conditions during hydrolysis to lessen or minimize the contributions of certain volatile compounds that may be prominent in a source substrate, such as sulfur compounds in beans. Thus, methods of preparing substitutes for food products like coffee, chocolate, or peanut butter, such as coffee-substitute concentrates and coffee-substitute soluble granules are contemplated and taught herein.

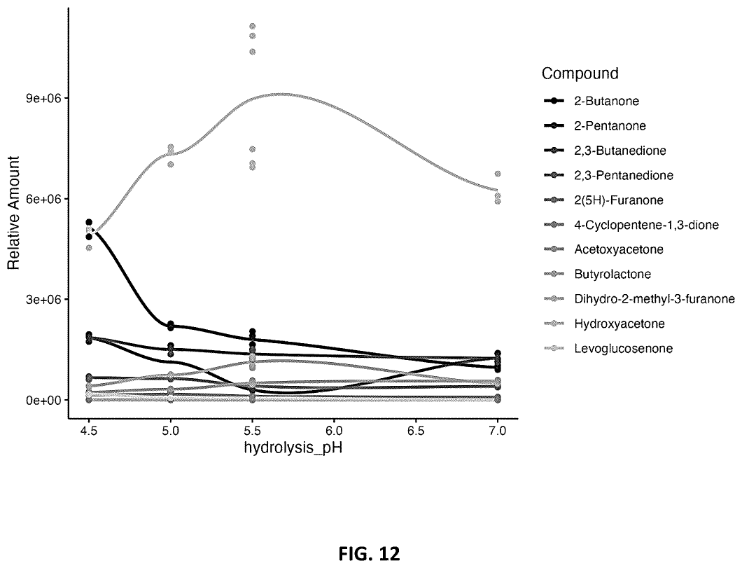

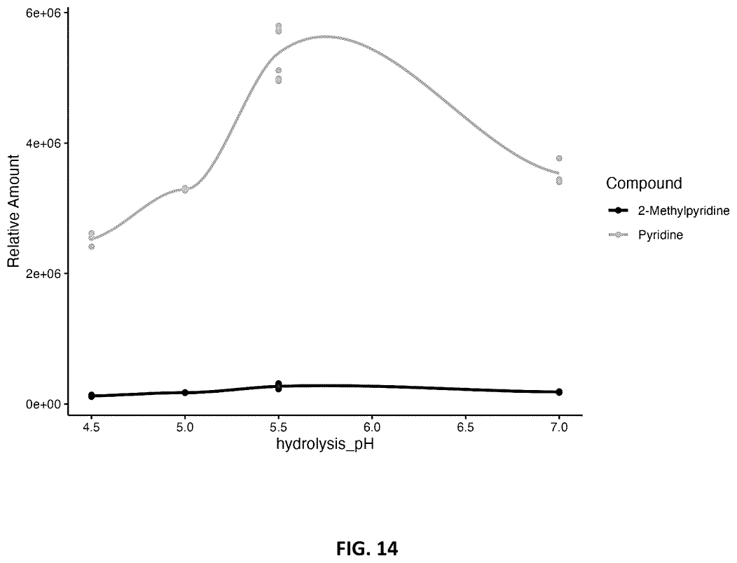

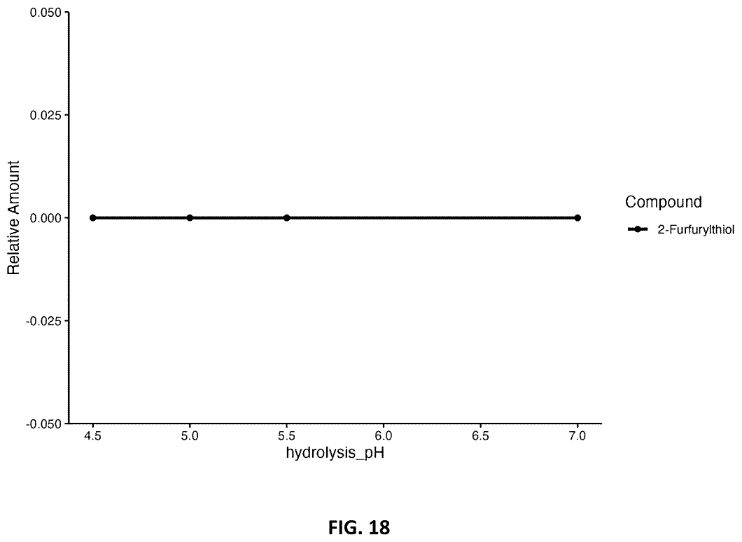

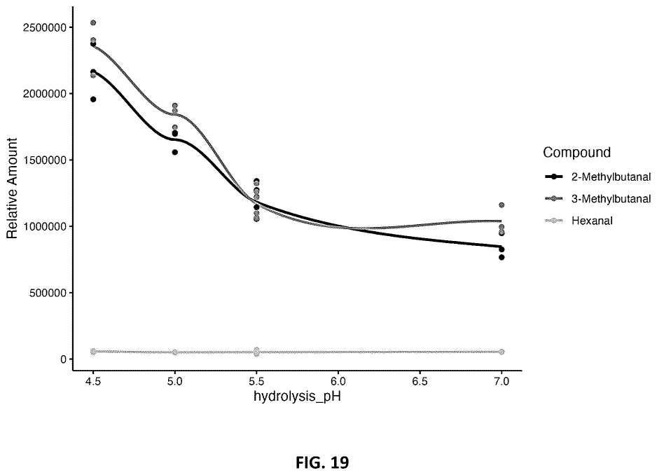

Referring to FIGS. 12, 13, 14, 15, 16, and 17, a small group of major compound classes that are known to contribute significantly to coffee aroma and flavor were measured. The results indicate that they followed a trend similar to that observed in pyrazines when acid-hydrolyzed roasted chickpeas were produced at different pH levels. FIGS. 12, 13, 14, 15, 16, and 17 graphically illustrate that the creation of diones, pyrroles, pyridines, alcohols (e.g., furfuryl alcohol), sulfur compounds (e.g., sulfides), and esters, respectively (with these compound classes having been previously identified in traditional coffee as contributing significantly to providing coffee with its characteristic aroma and flavor), was shown to be generally favored under less extreme acid hydrolysis. More specifically, the concentration of these compounds tended to be highest when hydrolysis was performed at pH 5-6. Certain species of these compound classes, however, did not appreciably decrease or increase in concentration as a function of pH, as evidenced for example, by the concentration of 2-methylpyridine staying relatively constant as shown in FIG. 14, or 2-furfurylthiol of FIG. 18, which did not show any change in relative concentration across the range of pH 4.5 to 7.0. As shown in FIG. 19 regarding aldehydes, similar to the furans shown in FIG. 11, the production of these flavor compounds is favored at lower pH, e.g., about 4.5, suggesting that hydrolysis at lower pH values (around pH 4 to 4.5) can be used to promote the organoleptic characteristics that aldehydes are known for.

The data illustrate that the flavor profiles of the chickpea ingredient can be successfully manipulated in order to make chickpeas more versatile in food applications that seek to mimic traditional coffee and other foods that have a complex chemical profile, such as traditional coffee, traditional peanut butter, and traditional chocolate, by creating some of the compounds that are commonly found in those foods by adjusting hydrolysis reaction conditions in addition to roasting parameters, such as temperature, time, and pressure.

The chickpea-based coffee substitutes that resulted possessed an intense coffee aroma and flavor and the rich, dark brown color of traditional black coffee. Thus, strong coffee-like odorants were produced even though it is unlikely that the overall chemistry of acid-hydrolyzed and roasted chickpeas is similar to that of traditional roasted coffee beans.

Through extensive experimentation, it was determined that acid hydrolysis pre-treatment conditions can be modified, for example, by combining two or more batches of chickpeas that have been hydrolyzed to two or more pH levels, to promote the creation (or reduction) of important classes of aroma compounds.

Interestingly, it was also discovered that subjecting the chickpeas to an alkaline treatment to a pH level of between 7 and 10 resulted in the formation of undesirable levels of sulfurous compounds as well as the amino acid cysteine and a pungent odor in the treated chickpeas. Thus, a desirable pH range of 4.5 to about 6 was discovered for the hydrolysis conversion of chickpeas to a coffee substitute ingredient that sensorially mimics key aroma and flavor characteristics identified in the literature as hallmarks of traditional coffee.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for preparing a ground plant substrate from a fibrous, lignocellulosic and/or proteinaceous plant material for use in a consumable food or beverage, wherein the method comprises:
treating the plant material with an acid in aqueous solution until the plant material reaches a pH of about 3 to about 7, thereby generating an acid-treated plant material,
roasting the acid-treated plant material to generate a roasted, acid-treated plant material, and
grinding the roasted, acid-treated plant material to yield the ground plant substrate.

2. The method of claim 1, wherein the plant material comprises legumes.

3.-5. (canceled)

6. The method of claim 1, wherein the acid comprises phosphoric acid, hydrochloric acid, sulfuric acid, or a combination thereof.

7. (canceled)

8. The method of claim 1, comprising treating the plant material at a temperature of about 40° C. to about 90° C.

9.-10. (canceled)

11. The method of claim 1, comprising roasting the acid-treated plant material to a temperature of about 165° C. to about 250° C.

12. The method of claim 1, comprising grinding the roasted, acid-treated plant material to an average particle size of about 0.1 mm to about 5 mm.

13. The method of claim 1, further comprising extracting the ground plant substrate with an aqueous solution to produce an extract.

14.-16. (canceled)

17. The method of claim 13, further comprising concentrating the extract to form a concentrate.

18.-19. (canceled)

20. The method of claim 17, further comprising drying the concentrate to form a solid concentrate having the form of granules, pellets, or powder.

21. The method of claim 20, wherein the drying comprises spray drying, freeze drying, air drying, dehydrating, or heat drying.

22.-27. (canceled)

28. A method for preparing a ground plant substrate from fibrous, lignocellulosic and/or proteinaceous plant material for use in a consumable food or beverage, wherein the method comprises:
contacting the plant material with an enzymatic solution containing one or more enzymes with stirring from about 15 to about 120 minutes to generate an enzymatically-treated plant material,
roasting the enzymatically-treated plant material to generate a roasted, enzymatically-treated plant material, and
grinding the roasted, enzymatically-treated plant material to yield the ground plant substrate.

29.-30. (canceled)

31. The method of claim 28, wherein the roasting takes place at a temperature from about 165° C. to about 250° C.

32. The method of claim 28, wherein the one or more enzymes comprise a carbohydrase, protease, amylase, pectinase, cellulase, hemicellulase, xylanase, ligninase, or tannase.

33. The method of claim 28, further comprising extracting the ground plant substrate with an aqueous solution to produce an extract.

34.-36. (canceled)

37. The method of claim 28, further comprising contacting the plant material with one or more chemical solutions, each chemical solution comprising an acid or a base, wherein the plant material is contacted with the one or more chemical solutions before the plant material is contacted with the enzymatic solution containing one or more enzymes.

38. The method of claim 28, further comprising contacting the enzymatically-treated plant material with one or more chemical solutions comprising an acid or base, wherein the enzymatically-treated plant material is contacted with the one or more chemical solutions before roasting, after roasting, before grinding and/or after grinding.

39.-45. (canceled)

46. The method of claim 28, wherein the plant material comprises legumes comprising chickpeas, lentils, peas, black beans cranberry beans, or a combination thereof, or fruit seeds comprising date seeds grape seeds, or a combination thereof.

47. The method of claim 28, comprising grinding the roasted, enzymatically-treated plant material to an average particle size of about 0.1 mm to about 0.5 mm.

48.-49. (canceled)

50. A method of preparing a concentrate for a coffee-substitute beverage from a legume, fruit seed, or combination thereof, wherein the method comprises:
contacting the legume, fruit seed, or combination thereof with an aqueous solution containing an acid to form an acid-treated legume or an acid-treated fruit seed having a pH between about 4 and about 7,
roasting the acid-treated legume or the acid-treated fruit seed to generate a roasted, acid-treated legume or a roasted, acid-treated fruit seed,
grinding the roasted, acid-treated legume or the roasted, acid-treated fruit seed to yield a ground legume substrate or a ground fruit seed substrate having an average particle size of about 0.1 mm to about 5 mm,
extracting the ground legume substrate or the ground fruit seed substrate with water to produce a first legume extract or a first fruit seed extract, and
concentrating the legume extract or the fruit seed extract by removing at least a portion of the water to form a legume concentrate or a fruit seed concentrate, wherein the extracted water is removed by evaporation, freezing, and/or thawing of the extract.

51. The method of claim 50, further comprising adding caffeine, one or more acids, and/or one or more flavors to the legume extract or the fruit seed extract.

52.-54. (canceled)

55. A method for making a soluble plant-based granule, a soluble plant-based pellet, or a soluble plant-based powder for use in a consumable food or beverage, wherein the method comprises:
(a) treating a plurality of plant seeds, beans, or peas with one or more chemical solutions, each chemical solution comprising water and an acid or a base, and/or one or more enzymatic solutions, each enzymatic solution comprising water and one or more enzymes, thereby producing a plurality of treated plant seeds, a plurality of treated beans, or a plurality of treated peas;
(b) roasting the treated plant seeds, the treated beans, or the treated peas, thereby producing roasted, treated plant seeds, roasted, treated beans, or roasted, treated peas;
(c) grinding the roasted, treated plant seeds, roasted, treated beans, or roasted, treated peas, thereby producing plant seed grounds, bean grounds, or pea grounds comprising particles having an average particle size of about 0.10 mm to about 5 mm;
(d) extracting the plant seed grounds, bean grounds, or pea grounds in water at a temperature of about 60° C. to about 175° C. to produce a plant seed extract, a bean extract, or a pea extract;
(e) concentrating the plant seed extract, the bean extract, or the pea extract by removing at least a portion of the water by evaporation, freezing, or thawing to form a plant seed concentrate, a bean concentrate, or a pea concentrate; and
(f) drying the plant seed concentrate, the bean concentrate, or the pea concentrate, thereby yielding a soluble plant-based granule, a soluble plant-based pellet, or a soluble plant-based powder.

56. The method of claim 55, wherein the plant seeds, beans, or peas comprise legumes comprising chickpeas, lentils, peas, black beans, or cranberry beans or fruit or vegetable seeds comprising date seeds or grape seeds.

57. (canceled)

58. The method of claim 55, wherein the plant seed concentrate, the bean concentrate, or the pea concentrate is dried by spray drying, freeze drying, air drying, dehydrating, or heat drying using a kettle, vacuum kettle, rising film evaporator, falling film evaporator, scraped film evaporator, dehydrator, or freeze concentrator.

59. (canceled)

60. The method of claim 55, wherein the acid comprises phosphoric acid and the soluble granule has an average particle size of about 0.1 mm to about 5 mm.

61. A replica of a coffee bean or a replica of a coffee ground, wherein the replica comprises a solid substrate comprising acid-hydrolyzed and roasted grains, legumes or legume seeds, fruit seeds, or a combination thereof.

62.-64. (canceled)

65. A coffee granule replica comprising an aqueous extract of acid-hydrolyzed and roasted chickpeas dried into the shape of a granule.

66.-67. (canceled)

68. A coffee beverage replica comprising an aqueous extract of acid-hydrolyzed and roasted chickpeas, caffeine, and/or flavors.

69.-71. (canceled)

72. A coffee replica having the form of an aqueous extract, wherein the coffee replica comprises acid-hydrolyzed and roasted legumes, and wherein the acid comprises phosphoric acid, hydrochloric acid, or sulfuric acid.
